(19) United States
(12) Patent Application Publication
(10) Pub. No.: US 2007/0014681 A1
(43) Pub. Date: Jan. 18, 2007

(54) Retrorotating, post-rotating and birotating prime movers

(76) Inventor: Normand Beaudoin, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/573,526

(22) PCT Filed: Sep. 3, 2004
(86) PCT No.: PCT/CA04/01615

§ 371 Date: Aug. 29, 2006

(30) Foreign Application Priority Data
Sep. 24, 2003 (CA) 2442351
Jan. 26, 2004 (CA) 2460217
Feb. 13, 2004 (CA) 2458162
Apr. 26, 2004 (CA) 2466987
May 17, 2004 (CA) 2766985

(51) Int. Cl. F01C 1/02; F01C 1/063; F03C 2/00; F03C 4/00; F04C 18/00; F04C 2/00; F16N 13/20

(52) U.S. Cl. 418/61.2

(57) ABSTRACT

The current invention has as objective to complete our works relative to motor machines by generalizing certain support methods, such as that by poly inductive mechanics, by hoop gear, as well as generalizing the realization criteria of motor machines, showing mainly that the degrees of mechanic rotativity of them can be realized horizontally, thus assuring the realization of machines said rotativo-circular, with differential or contrario dynamics, these machines allow to complete the chromatic ranges of motor machines and to differentiate the levels of dynamism, and their material figuration degrees, both real and virtual. We'll show in addition that the mechanical generalizations correspond to the dynamic generalizations of the figures.

### FIELDS OF THE CURRENT INVENTION

The current invention can be considered as the second part of our work relative to motor machines, work which we'll find the first part summarized in our patent application deposited internationally as “retro, post, and bi rotary motor machines.”

In addition, the current patent application summarized in the group of patents deposited previously to this one:

By opposition to the figurative plan, developed in first part, in which we have shown a certain number of criteria allowing to describe the figure and mechanical degrees of the machines, the current invention will determine the main factors allowing the determination of, from a precise cutting made possible by certain units of the first part, the various degrees of the machine this time dynamico mechanical, and by a new group of possible machines on this level, notably post and retro rotary differential rotativo-circular machines as well as contrario rotativo circular machines.

In addition, we'll show that the degrees of the machines can simultaneously belong to both levels. Finally, we'll show that the machines also possess figurative reality degrees, being the material, virtual, and real degrees.

In summary, thus, the current invention has for objectives to complete our first works and to show that we can also restore to rotary machines, both geometrically and dynamically, degrees of realization assuring them not only a motor capacity, but also a versatility of realization and distinction of types of appreciable machines. This versatility will find its theoretical form in a vast group of conceptual criteria, which will allow us to determine any machine.

This new group of machines, much more vast and answering to a group of criteria which is much larger, precise, and sophisticated, which will allow a new synthesis, much larger and including much more, which we'll express in the diverse chromatic scales of motor machines.

This new group of machines will also be important since it'll bring up rotativo-circular machines with a paddle or clockwise cylinder dynamic, not only as the primordial point of cutting of various types of dynamics of machines forming the chromatic range, but also, from the practical point of view by its original fundamental realization of rotary machines, in which the only machine in which we do not find, as for the turbines, no acceleration/deceleration of any of its parts, and as in piston engines, an equal push which is complete on its compressive parts.

From the point of view of the commercialization capacity of the current invention, whereas machines of a mechanical and dynamic configuration of the previous art have remained confronted with important problems, and have fallen in a commercial abandon, we think that certain contrario rotativo-circular machines, which the first version has been provided in our previous works, seem to us to be a type of machine which, by its qualities, allow to consider a renewed commercial capacity to rotary machines.

Specified Content and Objects of the Current Invention

The first part of the current invention will consist of generalizing certain parts or methods of support of the first part. Notably, we'll extend the notions of poly induction, of hoop gears, and of polycamation.

The second part of the current invention will have for objective to generalize the rotativo circular base figure, with a clockwise paddle movement, presented at the first part of the current invention. Notably, we'll show that this realization is mechanically original, since it is the dynamic realization of perfect birotativity. We'll show in fact that the birotativity, which we have figuratively brought to light in our first part, is also presented dynamically, under the form of the rotativo circular machine with clockwise movement. We'll explain the immense advantages of this type of machine and we'll generalize the horizontal support methods, allowing to assure a correct support of the compressive parts.

We'll show in addition, that the Rotativo-circular motor machines, generally realized by coordination of compressive parts of circular and clockwise movement are important not only from the point of view of their specific original qualities, but also theoretically, since they allow us to determine with precision a point of birotary cutting, this point in turn allowing the completion of a complete system of dynamics of motor machines, which we'll represent by the chromatic scales.

In other terms, we'll show that the mechanical degrees which we have defined in the first part, and which allow the figurative realization of machines of various degrees, by different and more sophisticated cylinder curves, which will also allow, when realized horizontally by means of semi transmittive induction, to differentiate dynamically the degrees of the machines, whether they be by clockwise dynamic, differential retrorotary dynamic, or post rotary, or even by contrario dynamic.

In summary, we'll thus show that all the advances relative to the degrees and birotativity of machines which we have realized on the vertical level in the first part of this work, can, from the unity of rotativo-circular clockwise paddle movement machine which is also shown in this part, allow us to generalize this dynamic and elaborate the complete plan of these machines, this time from the dynamic and horizontal point of view.

We'll achieve this work by demonstrating that these two levels can be realized in a same machine.

The group of these dynamics will allow the constitution of a complete system of motor machines, including chromatic ranges, and a complete critereology allowing us to define any machine.

More Precisely

a) we'll show the rules allowing the grouping under a same conception of the multiple mechanics of these machines;

b) we'll show the differentiation between the material figures, the virtual figures, and the real figures of the machines, which will allow to show different machines with opposite movement, such as the Slinky machines;

c) we'll generalize the rotativo-circular machines to all machines, for example, polyturbines of quasiturbines;

d) we'll show that the notions of degrees not only figuratively but in dynamic addition can be applied to machines in general and to poly turbines;

e) we'll show that we can realize chromatic scales of general machines, and that they apply in post, retro, or fixed cylinder or even planetary cylinder in clockwise movement;

f) we'll show that the rotativo circular machines are also general, from the point of view of their paddle, knowing that they can be realized by groups of simple paddles and cylinders, standard poly faced paddles, paddle structure;

g) we'll suggest types of possible segmentation which are more adequate; h) we'll suggest crankpin supports and their means of realization;

i) we'll show that rotativo circular machines can not only be realized by all induction, but also they can be elevated in degrees by all methods of elevation already indexed for fixed cylinder machines, notions of figurative degrees, for example polycammed gears and induction degrees.

Work Plan of the Current Invention

To realize these objectives, we'll consequentially realize the following steps of disclosure
1. Effectuate a recapitulation of the previous art, before and up to Wankle.
2. Show the main practical gaps of Wankle's practice, and the mechanical difficulties which result from them.
3. Show how our different contributions greatly improve the push, even in rotary machines of a first degree.
4. Show the clockwise dynamics.
5. Recapitulate a general comprehension system of machines, evacuating Wankle's difficulties.
6. Enlarge to the fullest extent the notions of mono and poly induction.
7. Suggest adequate machine segmentations.
8. Suggest support of the compressive parts by crankpins.
9. Show Wankle's semantic gaps.

The group of these realizations, linked to those already produced by ourselves, will allow the demonstration of all of Wankle's mechanical and theoretical gaps and how a total, more enlarged and including, finalized system can answer them.

The steps of realization of this second part of our works will be the following:

a) We'll summarize the data relative to the previous art relative to motor machines mainly rotary, with a piston or paddle compression.

b) We'll summarize Wankle's contribution in the matter.

c) We'll enounce the various base difficulties of Wankle's system (it is to be noted that we'll show, sub sequentially many conception and signification errors of the system).

d) We'll realize a brief recapitulation of the first part of the current invention, and notably, we'll show how we have overcome the difficulties of it, which would allow the realization of the characterization of degrees, as well as the neutral compressive motor aspect.

e) We'll generalize certain realizations, for example, realizations by hoop gear, or by poly induction.

f) We'll show that one of our previous realizations, being that by clockwise paddle movement, is not a simple realization among many others, but rather a strategic realization of the most important, since not only it implements an original degree of dynamisation of these machines, but also since it allows to complete the dynamic chromatic scale of these machines, and to realize new characterizations, such as contrario machines, and virtual and real figuration machines. We'll show in addition, that these types of machines are fundamentally original from the point of view of their quality, notably by their push equally spread out on the whole surface of the pistons, and by their total absence of acceleration and deceleration on all its motor and compressive parts.

g) Realizing a missing point of the previous systems, allowing the creation of chromatic machine scales, differentiated in post or retro rotary differential dynamic machine and in clockwise or contrario movement machines.

h) We'll then show the generalizing quality of composed dynamic machines said rotativo circular, in that in which they can not only apply to any machine, whether it be retro, post or bi rotary, but also in all dynamic of first, second, third or any other degree.

i) We'll then show that all these machines can also be realized by combination of simple paddles, by standard multifaced paddles, or by paddle structures.

j) We'll show that some machines can also dynamically or figuratively realize superior degrees, notably by correction methods already commented, as for example polycammed gears.

k) We'll determine the general association principles of support methods for these machines, the notions of induction applied on itself, of ascending and descending induction.

l) We'll finally show that starting from these new assets, we can differentiate the virtual and real material levels of the machines, and thus realize slinky movement machines.

m) We'll show that all the mechanical assets already realized by ourselves can apply to rotativo circular machines, which guarantees the specifically generative character of these machines. To accomplish this, we'll define the semi-transmissions already commented on by ourselves like the induction applied on itself.

n) We'll index the group of characteristics allowing us to specify the nature of a given machine much more global and surpassing the determinations of the previous art, and allows a versatility of maximal machines and an exhaustive comprehension of each. We'll show, to this effect, the semantic errors of many machines of the previous art.

o) We'll show that the groups of these characteristics form a synthetic unity by which the number of the machine, which can't be extended by simple classifications of the previous art, can now be entered correctly.

p) We'll show that the corrective methods, by runners, layering, polycammed gears, can also be applied to rotativo circular machines, by poly crankpins.

q) We'll show that the rotativo circular machines can also be realized by rotary paddles and rotativo circular cylinder, thus creating the counter chromatic scales.

r) We'll show the various types of simplified segmentation for these machines.

s) We'll show the possibilities for suspension by crankpins.

Recapitulation of the Previous Art, Before and Up to Wankle

The Art Previous and Posterior to Wankle Excluding Our Works

We can summarize the period previous to Wankle to works relative to motor machines, mainly rotary like the period in which we have progressively discovered a group of paddle and cylinder configurations, allowing the planetary displacement of these paddles in their respective cylinders.

The base figures have been discovered by a group of inventors, being Fixen, Cooley, Maillard, and many others (FIG. 1 a).

We can say by excluding our own works that the previous art, in general, relative to motor machines, particularly rotary, seem to have known its most important expansion before and during Wankle's time. The developments after Wankle's are very compartmental and even today we use in the industry the support method by mono induction, invented by Wankle himself. This is mainly attributable to the great opacity of the wankellian theory, which leaves little room to restructure. But, as we have already shown and will finish to show currently, an important enough number of machine characteristics and serialization, of semantic cutting of them, allows the elaboration of an important number of new machines, a vaster and more general theory, and especially, new types of machines totally excluding the group of faults of the machines before and up to Wankle.

Wankle's Contributions

As we have mentioned in our previous works, Wankle's contributions can be classified in three main categories, being
1) That of historic indexing.
2) That of mechanization, and finally
3) A paddle segmentation, and a serialization of these new figures.

Without pushing it, we could add the variants as well. But this part comprises semantic dynamicism errors and is deprived of mechanical support methods, which prevents us to know the nature as well as the real composition.

Wankle's Contribution Through Historic Indexing

The consultation of Wankle's main patent, titled Eintellung der rotationskolbermachinen. Rotations kolbenmachinen mit parrallelen drehaschsen unt arbeitshramumwandungenaus starrem werstoff numbered xb02204164 allows to take knowledge of the faithful exposition by Wankle of the state of motorology of the machines of his era and of the previous one.

To say truthfully, many of these machines, and even the great majority, remain however non-mechanized, and in addition are not mechanisable by using strictly the two induction methods proposed by the inventor. This is why here we will only consider the machines which can be mechanized, in other words, in which the motor parts can be mechanically supported.

Rationalization of Wankle's Figures

Wankle's most important theoretical contribution is admittedly to have organized the initial figurations of the previous art in such a manner so that the segmentations can be realized in these new machines not in the cylinder corners, but rather on the points of the paddle. Afterwards, Wankle, to the image of Fixen and Cooley, realized the series of these machines, retro and post rotary. These logical serializations similar to machine figures of the previous art, have allowed the grouping of machines in two categories, which we have previously named retro and post rotary, according to their paddle, which when observed by an exterior observer, displaces itself in either the same direction as its eccentric, or in opposite direction. (FIG. 1b)

The second part of Wankle's rationalization consists in specific serialization of each of these categories, serializations allowing to rationalize the ratio of the number of paddle and cylinder sides of each of these categories. Wankle thus enacts the rule that, according to which, retro rotary machines have a number of paddle sides inferior by one to that of their respective cylinder, whereas post rotary machines have a paddle side superior by one to their respective cylinder (FIG. 1b)

Mechanization

Wankle's theoretic contributions wouldn't be very well known by today's general public if it wasn't for his mechanical contributions, which resulted in the autonomous paddle support in relation to their respective cylinder, and consequentially, to cut back undue frictions of the paddle on the cylinder, resulting in a premature segment wear.

These types of mechanical support are limited in Wankle's method to two. These methods being mono inductive and intermediate gear support. (FIG. 1 c) Mono induction is the type of support generally used in the industry.

Variants

The only dynamic variant for which Wankle provides support methods is the variant by double rotational action. This variant is still useful today in the production of pumps. Wankle provides two support methods for this variant. (FIG. 1 d)

Mechanization by Mono Induction and Triangular Paddle

It is to be noted from the start that the crankshaft in rotary machines, but mostly retro rotary must be realized with a very small dimension to allow the realization of an acceptable compression ratio. In the same way, the more the number of paddle faces and cylinders of the machines is high, more their eccentric is small. It's for this reason that the industry has concentrated almost exclusively on triangular paddle post rotary machines.

As for mechanizations proposed by Wankle, in the mechanization by intermediate gear, it proves harder to realize the segmentation, and to realize the paddle positioning with complete exactitude. The industry has thus very limitedly recognized the method by mono induction as a liable support method allowing a commercial realization of this type of machine.

Period After Wankle, Excluding Our Own Works

The opacity and the rigor of Wankle's system have made later conceptual developments difficult. The rational organization of the motor machines comprises of but a few rationalization criteria, characterial machine distinction criteria, which has made conception not only narrow, theoretically but in addition, insufficient and erroneous in many areas, notably that of analytical perspective, and those relative to the character of compressors and machine engines. The excess of purification of the components by Wankle created a loss of a great part of the rotary capacities of the machines. Among the works after Wankle's, in significant contributions relative to motor machines, we must note the contributions of Wilson and St Hilaire. The first shows that we can realize a motor machine in which the paddle will be a flexible group of paddles, which we have named paddle structure. The second uses this paddle structure as a support structure to a set of superior paddles. Neither of these inventors was in measure to suggest adequate support methods for these machines.

We have abundantly shown that these machines constitute second and third degree machines, and that they can, as first degree machines, be serialized. We have also shown that the same mechanics of first degree machines, but this time combined could allow the support of its compressive parts.

Very Concise Summary of the Preliminary Course and of the Current Work

Initially, as many researchers, we have stated that the rotary machines, especially when they had their compressive parts supported by conventional support methods, producing a lot of friction, which is the direct consequence of contradictory pushes on the paddle. We thus have in a first time proposed many new support methods allowing to counter these difficulties, such as, the methods by poly induction, by hoop gear, by central active inductions, by semi transmission and so forth. (FIG. 2) We have subsequentially noticed that the mechanical deconstruction realized during the expansion was more interesting in retro rotary machines than in pot rotary machines. In the goal of profiting this important advantage, we have abundantly worked to correct the weak point of these machines, by trying to show apt methods to increase the compression of retro rotary machines. To realize this, we have been brought to understand that it was necessary to correct the course of the paddle and the curve of the cylinder in such a manner so that if it is inserted less deeply in the corner of its cylinders and deeper in the sides. Progressively with this work, we have interested ourselves to paddle structure machines, in which the first compressive structure has been realized by Wilson. We have noted that the cylinder curve of this machine was specific in what it comprises of on both the retro rotary aspect and post rotary aspect, which was corroborated by various mechanical support methods which we have produced to support the parts. We have concluded that, in addition that certain machines by their very nature have a superior degree of proven rotativity by a superior number of rotary structures. We have thus shown that the mechanics of these machines could then be applied to retro or post rotary machines, which confers them a higher mechanical degree, a more subtle cylinder figuration, and finally, a partially bi rotary character. These methods have thus allowed to increase not only the compression of retrorotary machines, but also to increase the couple of post rotary machines. The main realization methods of birotativity have thus been that of the addition of a geometric rod, of polycammed, layering, and poly induction gears. (FIG. 3)

The reasons of the obtained results, as much in the retro as post rotary machines consisted in that of which we give these machines their bi rotivity back, the number of mechanization degrees allowing their correct motricity.

The difficulty in realizing these mechanical layerings had then brought us to propose other original realization solutions for bi induction. The polyinduction allows in fact to realize horizontally the cutting which we have produced. We have also gone further by showing that the bi rotivity could be realized both horizontally and dynamically, by the realization of paddle machines with clockwise movement, which must be considered, as we'll show, as the most important theoretical expression of rotativo circular machines. (FIG. 4)

Very Concise Summary of the Current Invention

In the current invention, we'll firstly dedicate a first part to a generalization of certain methods of our previous works. Here we'll show notably the notions of poly induction by descending anchor or of alternative poly induction. We'll enlarge the notion of polycammed gears and of support methods by hoop gears.

Secondly, we'll specify our thought relative to base rotativo-circular machines, and we'll specify the nature bi inductive clockwise paddle movement. We'll show the great mechanical relevance of these machines.

Then, thirdly, we'll generalize support methods for these types of machines by showing more notably that there is always participation of at least two mechanics, by ascending induction, by descending induction, or by semi transmission, and that these parts are linked by the paddle, the crankshaft, or the support gear.

Finally, we'll generalize the rotativo circular machines to the limit. We'll show indeed that, starting with the clockwise dynamic, we can realize, this time horizontally, the group of degrees of these machines, a group which we have figuratively and vertically realized in the first part of our works. We'll precisely realize the following:

1) By showing that the number of degrees is dynamically expressible by post rotary, retro rotary or even contrario, differential action.

2) That these types of corrective methods, for example by polycammed gears, by increasing the rotativity degrees, can also be applied to them.

3) That the various paddle types, simple, standard polyfaced, and paddle structure can be applied to them.

4) That the horizontal level on which they have been realized can be combined to the vertical level of the previous machines.

5) That all rotativo circular machine is all at once, the expression of a material figuration of the paddle cylinder ratio, and the virtual figuration expressing the paddle movement, and a real figuration, expressing the correct placement of the machine time.

6) That the rotativo circular machines can also be realized with a differential or contrario dimension.

7) That the clockwise movement machines can be realized virtually, in inversed mirror image, with clockwise cylinder and rotational paddle.

8) That the clockwise movement machines can also be realized bi functionally.

The group of these new generalizations will complete our works and allow us to realize a general theory of determination criteria of all motor machines.

More Concise Summary of our Previous Works and the Object of the Current Invention of our Previous Works

Our previous works have thus realized the following aspects:

A) we have added many first level mechanics to Wankle's two mechanics, which has allowed the determination of a vast mechanical group comprising the following support methods (FIG. 2):
by mono induction (Wankle)
by intermediate gears (Wankle)
by poly induction (Beaudoin)
Method by semi transmission (Beaudoin)
Method by hoop gear (Beaudoin)
Method by intermediate gear (Beaudoin)
Method by heel gear (Beaudoin)
Method by internal juxtaposed gears (Beaudoin)
Method by internal superposed gears (Beaudoin)
Method by central post active gears (Beaudoin)
Method by gear-like structure (Beaudoin)
Method by unitary gears (Beaudoin)

We have then produced the following group of advances (FIG. 3)

a) We have shown that we could increase the compression of retro rotary machines, the couple of post rotary machines.

b) We have then shown that we could realize rotary machines of various degrees, these machines realizing new more subtle cylinder forms being supported increasing the number of inductions.

c) We have then shown that we could produce accelero-decelerative action of the compressive parts, increasing to their oscillatory effect, and thus increasing the course of the compressive parts and the relative cylinder forms.

d) We have shown the rules of combination of mechanical layering.

e) We have generalized cylinder forms for poly turbines.

f) We have shown methods of degree and cylinder modifications.

g) We have shown the dynamic degrees of piston rotor cylinder machines.

h) We have shown the effects of poly crankpin on rotary machines

i) We have shown the different types of obtained cylinders, ovalised, squarified, etc

j) We have shown that the machines could be constructed by groups of unitary paddles, standard poly faced paddles, paddle structures

k) We have shown the perfectly birotary dynamics of clockwise paddle movement, and the rotativo-circular dynamics which this movement implies.

Retrospective of the Art Before and Up to Wankle

We can summarize the previous art up to Wankle by saying that it is the progressive and non rationalized expression of various rotary machine figures. The main inventors to which we owe the base geometric figures of rotary machines are Fixen, Cooley, Maillard and many others. These inventors have shown that paddles of various numbers of sides can be realized in a way to produce an interior planetary course of a cylinder, when they're set up on an eccentric (FIG. 1a)

Wankle's Contributions

Wankle's contributions can be considered from three particular points of view. We firstly owe Wankle an important historical part, since, in his invention, he indexes exhaustively the motor machines of the previous art.

Wankle's second contribution must rather be classified from the point of view of its theoretical value. In fact, Wankle establishes a classificatory rationalization of these figures, and paddle segmentation figures, which allows on one part to divide the figures post and retro rotarily and, on another part, to fill the said classes of missing figures. (FIG. 1b)

Wankle's third contribution consist of realizing two orientational support methods of the machine paddles, methods which we have named by mono induction and by intermediate gear (FIG. 1c). These methods have had for main effect to make the paddle totally independent, mechanically, of the cylinder in which it travels. Consequentially, the use of these methods has allowed a correct separation of the mechanical and compressive parts of rotary machines. It's mainly for this reason that, one of these methods, the method by mono induction, is adopted by the industry, and for result that the rotary engines are often also named Wankle engines, from the name of the inventor of these methods.

First Part

In this first part, we'll determine more specifically the most fundamental gaps of the previous art, notably that of Wankle and we'll produce and extension by precision of the methods which we have previously proposed.

General Gaps in Wankle's System

It is a point of consensus to consider rotary machines before Wankle as very minimally resistant to premature wear of segments, and Wankle machines as having an elevated friction coeffiction and a very weak coupling.

To really be in measure to correct these faults, we must have a full consciousness of their causes. We know that the segments of the machines of the art before Wankle, underwent a premature wear cause by the fact that the orientational support of the paddle is realized by its anchoring to the cylinder. The segments thus underwent an important mechanical pressure for which they have not yet been conceived.

We can classify the gaps of Wankle's system in three main categories, being mechanical, semantic and gaps of incompletion. We'll only study the semantic and incompletion gaps at the end of the current invention, and will only consider the mechanical gaps, for the sake of the current section.

Wankle's Mechanical Gaps

Segmentation

The positive effects of Wankle's new segmentations have allowed a paddle segmentation, and a softening of the cylinder shape, which has had for effect to minimize the use of segments. In addition, the main negative effect has been to realize the explosion on a single horizontal paddle, and not a rectifying paddle, as it was in the machines of the previous art. The price to pay to secure the segmentation has thus considerably diminished the amplitude of the extension, reduced in Wankle machines to only the extension of the crankshaft.

Mechanics

The mechanical contributions of Wankle have thus filled their objectives of realizing the orientational securization of the paddle autonomously to the cylinder, and consequentially to realize the total separation of the compressive mechanical action. In addition, it is evident that the realization of these orientational support methods has lead to other difficulties, which are almost just as important, theoretically and mechanically.

Since we intend to broaden certain previous solutions here in the first part of the current demand, such as poly induction, induction by hoop gear, and by polycammed gear, and in the second part, to generalize the horizontal dynamico-mechanical level of the machines, we'll discuss Wankle's errors here, and will show that all our solutions aren't compartmental, but to the contrary for an original systematic corpus allowing to fully realize these machines. It will be consequentially easier for the reader to take knowledge of the originality, the effectiveness, the flexibility, the variability, and the generality of the global synthesis which we have proposed to this effect.

The group of Wankle's mechanical gaps and the group of solutions which we have brought and will bring are the following:

a) A realization by the means of two mechanics, being the mono inductive mechanic and by intermediate gear, of contradictory pushes on a same paddle, a part of its pushes being in inverse direction of the machine rotation (solutions: hoop gear mechanic, semi transmission, central post active gear)

b) A mechanical realization lowering the number of components on an inferior number to that strictly necessary to the realization of the motricity (solution: layering, poly crankpins)

c) A counter-rotary mechanization, issued from the inversed observation of the machine mechanics, from the exterior towards the interior of the system of the machine (solution: constructed observation, and poly induction)

d) An exaggeration in the regularity of the rotary movement of the paddle polycamed gears).

Wankle's First Gap: Centralization of the Anchoring Resulting in Contradictory Pushes on the Paddle

The consisting element without objection the major difficulty of all rotary machine, when the orientational action of it is realized by one of Wankle's methods, in other words, in the center of the machine, is admittedly that of the contradictory push of the explosive power on the paddle. By contradictory push, we hear on one part that a part of the paddle has an orientational induction not only opposite to the other part of a same paddle, but also opposite to the system of the machine. This is exactly what goes on in Wankle's two main induction mechanics, being mono induction, and the induction by intermediate gear, and it is certainly the main reason upon which is founded the lack of motricity of these machines when realized in these ways. (FIG. 5b)

To better grasp the cause of this gap, we can use example which are more comprehensible by comparing many piston engines, of different types. We can in fact compare standard piston engines to runner rod piston engines, and poly induction piston engines. (FIG. 5c)

We can state at this figure that the power of the piston on the crankshaft, in course of descent, is given in the standard piston engine by the vertical push on it, and b by it's abutment and the rod, transforming it into lateral push.

The two combined effects, the push and the rod effect combine themselves to realize the circular movement of the crankshaft. The push on the surface of the piston is totally positively used. In fact, whether it is anterior or posterior to its support point, it transforms into lateralo-vertical push directed in a single direction.

In the runner rod engine, the lateral action of the push is lost, and the rod effect is cut back. The machine then has but its vertical effect.

In the rectilinear rod poly induction engine, of our patent titled Poly induction energetic machine, the power is this time increased by the strictly vertical action of the push, added to the lever power of the superposed crankshafts.

In rotary engines of the art previous to Wankle, we arrived to realize a push, but unequal on the whole surface of the paddle and consequentially an appreciable push effect on the crankshaft. (FIG. 5a)

The crankshaft and the paddle participate by realizing their compressive action to the mechanical action, the extremity of the paddle realizing a certain anchoring in the cylinder and would allow a lever action of the paddle on the crankshaft. Unfortunately, such a procedure would make the commercial realization of these machines difficult, since mechanical parts realized confoundedly with compressive parts result necessarily in premature wear.

It was thus absolutely necessary to realize not only positional support methods, being in the center of the paddle, but also, orientational, in such a manner to make the action totally independent of the cylinder and thus allow the realization of a strictly floating segmentation.

Wankle's Methods: Inductions by Mono Induction and by Intermediate Gear

As we have just shown, we can say that the orientational anchoring, in rotary machines, is the equivalent of the rod effect in piston machines.

We can thus confirm that the displacement of the anchoring of the exterior towards the center of these machines produces a similar effect, if not worse than that of the cutting back of the rod effect by realization of the runner transmission previously demonstrated in piston engines.

In fact, by anchoring the orientational aspect of the paddle in the center of the machine, we divide, necessarily, this said paddle in two parts which will realize the push of the explosion contradictorily, in opposite direction.

The pushes on each of the paddle parts will thus be contradictory, and this will translate by a reduced push on the crankshaft, since the push on it will only be the difference of the contradictory pushes. In the case of a mono induction machine, which is Wankle's first support method, the back of the paddle with undergo a negative push whereas the front will undergo a positive push. To the contrary, in the case of the application of the method by intermediate gear, it's the front part of the paddle which will realize a negative push, and the back part which will realize a positive push. (FIG. 5b1, 5b2)

We'll find in more details the explanations relative to these mechanics of the current application of previous patents.

Precisions of Existing Solutions

It would be advised to read our previous works relative to motor machines, to take charge the various support and correction methods of machine's paddle courses, and to better understand the notion of degrees. For means of the current exposition, we will only bring up those which we intend on expanding. We'll thus further generalize:
A) Inductions by hoop gears, realized with chains or belts
B) Methods by polycammed gears, realized circularly, with teeth alternating between distanced and closer
C) Vertical compression semi transmission and elized structure
D) methods by poly induction
   1) on the level of their inductions
   2) on the level of their support locations
   3) on the level of their alternation

As we have already mentioned, we have already shown many solutions to these problems. We'll however limit our exposition here to the solutions which will currently receive invention and generalization.

We have demonstrated many solutions to these difficulties which can be realized without changing the level of the machine, in other words, by preserving the first level machine. These solutions all have in common the objective to realize this time mechanically the exteriorization of the anchoring of these machines. These solutions already commented on in our previous works are mainly, the mechanics by hoop gear, polycamation, by semi transmission, and poly crankpins.

We could to this effect re-read our previous works, as well as the considerations on the push that these solutions bring, and that we'll show in our previous patent application titled retro, post and bi rotary machines (conclusion).

These mechanics, for the means of the current application, must be completed as follows:

A) The mechanics by hoop gears must also undergo their realization with chain or belt (FIG. 6)

B) Polycammed gear mechanics must also comprise round gears in which the previously commented accelerations/decelerations are realized by the distance or closeness of the teeth (FIG. 7)

C) The mechanics by semi transmission apply to all machine dynamics, that the motor parts be either the cylinder or the paddles, that these machines be retro or post rotary, or even that these retrorotary machines be with lateral or vertical paddle explosion (FIG. 8)

Mechanic by Hoop Gear

The mechanics by hoop gear are realized when the support and induction gears of external type are coupled between them by a gear rotarily and planetarily set up joins them. We thus succeed in paddle activation, set up on a crankpin by its summit. This gives it great induction fluidity. We have already shown that, in hoop gear mechanics, we could increase the string effect of the hoop gear and the angulations of the push by realizing these mechanics with a third gear. In addition, in our bicycle pedals we have shown that this mechanic could also apply by realizing the hoop gear as a chain. The current simply has for effect to enounce, for motor machines, that the mechanics, said by hoop gears, the hoop gear can materially be realized by a belt or even by a chain (FIG. 6)

As previously, in this realization, the string effect limits the realization of the contradictory forward push on the paddle. The forward push is thus rotary in the direction of the machine, and is added to the back push, which is also positive. The chain could also be realized as a belt.

In fact, as in the realizations with three gears, the hoop gear mechanics, when realized with a belt or chain, will realize a supplemental string effect, this effect canceling the contradictory forward push and allowing a, although unequal, positive push on the totality of the surface of the paddle.

The push on the paddle will thus not be contradictory and since all the pushes on the paddle are offensive, and in addition, respect the unequal character of the opening of the paddle during expansion.

Accelero-Decelerative Mechanics and Polycamation Techniques

We have shown in our previous works that the realization of accelero-decelerative parts in motor machines could allow the realization of machines previously impossible, and would allow machines of a higher motricity degree. These machines being realized from gears which we have named polycammed gears. Notably, these machines, when realized with such gears, in addition of admitting an acceleration of push compatible with the thermodynamics of the explosion, would allow a variation of the anchoring point reducing the negative counter push on the paddle. We can hear, by the current, the notion of polycammed gears by enouncing that standard or polycammed gears can be realized in such a manner as to produce accelerations/decelerations by producing distancing in variable gear teeth. A gear, on which the teeth will not be equally set up, and which, consequentially, will be closer together in some areas, and further apart in others, will produce, even if they're circular, accelerations and decelerations similar to that of polycammed gears. (FIG. 7)

In addition, two gears conceived in this matter could realize alternative or accelerations and decelerations between themselves on a timeline. We'll thus produce the same accelerative and decelerative effects on the parts to which they are fixed, and in addition, different cylinder forms, more rounded or sharper which we'll be able to realize symmetrically.

Generalization of the Method by Semi-Transmission

Such as shown in our works deposited before the current, the method by semi transmission applies to all rotary machines, and in the case of retro rotary machines, to vertical explosion machines (FIG. 8a). This method will allow a verticalising action of the push on the crankshaft.

In addition, it is also important to mention here that the method by semi transmission could be realized sub dividedly, by the conjunction of an ascending induction support, and a descending rotation induction axe (FIG. 8)

Finally, we must mention, as we will specify further, elized semi transmitively to adequately support paddles in clockwise birotary movement.

Solutions to Increase the Number of Vertical Rotational Degrees: Layering of Inductions and Poly Induction

We can summarize by affirming that Wankle's first gap consists in an excessive lowering of the number of machine parts. This lowering allows to realize the machine in its compressive nature, but not in its motor nature.

This affirmation comprises itself in regard to the example of piston machines, previously presented. In the piston machine with a runner rod, rod and pistons are realized confoundedly. There are but two constituting elements of the machine which remain, being the compression part, realized by including fixedly the binding and mechanical parts. The machine will be powerful in compression, but will be of lesser performance when used as an engine. The way to confer the power will be to restore the binding part, the rod, in a distinct manner of the piston.

We must state in a clear manner that the centered realization of the anchoring in rotary machines is equivalent to the subtraction of the rod itself. When the rod is realized confoundedly with the piston, the machine is deprived of its rod effect. A similar loss is realized when the anchoring of the machine is brought to the center.

We affirm that, for internal combustion machines, the three following elements must be realized for all machine in its motor form:
A compressive part
A mechanical part
A binding part.

They must be realized conjointly and cooperatively to realize machines under their neutral or motor forms.

We think that motor machines, whether they are piston or rotary, can be realized in two main ways, being their compressive form, or their neutral motor form. They are realized in their neutral form when they are deprived of their rod effect and are realized with confounded parts. They are of neutral and motor form when their rod effect is restored, and in addition when we add a lever effect, as in rectilinear rod engines.

We have shown and will show again that one of the major realization errors of all machine of the previous art is to have realized rotary machines as first degree machines, in other words, as machines only possessing a single degree of peripheral rotivity. All the machines have thus been realized in their compressive form, and not motor.

Mechanical Layering as a Degree Elevation Solution

During our previous works, we have shown that mechanical layering, which had for object to realize retro rotary machines with an acceptable compression ratio, had in reality a much more general value since we could realize all motor machines according to this method. More specifically for post rotary types, it allowed to realize an extremely powerful coupling considerably improving the attack angles of the paddle on the crankshafts. As for bi-rotary machines, since the mechanical degree allowed the paddle support and was already of second degree, these layering mechanics allowed a correct support of the compressive parts, which the previous art was not in measure to realize the nature. These second degree machines were therefore more powerful and their nature was of the motor type, whereas first degree machines, realized with a single layering, remained compressive type machines, with the two layerings becoming neutral or motor type.

In the layering realizations the motor parts of the machines are not confounded. In fact, the realizations by layering have totally restored distinctively but in a coordinative manner, the motor parts of the machines and thus realized them as their motor form.

For more information, our previous works on the subject can be read. The brief reminder here of these notions has for object but to prepare the field for a better comprehension of the mechanical combinations, which in the current will be realized, for rotativo circular machines, horizontally. We will limit ourselves here to but a few machines.

The most obvious examples of these realizations are realized in triangular retrorotary engines and triangular post rotary paddle machines (FIG. 9)

In these machines, the displacement of the center of the paddles, in other words the positional displacement of the paddles, is no longer circular, but is also planetary. The mechanics of these machines all suppose a superior mechanic in which the support gear is dynamic and peripheral, since its set up fixedly at the height of the crankpin, or even polycammed and set up in the side of the engine. The superior crankshafts of these machines realize a similar action to that of the rod of a piston engine. There are more than two hundred mechanical combination possibilities.

Wankle's Second Gap and Second Vertical Degree Increase Solution: Poly Induction

We have abundantly worked on the notion of poly induction. To better understand not only originality but the reach of the notion of poly induction, and this, not only from the mechanical point of view but in addition to the conceptual level, we must make room for a comprehension of rotary machines from the point of view of the observation.

As we have said previously, the cylinder forms of rotary machines as well as their strictly positional support have appeared before the elaboration of various types of orientational paddle guiding. Consequentially, we can say that in the domain of rotary machines, the experience and practice have preceded theory. Starting in fact from paddles simply supported positionally by an eccentric and set up in a cylinder, we proceeded to one of two types of observations, observations which have previously allowed the mechanical composition assuring in addition the autonomous paddle orientation.

Types of Observation

We must necessarily think that to obtain the mechanical result by mono induction and by intermediate gear, we needed to proceed to the observation of the paddle from two different points of view. We'll say that the first type of observation is an observation from an absolute point from the exterior of the machine, (FIG. 10a) and we'll say that the second observation is dynamic and interior, since it can be realized from a hypothetic observer positioned on the crankshaft in course of rotation (FIG. 10b)

Observation by General Exterior Observation

In the first type of observation, said by absolute exterior observation, we suppose an observer located on the outside of the machine and observing the displacement of the paddle and the crankshaft. In post rotary machines, the observer will note that the paddle acts in the same direction of the supporting crankshaft, but slower than it. Inversely, in retro rotary machines, the observer will note that the paddle acts in opposite direction of rotation of the supporting crankshaft. It's from these observations that Wankle must have built his first mechanics, which we have named induction by mono induction.

In the case of post rotary machines, the necessity of producing a slower paddle movement than that of the eccentric has been realized by the use of a reducing paddle induction gear, being of internal type, coupled to an external support gear. In the second case, in other words, of retro rotary figuration, since the paddle must turn in opposite direction than that of the crankshaft, the paddle gear is of external type, whereas the support gear is of internal type, which will force a sufficiently accelerated retrorotation of the paddle so that the observer can notice, observing its opposite movement in relation to that of the crankshaft (FIG. 10a)

Observation by Positioning on the Crankshaft

The second type of observation gives birth to all other first degree mechanics, including Wankle's mechanic by intermediate gear, as well as our first degree mechanics, which are for example by semi transmission, and by hoop gear and by central active gear.

This type of observation is possible if we suppose that an observer is positioned on the machine's crankshaft and compares the direction of its own movement to that of the paddle. He will state that to the contrary to what goes on in the first case, the paddle always acts in counter direction of the crankshaft. There is no contradiction between the two observations. In fact, even if the paddle always turns in opposite direction of the crankshaft, its retro rotation speed varies depending on if it is a post or retro rotary machine. Thus, if its retro rotation speed is inferior to that of the crankshaft's rotation, as it is the case in post rotary machines, the exterior observer will continue observing that the planetary rotation is realized in the same direction of the crankshaft. In addition, if its retro rotation speed is superior to that of its crankshaft as it is the case in retro rotary machines, the exterior observer will continue observing a movement opposite to it in relation to the crankshaft.

We can deduce these assertions, that the mechanics to be constructed from an observation on the crankshaft, will not directly search to realize an action in the same or opposite direction of the paddle, as it is the case in the first observation, but a rotation in opposite direction to that of the crankshaft, but with different speeds however, thus realizing post or retro rotary machines (FIG. 10b)

Once again, for example, Wankle's induction by intermediate gear mechanically produces this observation. The paddle is activated not in a direct relation to the body of the engine, but by means of a gear set up on the crankshaft, in such a manner to be activated by its relation to it.

As we have already mentioned, mechanics by hoop gear, by central active gear, by semi transmission, and many others of our conception are mechanical implementations issued from this same perspective and observation.

It's from these types of observation that we were able to construct the resulting mechanics, which we can name first degree mechanics with forward prominence, and first degree mechanics with backward prominence, depending on if it's the front or back part of the paddle which produces the push, the opposite part producing as we have already shown, a counter push.

Exterior Observation of Displacement Points

A third type of observation can be realized and this type of observation will be the rational source of realization of poly inductive mechanics. In this type of observation, it's the case to realize an observation from a fixed exterior observation. However, here, it is not the case to observe the movement of the paddle in general, or even to compare it with that of the crankshaft, as in the case of the first type of observation. Rather, it's the case to observe the course of various points of the paddle for a rotation. We'll name this type of observation dynamic (FIG. 10c).

This observation will allow the realization that all point located on a line starting from the center of the points of the paddle traverses the caricature form of the cylinder in which it saunters. Secondly, this observation will allow to state that all point located on a line uniting the center of the sides to the center of the paddle traverses a form similar to that of the cylinder, but this time in its opposite direction. The observer will then notice that the points of the two shapes are always of equal distance between each other, which will allow the connecting of a rigid paddle to mechanics realizing these two points.

From this observation, we'll thus realize in combination two planetary mechanics working oppositely, which we'll name poly induction. (FIG. 11)

Original and Foundational Theoretical Aspect of Poly Induction

Once again, the method by poly induction is much more than a support method. It is in a way a geometrico dynamic comprehension completely contrary to that of thinkers of the previous art of which, Wankle himself. In fact, for Wankle and his predecessors, the geometric realization of all cylinder form is produced by subtraction of movements, in other words, a rapid central movement, that of the crankshaft, and a slow exterior movement in opposite direction, that of the paddle. As we have seen previously, there is confounded inversion and realization of the mechanical parts. The subtraction of these movements realized by the central eccentric and the paddle produces the curve of the cylinder (FIG. 12).

Thus the poly induction shows that the production of the curve of the cylinder can be realized totally differently by the additive and not subtractive manner of realization, of two positive movements, the first movement, the master movement realized by the central crankshaft, and the second, secondary movement realized by a subsidiary crankshaft. In addition, the slow master movement, is this time realized in the center of the machine, and by the crankshaft and not in periphery in a confounded manner with the paddle.

In addition to realizing the compressive, binding and mechanical machine elements in a dissociated manner, the poly induction shows without a doubt that the cylinder curve can be realized by the sum of two positive circular dynamic actions and not, as in the inventors of the previous art's case, by the sum of contradictory actions.

But there is much more to consider. As we'll see further, the type of movement dissection in sub movement realized by the poly induction will allow to realize on this foundation a new dynamic organization of the most important and determining, as much mechanically as theoretically, being the rotativo-circular clockwise paddle movement dynamic organization.

Before passing to this step, we'll however generalize certain notions of poly induction.

Poly Induction: Generalizations of Methods and Horizontal Repartition of Submovements: Rotativo Circular Machines

Here we intend to generalize the method by poly induction with the four following ways:

A) Mention that all induction can serve to command each post rotary subsidiary induction of a poly induction

B) That all site of point connection of the crankpins can be chosen, and will allow to distinguish the compressive, neutral and motor aspects of the poly inductive machine.

C) That during the realization with more than two subsidiary crankshafts, it is possible to conserve the slinky slope effect by realizing the poly induction dynamically, in other words, alternatively.

A) Poly Induction by All Inductions

In the standard poly induction, in double or many parts, each subsidiary induction can be assimilated to a mono induction however post rotary, comprising a post rotary induction gear, of external type, and a support gear, also of external type, common to each induction.

1) We simple enounce here that the post inductive action of each sub induction can be realized by all first degree induction, this one however realized in a post rotary manner. For example, we could activate each induction gear by hoop gear, by intermediate gear, and so forth (FIG. 13).

2) The second precision which we'll bring here is that all point of the paddle produces the form of the cylinder, but with different orientations depending on the situation. As we have previously noted, the points in the point axe, and the points in the side axe, produce complementary forms of the cylinder. We'll note in addition that the intermediate points produce the form of the cylinder but this time, obliquely. The machine could then be supported not by double articulation, but by tri articulation. In this case, the support by the sides will produce a descending anchoring, the support in intermediate position, a late, or early, descending anchoring, and the point support, a superior anchoring. We'll thus say that in the two first cases, the machine is of motor or neutral type. The supports in the sides realize a course opposite to the crankpins, vertical, and the parts of the paddle joining these support points to the points of the paddle must be considered as geometric additions which the effect will be to re-establish, in lack of these positions, and course, the initial curve expected. During a support by the points, the machine is of compressive type. Note that the last type was realized by Muelling. It is evident here that the poly induction can be realized in a negative manner.

The positioning of these inductions will allow, as this is partially realized in the double poly induction part, and anchoring and a slope effect in course of descent, which will allow the realization of the machine in its motor form.

2) During the realization by more than two supports, a great part of the Slinky slope effect realized in double disappears. Thus it is important to conserve this mega effect, which makes the inductions interact between themselves, and will not conserve them in isolated ratios of mini inductions. In addition, it is also important to realize a balanced and equally partitioned support between the various inductions of the faces of the paddles, as allow the triple part realizations (FIG. 13b).

The solution to this dilemma consists of realizing alternatively and successively a Slinky induction. To do this, we'll cut back the teeth either on the support gear or the induction gear in such a manner so that never more than two inductions, except for alternative transitions, work at once.

Each induction is thus alternatively motivated by its direct connection to the poly inductive mechanic, or even by its strict connection to the paddle. Consequentially, the paddle is always maintained minimally by two inductions and the third induction is mechanically free and lead by the paddle.

In this manner, not only do we assure the Slinky effect, but also subtract the contradictory induction, producing a somewhat counter push or half-push.

As we have just shown by the poly induction mechanic, the geometrico dynamic conception of these Wankle machines is not only a failed one because, as we have said, it lowers the number of parts composing the machine, but also because by doing this, they become inversed.

Wankle's Inversion Gap

To better understand this idea, we'll once again use for example, strictly piston engines. We'll compare in fact standard piston engines to orbital type piston engines and to rotor cylinder engines, the last two being taken from our Canadian patent. In the proposed standard and orbital engines, each compressive, binding and mechanical group, taken in isolation is exactly the same, in that the purely rectilinear action of the piston is transmitted by the rod to the crankshaft set up rotarily in the machine. The differences between these machines are only relative to the starting position of certain parts, such as the groups of piston cylinders and the crankshaft's crankpin. In the case of standard machines, we establish many successive explosions by setting up many crankpins in different quadrants of the crankshaft, each set of cylinder found on the same line. In our orbital engines, they are rather connecting points for the rods which are on a same line, since they are connected to the same crankpin. Inversely, the cylinders are set up in different quarters. Once again, the construction or deconstruction dynamic of the compression is exactly the same for these two machines, since the internal crankshaft, rod and pistons ratios are maintained.

The dynamic of the rotor cylinder piston engine is very different.

The rods and the pistons are all connected to a same fixed axe, de-centered, and the rotor cylinder is set up in a rotary manner in the center of the machine (FIG. 15).

The rectilinear action of the piston in its specific cylinder is thus the result of the double circular action of the cylinder and piston from different centers. This machine is much less powerful than the two other previously commented versions, and this explains itself since the power is in part transmitted from the center to the periphery before returning to the engines' central axe. There is thus a loss of energy. A second way to understand the power deficiency of this type of machine, when used as an engine, is to understand that the power is obtained, similarly to the obtained resultant between the skittle and the sail of a sailboat, by a very weak coupling angle, even halfway during the expansion.

If we want to determine the geometric cause of this insufficient energy production, we realize that the functions usually granted to the crankshaft have been deconstructed and subdivided, then granted to different parts. In fact, we state that the crankshaft's crankpin is realized as the secondary fixed axe, whereas the rotary part of the crankshaft is granted to the rotor cylinder. There is thus both the dismembering of the crankshaft, and realization of a dismembering part, which has been realized confoundedly with the cylinder. In fact, the rotor cylinder realizes both crankshaft components and a part of the compressive components. Now clarified, we see the contradiction more specifically, which consists of stating that a cylinder strictly rectilinear can only transmit so little energy when it is used as crankshaft. Thus, in summary, in rotor cylinder machines, rod piston and cylinder are present in the machine. It is the crankshaft which is not realized in its standard form, but rather realized in part with the cylinder. The crankshaft will thus be found in periphery.

To the light of what has preceded, we realize that the role of the parts of a motor machine is not definitive, and that many dynamizations of machines are possible. This being done, these dynamizations allow certain parts to play a different role.

In the case of the pre-cited machines, the strong knowledge of base dispositions, when it is realized standardly and orbitally, allows to understand easily enough that the role playing game realized in rotor cylinder machines is a constructed version.

In rotary machines, the charge taking of the construction mistake is much more difficult, since these machines have, since their origin, been set up reversed.

We must in fact suppose, that in all rotary machine, the master crankshaft, the knowledge of the inventors of the previous art, has been realized confoundedly with the paddle, and that, starting from the statements which we have taken from our poly inductions, the central eccentric is nothing other than the expression of a subsidiary crankshaft, set up in place and center of the crankshaft.

As we have previously said, the first gab of rotary machines is that they have no rods, and for this reason, have lost the rod effect. Thus, to the light of what we have demonstrated, we could affirm that if certain parts of standard rotary machines have been realized confoundedly, they are not, as in runner engines, rods and pistons, but rather, as in rotor cylinder engines, the crankshaft and the compressive part, the cylinder. We think that standard rotary machines are rather machines in which, as for the example mentioned above, the master crankshaft has been realized in one of the compressive parts, here the paddle. If this turns out to be founded, we could say that what we generally understand to be the crankshaft of a rotary machine, when realized by first degree inductions, is in fact but a subsidiary crankshaft, the master crankshaft being realized confoundedly with the paddle.

The rotary machines totally composed, as a previously commented example, layering machines and poly induction machines would include the correct compressive, motor and binding part arrangement.

If this supposition is true, we can say that in all the standard realizations, that are in first degree, rotary machines, the master crankshaft is cut back from its central position, to be replaced by the subsidiary crankshaft. Consequently the master crankshaft finds itself realized confoundedly with the paddle. We thus notice here that the second fundamental gap of machines, knowing that the master crankshaft is realized in periphery, confoundedly with the paddle, is completely correlative to the first, in which we have recognized an excessive lowering in machine parts and the confounded realization of certain elements.

Wankle's Third Fundamental Gap: the Differential Post Rotary Machine Realization

In the previous matter, we used for example piston engines, to show that first degree engines inverse the machine parts in a certain way. But the main example, that of the rotor cylinder, remains imperfect. In this case, in fact, the crankshaft is displaced in the cylinder whereas in the rotary engine, it is in the paddle.

We'll need to go further to give a valid image, when realized as a piston engine, of the rotary engine. This image will allow us to realize much easier the third gap which is in question here.

To make the reader understand our matter, we will serve ourselves once again from examples taken from piston engines, standard and rotary.

As we have already shown, standard piston engines are best set up when realized with a fixed cylinder, and when they're realized with a rotor cylinder, such as demonstrated in our previously cited Canadian patent and examples.

However, in the rotor cylinder machine, the crankshaft, as we have previously shown is subdivided, and one of its parts, the crankpin is realized by the support axe of the rods and pistons, and the other central rotation axe, by the rotor cylinder. It is possible, such as we have demonstrated in our Canadian patent application titled Poly crankpin energetic machine and simple induction machine to realize a contraction and expansion movement of the cylinder and piston by increasing the degree of the machine and duplicating the crankshaft, in other words, all while keeping the part which has been attributed to the cylinder, by completely reconstructing the initial crankshaft. The resulting will be a hybrid engine, composed of a standard engine, and a rotor cylinder engine. (FIG. 16.2) As we can state in the same figure, the opposite or same vectorial action of the two pistons can be obtained with a fixed cylinder and poly crankpin crankshafts in the opposite and same quadrants.

The action of this new crankshaft will be determined in both directions. We could in fact increase the post rotary speed and make it superior to that of the cylinder, or even inverse it in relation to the cylinder. Doing this we'll reduce even more so the power of the machine, or we could even increase it. In fact, in the first case, the push on the piston is realized against an element, the cylinder, which travels, however slower, in the same direction as it. The developed power is thus in part contradictory. It is only produced by the difference of the real push and of the counter push by reaction on the cylinder. Its for this that we'll speak of simply differential push.

Inversely, when the crankshaft is activated in the direction opposite of the rotor cylinder, the two parts travel in opposite (contrario) directions, and the expansion takes place on both these parts at once. As in the two semi transmission cases, the coordinating of the parts, the power, in the second case is not differential, but additive, since it is the result of contrario part movement.

We can thus deduce from the most common examples that the most pertinent comparative aspect of rotary machines, and particularly post rotary machines, when realized with pistons, the post rotary induction rotor cylinder, when realized with rectilinear rods. In this engine, the force is only differential, and in addition the rod effect is obliterated by use of the runner rod.

### SUMMARY

These three fundamental gaps explain the lack of power of these machines, and would open the door to a group of new solutions which would progressively determine the best position of the crankshaft and other elements.

Our layering and poly induction solutions show in fact that it is possible to correct advantageously these gaps. A third type of solution, original and extremely advantageous to many regards consist in the solution by clockwise paddle movement and rotational cylinder, which the dynamic has been set up in first part by this work. In this part we'll generalize this dynamic and show the pertinence of this generalization under the name of rotativo circular machines (FIG. 17).

In the next part, we'll go further, by generalizing a dynamic of our first works which is possible to realize centrally and independently, notably in poly inductions and layering inductions, and that this realization is confounded once again, but this time with the cylinder, in rotativo circular engines, is admittedly the realization which cuts back all the conception errors already commented, and which is the realization implementing the profound nature of these machines.

Summary of this First Part

In summary of this first part, we can thus enounce that the profound nature of rotary machines will thus be opposite to that of piston engines.

In standard engines, it is easy and evident enough to take knowledge of the truthfulness of this statement, since we can easily compare standard machines to their dynamic derivatives, rotor cylinder machines, and we can state easily enough where the elements are now.

In rotary machines, the same statement is much harder since these machines have been realized by use and experience and consequently, mechanical history has conceived them from the start, but inversely, in the absence of representation reference allowing the measuring of this counter orientation. The poly induction and layering induction allow this comprehension. We have thus functioned as if, in piston engines, standard piston engines have been invented after rotor cylinder engines.

In summary, and as astonishing as it may seem, we must understand that in rotary engines in their standard form, which plays the role of central crankshaft is easily assimilated to a rotary rod, or even to a subsidiary crankshaft set up centrally and that the real crankshaft is realized in an exteriorized, hidden, and confounded manner, with a peripheral component, and compressive, the paddle.

Second Part

Horizontal Reintegration of the Rod Effect: Clockwise Movement and Machines/Rotational Cylinder, and Horizontal Dynamic Generalization: Rotativo Circular Machines or Rotativo-Orbital

We now know that the three previous gaps are present in all Wankle machine. Not only is there an excessive lowering of composing parts of a motor machine, by the confounded realization of a few of them, but also that this confounded realization is in addition inversed, into what it is not, as in the case with runner rod engines, the rod which is realized confoundedly with the compressive part, but the crankshaft, and in addition post differential, which diminishes the power of the machine.

The motor power is thus cut back as much vertically as horizontally. It's this, simultaneously realized, inversion and diminishing in parts which are the profound causes of the non realization of the explosive power of the machine.

In addition, as we have noticed, even if layering mechanics and poly induction mechanics correct in large part the fundamental gaps of the previous art already enounced, they are not themselves perfect. The layering mechanics will very certainly offer a few resistances to a commercialization. We'll oppose in fact that to control the displacement of a paddle supported by the rotation of two superposed crankshafts, could in fact cause certain very material difficulties. In addition for the poly induction, we could oppose that the use of three subsidiary crankshafts for a paddle doesn't represent an economy in relation to that, in a standard engine, to use three pistons for a crankshaft.

Moreover, by showing that the position of the crankshaft confoundedly with the paddle isn't pertinent, we must also ask the question if bringing its position as that of the central master crankshaft, as in piston machines, is the best set up for rotary machines.

Observation from the Master Crankshaft of Poly Inductive Machines and Realization of Bi Rotary Clockwise Machine Movement (FIG. 18)

Let us note from the start that we have shown the sequences for a rotation of Clockwise mechanic, of first, second, and third level in the first part of this work. In the current part, we'll supply the theoretical explanations in a much deeper way; we'll generalize these assets and will determine rationally the composition rules of the mechanical groups allowing the adequate support of compressive parts.

To answer to the objections and questions mentioned above, a new type of observation will be relevant, type of observation which is made possible by the mechanical realization of the method by poly induction.

In poly induction machines, the rotation of the master crankshaft corresponds to a rotation equal to the relative speed of the paddle. We suppose, in this type of observation, an observer positioned on the master crankshaft, and observing, as in the previous cases, the behavior of the cylinder, of the paddle, and in addition, the subsidiary crankshafts. We must deduce that even if for us, exterior observers, this master crankshaft is in rotation, for the observer being positioned, given the constant speed, the reference frame will give much different results. In fact, the observer will neatly see the components of the circular rotary clockwise paddle movement in its entirety.

In fact, considering the paddle movement, the observer will state that its positional rotation movement is circular, and in addition, that the immutable orientation aspect, in other words that its orientation doesn't vary, despite its center's circular action. Similarly to the hands on a watch which turn, the numbers always remain at the same angle, being perpendicular. This is why we have named this specific paddle movement, Clockwise movement.

Inversely, when the observer will direct his regard towards the cylinder, he will no longer perceive it as we do from the exterior, as a fixed element, but rather as a rotational element activated in opposite direction of the paddle's circular positional movement. The observer will thus be in front, virtually, of the first expression of the bi rotary rotativo circular machine, the clockwise paddle movement/rotational cylinder machine. (FIG. 18) Another construction allows the realization of clockwise movement, and to demonstrate fully that it is fully issued from poly inductive cutting back, unknown to Wankle and his predecessors, is to enclose the crankshaft of a poly inductive machine, for example in a vice and to activate the remaining elements. We'll thus see that the paddle produces very exactly the clockwise movement and that the cylinder produces the contratio rotational movement. (FIG. 18)

Concrete Realization of the Clockwise Machine

The clockwise realization of the machine will be produced when we'll realize in a material manner the observations of the previously positioned observer.

There emanates from these explanations that the most concrete evident realization of the machine will be issued from a re-dynamization of the same mechanic which produced it. We can in fact imagine, starting from this observation that since the crankshaft is without movement in relation to the observer it will be immobile, and could consequentially be realized confoundedly with the side of the machine. The secondary crankshafts will be provided with induction gears and will be set up in a rotary manner in the side of the machine. They will be reunited by a means such as a third gear, assuring the similarity of their rotations. The paddle, which will be set up on these crankshafts will consequentially realize a strict circular movement, without orientational movement, being a said Clockwise movement. The gear uniting the induction gears will be the dynamic support gear, and will be coupled to the cylinder, which will assure the retro rotation. (FIG. 19) The same procedure could be realized fro retro rotary machines, but by using an internal dynamic support gear. Note that the clockwise movement machines with post rotary figurations realize a contratio movement of the compressive parts, and machines with a retro rotary figuration realize, when set up to the initial degree, a movement in the same direction. We'll come back later on these types of criteria of the most important for the motor machines.

Specificity and Originality of the Clockwise Movement of the Rotativo Circular Dynamic

If we pursue the comprehension of motor machines such as we have started, we'll realize that clockwise paddle movement machines are original and important, and this for many reasons, as much on a mechanical level as theoretic. These machines totally correct all the faults and gaps of rotary machines of the previous art, and this is understandable since they exceed the normal machine categories to realize both piston and turbine machine qualities. As we'll demonstrate further, the specific clockwise movement can be obtained by a group of important mechanical combinations. However, the previous realization, by fixed polyinduction already allows an understanding of the following. The clockwise movement has the following major mechanical and theoretical advantages. (FIG. 17)

A) The machine, contrarily to all machine of the previous art is, dynamically, perfectly bi rotary. In fact, as we can note, the paddle has no orientational rotation. It is neither post nor retro rotary. It has a de-rotation in relation to the crankshaft very exactly located between post and retro rotary de-rotation. It thus has a similar nature not to that of rotary machines of the previous art, but rather to that of poly turbines. By its nature, it will always need in fact two inductions to correctly activate the parts.

B) Consequentially, the machine realizes, contrarily to all machine of the previous art, no counter push on the paddle. Similarly and in the same manner, superior to that of a piston, the push is realized not only on the totality of the surface of each paddle face, but also perfectly distributed to each side support points for their mono inductive poly inductive support (FIG. 20). This characteristic allow once and for all to advantageously compare the push of rotary machines to that of piston engines.

C) The machine, opposite to all rotary or piston machine from the previous art, and similarly to turbines, the clockwise paddle movement, as well as the mechanical parts produce no acceleration or deceleration of any of the parts.

D) The machine distributed the layering of the poly induction or of the layered inductions, this time horizontally, which cuts back all machine vibration

E) The cylinder curve will lead its retrorotation, and this retrorotation will realize an effect similar to that of the rods in the piston engine, and an additional force to the machine

F) The parts restore horizontally the minimal number of constructive parts allowing to realize the machine in its motor nature

G) Finally, the paddle and cylinder posses a contrario movement, which we find at no location of the previous art, except in our simple induction machine realizations, realized with pistons, and tumbler pistons.

The rotativo circular engines with clockwise paddle movement comprise both, qualities of piston engines, rotary engines, and orbital engines and of turbines, all while comprising but very few of their respective faults.

In fact, if we compare these machines to piston machines, we see that the paddle of these machines accepts an equally distributed push as in piston engines. We see that all point of the paddle and, consequentially, of its surface, travels at the same speed. In a certain manner, we can even say that the push is superior to that of piston engines, since the paddle, being directly connected to the crankshafts, renders the rod's angulations inexistent. It will result in an absence of friction and of energetic expense caused by the negative counter pushes.

In addition, if we compare these machines to rotary machines, we see that they can use the same figurations, and consequentially realize closed combustion chambers. In addition, the rotationality of the parts can allow the use of light valves.

Finally, if we compare these machines to turbines, we see that as in turbines, except when they are realized with the help of polycammed gears, all the parts with no exception travel at a constant speed, and there is absence of acceleration and deceleration of all compressive or mechanical parts.

It is therefore a type of motor machine located at the confluence of totally different motor machines of the previous art, which recovers the most essential qualities of each of them but recovers but a few of their faults. The push should give them the power, the figuration a minimal number of parts, and the rotativity a velocity and longevity which is maximal and unequaled in all other motor machines (FIG. 21).

We must state that the geometric dynamic of contrary poly induction, as we have shown Wankle's, is the dynamic which allows a just and valid cutting back of movements entering the composition of the paddle's planetary movement, in two specific movements, and then, to restitute them horizontally by the clockwise/rotary cylinder dynamic.

If our reasoning is founded, this allows us to now answer the interrogation which we have previously left suspended. We have in fact shown that Wankle's and the thinkers from the previous art's geometric conceptions have been inversed the composition of the parts by setting up the crankshaft confoundedly with the paddle, peripherally and planetarily, which deprived the machine of all its motor substance. We have then restored a, so to speak, “piston” vision of the machine by realizing it by master and secondary crankshafts, by asking ourselves if it really is the most pertinent set up.

To the light of what we have just shown, it appears that the most pertinent set up consist in realizing the machine horizontally, by realizing the crankshaft confoundedly, this time around, with the cylinder.

As astonishing as it may seem, thus, whereas the least pertinent set up for piston engines is that of the rotor cylinder, it turns out to be the most pertinent for rotary machines.

Clockwise Movement Paddle Machines and General Rotativo-Circular Machines:

Generalization

In the next section we will apply ourselves to demonstrate that rotativo circular machines constitute a specific determined type of machine, to realize, so to speak, motor machines horizontally, by opposition to the vertical plan which we have demonstrated the existence of in the first part.

To do this, we'll show mainly that rotativo circular machines can be produced with all the existing inductions, in the measure where we specify the notions of semi transmissions, ascending, and descending inductions.

We'll then show that they can receive all types of standard machine paddles. We'll then show that they can establish different realization degrees dynamically. We'll then show that a correct comprehension of these machines requires the distinguishing of their material, virtual, and real aspects. Finally, we'll show that the group of these generalizations will allow us, by the combination of two horizontal and vertical plans, to produce a global and criteriological synthesis pertinent to all motor machine.

More specifically, we'll make matter of the following points:

Mechanical Generalization
a) Clockwise movement by central induction
b) The methods by semi transmission by considering them as an induction transferred from center to center, said horizontal induction
c) The methods by ascending, descending, and horizontal inductions
d) And we'll show that the layered induction combinations can be produced horizontally, and allows the support of the compressive parts of rotativo circular machines.

Figurative Generalization
e) That all rotativo-circular machine possesses all the variants of all other machine, knowing if it is applicable
   4) As applicable to post rotary machines as retro rotary
   5) That they apply to machines with all numbers of sides
   6) That they apply to rotary machines, such as poly turbines
   7) That they can also be produced accelero-deceleratively
   8) That they can also be produced with simple paddle combinations, cylinders, simple paddles, standard polyfaced paddles, paddle structures
Dynamic generalizations
   9) That they can be realized by degrees, by clockwise paddle movement of first degree, of second degree, these degrees being able to be realized either horizontally or vertically
   10) That they can possess various differential, retro and post rotary, and contrario mechanical degrees
   11) That they can, when realized with a contrario mechanic, realize material, virtual and real cylinder figures.
   12) That they can, as static cylinder machines, be realized in bi functional compressive parts.
These additions will allow us to globalize the group of our enterprise and to show:
   13) That the group of all the possible machines can be set up in chromatic scales
   14) That the determination characteristics of all machine can be specified by a very large group of generic criteria, including the criteria of the previous art
   15) That many semantic difficulties of the previous art can be correctly specified: appropriate mechanics for rotor cylinder dynamics, working in the direction of the machine
   16) That the mechanics by polycamation can also be used to contain stand-up forms of retro rotary machines
   17) That they can be realized in center-peripheral inversion, by clockwise cylinder/rotary paddles
      Mechanical Generalizations
      Clockwise Movement by Central Induction

We must now note a very interesting characteristic of clockwise dynamics. In this case, all paddle point describes the clockwise movement exactly, and even the central point of the paddle. Consequentially, the paddle can be supported by its center. In addition, it is important to reiterate the perfectly birotary character and nature of this movement. Starting from these two ideas, we'll state that, to assure the support by the center of the paddle in Clockwise movement, we could use all induction issued from the observation by the crankshaft, by taking care to realize however original support and induction gear ratios, assuring the bi mechanicality, being a ratio of support to induction gears of one to one. In fact, in the previous art, as we have specified, we always intend on making the paddle turn in such a way so that it has a distinct orientational character, either post or retro rotary. Consequentially, we always realize gear rations either by larger support gears, during retro rotary generalizations, either by smaller support gears, for the post rotary realizations. Clockwise paddle realizations and the induction ratio of one to one which their support requires are not in the order of thought of the initiators of the previous art. This ratio prescription, original to the realization of Clockwise movement explains itself by the fact that to realize an orientational non rotation of the paddle, it needs to undergo a perfectly equal retro rotation to the post rotation of the crankshaft. Since the central crankshaft of these machines is equivalent to subsidiary crankshafts of the poly induction concentrated into a single one, and that all the inductions are possible, the same methods all apply here, by respecting the aforementioned ratios. We can consequentially realize the orientational support of the paddle by intermediate gear, by hoop gear, by central active gear, and so forth, by respecting the clockwise ratio of one to one. In addition, the use of simple mono induction is impossible, and this shows well the originality of these machines. To realize the clockwise movement, we must, by this induction, use the semi transmittive method, a method by which the retro rotation of the support gear will accelerate the orientational rotation of the paddle to a speed equal to that of the crankshaft. (FIG. 22)

We now know that it is possible to realize the clockwise movement of the paddle by fixed poly induction, the induction gears being lead in the same direction by intermediate of an external gear, internal gear, by chain, or we can even realize the clockwise movement of the paddle by central induction by the same one to one ratio.

But as in layering machines and poly induction machines, clockwise movement machines restore the rotivity levels necessary to a full and entire motor action. As the poly turbines, by their nature, Clockwise movement machines are second degree machines since they always need two inductions, this time horizontally set up. We must in fact proceed, in a supplementary manner to the retro, or post, rotary governing, depending if the machine will be post or retro rotary, of the rotary cylinder.

To do this, we must beforehand specify three notions which are that of horizontal induction or semi transmittive, and that of ascending and descending inductions (FIG. 18b)

Semi-Transmittive Inductions or Horizontal Inductions

We have shown many times the importance of semi transmissions, since they allow us to modify initial machine figures, or even, to make these machines apt to restore their retro and post rotary power of a same paddle.

We can say that there mainly exist two types of semi transmissions, accelerative or decelerative transmissions, and inversed transmissions. We can also say that each of these semi transmissions could be produced with standard gears, internal or external, or pinion gears (FIG. 23).

In rotativo circular machines, it will often be necessary to realize semi-transmission confoundedly, inversely and accelerative. This will happen mainly when the action of the cylinder will be activated in relation to that of the eccentric. Since the cylinder acts in contrario of the paddle, and at a different speed than it, we'll need a semi transmission realizing both these necessities at once.

The poly inductive semi transmission inductive is very simple to this aspect. It will be the case to set up, in a rotary manner, in the block of the machine, inversion gears. We'll then provide, depending on the necessity, the crankshaft's tree with an external type gear coupled to these gears, and we'll provide the rotary cylinder of the machine with an internal type gear. This gear will itself be coupled to inversion gears. The result of such an arrangement will allow in a condensed manner to realize the anti rotation and the speed reduction of the cylinder in relation to that of the crankshaft. Note that in certain occasions, the speed of the parts could be equal, and in other cases, that of the rotary cylinder will be superior. We could also proceed by pinion gears. We'll couple one of the pinion gears to the crankshaft and the other to the cylinder. We'll couple one of the two gears by the intermediate of a pair of inversion gears, taking care in choosing one of the two gears with a dimension superior to the other. Each of these gears being coupled to the crankshaft or cylinder's gear. We'll obtain both the antirotation and the necessary speed difference required. (FIG. 23)

Generalization: we enounce that all the inductions can thus be transformed into semi transmission, and for this reason, the semi transmission could for the means of the current be named justly horizontal induction. We'll find, in our previous patent applications as well as in our antecedent patent applications, many examples, which all answer to the current definitions.

Ascending and Descending Inductions

By ascending inductions we mean all first degree induction of the previous art as well as ours and of superior degrees, in which the support gear is set up centrally, and which the induction gear is set up peripherally. For example, inductions by mono induction, by hoop gear, by poly induction are ascending inductions.

Contrarily, if we set up a support gear, this time peripherally, either set up rigidly on the crankshaft's crankpin, or even, for example on the paddle of a machine, and from this gear, we activate a central gear, we are now speaking of descending induction. The use of these two inductions in combination in a standard machine can allow the creation of a paddle support different from the motricicy axe which will be activated by the paddle. At the limit, this would be a method said by elized semi transmission (FIG. 23).

In the case of rotativo circular machines, we could, by a paddle side, activate its Clockwise movement, and by the other paddle side, set up on the paddle a peripheral support gear, and by means of an induction, for example hoop gear, lead the retro rotation of the cylinder. (FIG. 23)

Three Great Support Methods for First Degree Clockwise Movement Rotativo Circular Machines

As we have shown for the induction layering in height, since there exists more than fifteen first degree inductions, and that each of them can be combined to a second first degree induction, however, this one being peripheral, we have a very impressive number of total inductions.

In the same way, if we accept the simplification which we have previously produced to the effect that all semi transmission is a horizontal induction, or in other terms a neither ascending nor descending induction, but rather transferred on the same center, or on itself, and consequentially all induction can be transformed into semi transmission, and in addition that rotativo circular machines always require two confounded and coupled inductions, we notice that there exists here an impressive number of possible induction combinations which would be very difficult to completely index.

A rational and synthetic regulation of their organization will allow us to not have to expose all of them, and this time to correctly group them. This rule is as follows:

We can realize the combined support of all rotativo circular machines by using as combinatory parts, (FIG. 24)
a) The paddle
b) The crankshaft
c) Or the induction gear of the cylinder, each of these ascending, descending, or semi tranmitive inductions being combined to this same element which we will have determined.

To better understand this last statement, we simply need to grasp the idea that the movement of the cylinder and that of the paddle must be perfectly coordinated and synchronized. Consequentially, their inductions must also be coordinated and synchronized, which signifies that they must have a dependence characteristic of one to the other. In other terms, there will need to be minimally one of the parts of their respective action, which must be shared, must be the same for the two inductions. These parts will either be the paddle, the crankshaft, or the induction gear.

Combinatory Paddle Interdependence

General rule, we'll realize the interdependence of the system by means of the paddle by activating, as we have previously demonstrated, the Clockwise movement of the paddle by one of the inductions, with a ratio of one to one of the support and induction gears, and we activate the cylinder inversely, once again from the paddle, by a descending induction, by setting up on the paddle a peripheral support gear, and on the rotary cylinder an induction gear. (FIG. 24)

In this manner, when the paddle will be activated by the crankshaft, by means of its ascending induction, it will activate the cylinder, and inversely when it will be activated by the cylinder, by means of its descending induction, it will activate the crankshaft. All induction could thus serve as ascending or descending induction.

Combinatory Interdependence by the Crankshaft

In the induction combination methods by the crankshaft, we'll realize from the crankshaft an ascending induction of one to one which will assure the correct Clockwise paddle movement. In addition, we'll connect, as we have previously shown, the cylinder and the crankshaft by means of an inverso-accelerative semi transmission. Consequentially, the paddle and cylinder movement will be totally coordinated. To realize this type of induction, we could use, for the paddle, of any induction, and for the cylinder, any semi transmission. Many combinations are therefore possible. We'll consult with our works, in antecedence, and our previous works to take knowledge of many examples to this effect (FIG. 24, 55, 56, 57)

Combinatory Interdependence by the Paddle Support Gear

As we have previously shown, we must realize the support gear and paddle ratio, in the order of one to one to assure its Clockwise movement. In addition, we know that we can, in the measure where we modify adequately the induction and support gear size ratio, we can instigate the support gear by any induction, thus making it semi transmittive, without modifying the orientational rotation ratio of the paddle in relation to its initial dynamic. It is thus possible, from the crankshaft to realize a retro rotary and semi transmitive management of the support gear of an ascending paddle induction, which we have realized many times in our works.

In the case of rotativo circular machines, we'll need to motivate the dynamic support gear in such a way so that all while allowing the respect of the one to one characteristics of clockwise movement, it activates, being fixed solidly, the retro rotation of the cylinder, consequentially we can say that the same semi transmission will activate the dynamic paddle support gear, and that this dynamic paddle support gear will be, confounded with the cylinder's induction gear. The two systems will thus be, in a large sense, connected by the same semi transmission, and in a way restrained by the gear, serving as support gear on one level and as an induction gear on the other. (FIG. 24)

As previously, many configurations are possible, since there exists many semi transmissions, but the logic will remain the same.

Fugitive Generalization

Clockwise Movement Machines with Post and Retro Rotary Paddles

Although of original dynamic, reminding, as we have said, the qualities of piston engines and turbines, rotativo circular machines use paddle and cylinder geometric figures from the previous art in a new way. Clockwise paddle movement rotativo circular machines are consequentially realizable just as much in a post rotary figuration as a retro rotary figuration. We must however note that their dynamics are different; a post rotary clockwise movement machine realizes a contrario movement of the compressive parts whereas retro rotary type machines realize a cylinder and paddle movement in the same direction. (FIG. 25)

Clockwise Paddle Movement Rotativo Circular Machines and Number of Sides

As we have already observed, the figurations of the compressive parts of rotativo circular machines are similar to that of standard rotary machines, when they are realized in the first degree. We thus must specify that all the figures of retro or post rotary machines can therefore be realized in rotativo circular mechanics, with clockwise paddle movement. In fact, for example, in a triangular cylinder, four-sided paddle post rotary machine, the paddles will always possess clockwise movement and the cylinder will always be anti-rotational. In the same manner, in retro rotary figurations, the three sided paddle will have a clockwise movement in the same direction of it's strictly rotation cylinder (FIG. 25).

Clockwise Paddle Movement Rotativo Circular Machines and Bi Rotary Machines

The poly turbine type of machine, in which the cylinder and the compression paddle structure have been invented by Wilson and which we have furnished the adequate mechanics when the cylinder was fixed, can also be realised rotativo-circularly. In these cases, the subsidiary crankshafts, added with geometric rods will realize a strictly circular action, which will realize the rhombuso-squareoid control of the paddle structure. Their induction gear will be coupled to the cylinder gear which will complete the system rotationally. We'll note here that even if the induction crankshafts and the cylinder have no acceleration/deceleration, the paddle structure, more complex, realizes its oscillatory aspect, an aspect on which we'll return further, for all machines. (FIG. 26) We must also note, as we'll see further that many rotativo circular dynamic degrees will be possible for all machines, including poly turbines.

Rotativo Circular Accelero-Decelerative Paddle or Cylinder Movement Machines

We can, as for all machine, use in the set up of rotativo circular machines polycammed or poly cammed derived gears, which will produce modifications in their cylinder forms resulting from the accelero-decelerative movements of the parts. We'll use mechanics similar to those we have already described in our differential turbines, in which the cylinder will be supported by polycammed gears, realizing a strictly circular, but accelero-decelerative, support action.

We could for example decide to conserve the rotary movement of the cylinder's irregularity, but grant the clockwise movement a certain accelero-decelerative irregularity. We'll thus modify the cylinder and we'll then realize a superior thermo-dynamicism, as when it is applied in standard machines. In rotativo circular machines, we could inversely realize the movement of the rotary cylinder accelero-deceleratively. (FIG. 27)

Clockwise Movement Rotativo Circular Machines: Paddle Types

We could realize rotativo circular machines with three types of paddles which could also be used in standard machines.

Firstly, we'll use a combination of unitary paddles in the cylinder and produce explosions between each of them and the cylinder, or between all of them and the cylinder (FIG. 28). In these two manners, the combustion chambers could be common, which would have for effect to multiply the reach of the crankshaft by two. We could thus considerably increase the compression ratio and realize these machines with a diesel gas system.

Of course, we could realize these machines with multi-faced paddles, in other words standard paddles, or as we have previously determined with paddle structures (FIG. 28).

Clockwise Paddle Movement Rotativo Circular Machines and Number of Degrees

The clockwise movement in its most natural state is realized by the positional movement of the circular paddle. It can, as we have also shown in the first part, also be non circular, for example rectilinear (FIG. 29b). It can, when the reach of the central crankshaft is large, inscribe itself in a non rotational cylinder movement, but planetary. In these two last cases, it is necessary to increase one of these inductions of degrees to realize the machine (FIG. 29 c,d,). The rectilinear-clockwise movement of the paddle requires an induction layering effect. In addition, the planetary movement requires an induction degree superior to the simply rotary movement.

Clockwise Paddle Movement Rotativo Circular Machines, and Symmetrical Oscillatory Contrario Movement

We can also realize the paddle movement in an oscillatory clockwise manner with support from polycammed inductions. In fact, the ratios of one to one will remain for a rotation, but with the means of polycammed gears, the orientationally fixed movement will be alternatively variable (FIG. 30, 31).

This will allow the realization of figures of odd cylinder machines with opposite unitary paddle movements, and to realize the oscillatory character of poly turbines.

Clockwise Movement Paddle Rotativo Circular Machines and Rotational Paddle

We have, beforehand, shown that we can realize machines with fixed paddles and planetary cylinders. In these cases, the figure realized is a virtual figure corresponding to the real machine induction. For example, a triangular type figuration, in which the cylinder is planetary and the paddle is fixed, requires a post rotary machine mechanic of a three sided paddle and two sided cylinder figure. This means that the retro rotary type of figure is the virtual figure of the real post rotary figure in complementary position.

In the same way, the clockwise figures can also be inversed from the center to the periphery. To realize these inversions perfectly, we must, as it is the case with standard figures, set up the figurations in their complementary direction, and use the support mechanic of the real figure, and not the virtual figure (FIG. 33). Thus, we can realize machines possessing a clockwise cylinder dynamic and a perfectly rotational paddle dynamic. Of course, as before, the cylinder can be a group of unitary cylinders, in standard polyfaced cylinder structure, or paddle-cylinder structure (FIG. 26).

In the same way, clockwise cylinder movement machines can be realized bi functionally, the cylinder of one is being simultaneously used as paddle of the other. (FIG. 56). These procedures allow powerful turbines or two time or anti repression management.

Dynamic Generalizations

Rotativo Circular Machines and Dynamic Degrees

As we have shown previously, rotativo circular machines can be increased in degrees by modifying the course of the center of the paddle, all while keeping intact the fixedness of the orientation aspect of the paddle. The degree of machines, so to say, has been increased figuratively, and not dynamically. The following matters will have for objective to show that rotativo circular machines can be increased in degrees dynamically. We'll thus enlarge the notion of Clockwise movement machine by that of rotary circular machines.

We'll show in the following matters that the Clockwise dynamics are not only important from the practical point of view, and this in regards to qualities which we have already enounced, but also, from the theoretical point of view. We'll show in fact since they constitute a major segmentation axe allowing realize the delimitations of dynamicism areas of machines and to realize the comprehension of motor machines on a totally different level, being the angle of dynamicism degrees. These comprehensions will allow to create on a level the complete scale of rotary machines, and to correct many semantic errors of machines of thinkers of the previous art, all while including them in a much more general theory, possessing characterizations of much more powerful and effective machines.

The following matters will show that we can realize similar dynamics in rotativo-circular rotary machines, that in rotor cylinder piston mechanics which we have previously exposed, as exemplary title.

In fact, up to here, we have only commented on clockwise paddle movement rotativo circular machines. It is however possible to realize machines in which the paddle movement will not be. We can for example suppose a machine in which the paddle movement, a two sided paddle will displace itself in a one sided cylinder, this cylinder however being not fixed, but rotational (FIG. 33).

We'll consider in this first case that the paddle has a retro rotation allowing it to realize three faces. The retro action of the cylinder will compensate the figures. We'll thus state that we can realize the machine in such a manner so that the paddle and the cylinder act in the same direction. The push between the parts would then be only differential.

Conversely, we can suppose, for a same type of figure, a slower paddle retro rotational movement, and a post rotational cylinder movement allowing the fulfillment of this alteration (FIG. 34). Even here, but this time post actively, the paddle and cylinder will act in the same direction, but differentially one in relation to the other.

Finally, we suppose the fixed cylinder mechanic (34), where the realized force is neutral, and the movement dynamic is clockwise (FIG. 34), in which the movement of the paddle and cylinder are contrario, thus developing a lot of energy. Very finally, we could, as Wankle has done himself, realize the paddle and cylinder strictly rotationally (FIG. 34). We thus see that for a same figure, five very different dynamics are possible.

Comprehension

To better understand the rational character of the last examples, we'll enounce a formula which could then be applied to all machines. We'll say that this formula is the dynamico-mechanical regularization formula, or cylindrical counter part formula. This formula, thus, is enounced in the following way.

In all machine, we can for a same paddle cylinder figure, displace the next compression area by advancing or backing it up in relation to the standard area of the next compression, this area being realized when the machine's cylinder is fixed. In counter part, we'll effect a mechanical regularization and the cylinder will have to dynamically be displaced for as much.

Let us give an example. We know that during a standard dynamic, for example of triangular paddle and two sided cylinder, we can measure the difference of angulations between the various culminating paddle points, corresponding to the emplacements of successive explosions, and that in this case, we realize an angle of eighty degrees. In the triangular engine, one hundred and twenty degrees separate each explosion location (FIG. 34, 35).

We can determine for a figure, freely all new perpendicularity location to the eccentric on the successive paddle surfaces of each paddle. Consequentially, this foreseen point of new expansion will not be realized by standard angulation for the new paddle rectification. For example, if we want to realize the new compression point not at one hundred and twenty degrees, but rather at sixty degrees, we'll realize that there is missing a displacement of one hundred and twenty degrees to be standardly realized. We'll thus need to compensate this difference by a mechanical regularization by applying the angulation difference of this new maximal expansion point and that of standard expansion to the cylinder. Consequentially, we'll make the cylinder realize a retro rotation of one hundred and twenty degrees.

As we can see, if this point is anterior to the standard point of explosion, it must be compensated by a cylinder retro rotation, equivalent to the same angle separating these two points. In addition, if it surpasses the standard explosion point, we'll need to give the cylinder a post rotary action in which the angle will be equivalent to this difference to be maintained.

For example here, if we intend to produce the following explosion at two hundred and forty degrees, we'll calculate sixty supplementary degrees to the standard position. The cylinder will therefore have to be activated post actively of sixty degrees. However, this only rule doesn't manage to effectuate a correct and complete report of all the mechanical possibilities in the matter. To well understand the types of rotativo circular machines thus created, we must call on the notion of paddle retro rotivity.

As we have already mentioned, in all rotary machine, the paddle has a retro rotary action in relation to its eccentric. We have already determined that the retro rotary action more or less pronounced would allow us to determine if the machine was of post or retro mechanic nature. In the two previous examples, it is to be noted that we have, by advancing or backing up the moment of explosion, increased or diminished the de-rotation speed of the machine's paddle. By analyzing in more detail the examples of these examples, we notice that when the machine paddle attains its next compression after only sixty degrees, it thus realizes six explosions per rotation. The retro rotation will thus accelerate to such a point that we'll need to use a retro rotary type of induction, for example a mono induction with internal support gear and external induction gear. In the second figure case, the paddle retro rotation speed will remain weak and the machine will remain of post rotary type.

We thus see that, for a same figuration, the dynamico mechanical machine alterations make the machine pass from post to retro rotary.

Once again, clockwise paddle movement proves to be important, since its perfectly birotary dynamic nature allows to consider it here as a segmentation limit of the most important. We can once again give the image of this bi rotativity of clockwise machines by saying that the paddle realizes explosions at the same places as its inversed figure, being here for example triangular. The clockwise dynamic is thus an important mechanical hinge. In fact, we can accelerate the de rotation of all post rotary paddle, without changing its nature, up to the clockwise limit point. If we accelerate the paddle retro rotation any more, the machine becomes retro rotary.

Figurative and Mechanical Evidence

The mechanic is admittedly the best proof of belonging of a machine to one class or another.

Here, in the clockwise mechanic, the mechanical realizations, in a one to one ratio, are perfect proof of the perfect bi mechanicality of the machine. It sways neither to the side of post, or retro inductive machines. During the use of this sort of mechanics, particularly in mono induction, we must correct them by semi transmission to realize them bi mechanically. In the same way, if we consider the definitions of the paddle movement in relation to that of the crankshaft, observed from the exterior to define the post or retro rotary character of the machines, we notice that here again, the paddle turns neither in the same direction of its crankshaft, nor in opposite direction, since it rotates but positionally.

As for the capacity of dynamic retrorotary realization, we can understand that, as we have already said, in retro rotary machines, the paddle de-rotation in relation to its crankshaft is more accentuated than in post rotary figures. By understanding that this is the consequence for a same paddle of a larger number of cylinder sides and consequentially of a bringing closer together of them, if we understand that this bringing together, even if artificially produced, needs itself an accelerated paddle rotation and a retro rotary mechanic.

If we observe strictly the unfolding of the movement of the paddle of a rotativo circular machine in which the paddle has been accelerated beyond that of the clockwise bi rotary dynamic, we'll state that i twill describe a virtual figure different than that of the material figure, this time retro rotarily.

We must therefore be clear that the mechanical realizations of rotativo-circular machines must take these points in account and that we must take in account the virtual paddle figure to determine the adequate paddle mechanic, and the nature of this machine.

We'll come back later on these notions of material and virtual figures and will show that we also needed to add that of the real figure. But before that, it is necessary to treat of another important subject, being that of differential and contrario movements.

Differential and Contrario Movements as Compressive or Motor Movements

We can determine the important differences between the various machines with rotary-circular movement, which this time are not in relation with the post or retro rotivity, but rather in relation with the realization of these machines as their compressive forms, or as their motor form.

Even here Clockwise movement machines will be of a notable use and relevance to define the current matter. In fact, in the current section it is necessary to conclude by clearly enouncing that if rotativo circular movement machines can be subdivided in machine classes, they can also realize another sub division, of the most relative, being that of compressive or motor machines.

We can enounce that which follows. All machine in which the location of the next compression is located between the standard compression area and the Clockwise compression area, will have a contrario action of the compressive parts, which will assure it a motor power. (FIG. 45, 47, 4.2)

We can also enounce that which follows; all machine in which the location of the next expansion is posterior to the location of the next standard expansion will see its compressive action completed by an action of the cylinder in the same direction (FIG. 47, 49). The machine will thus remain post rotary, but will become rotativo-circular, and in its nature, Compressive, since the resulting force will be but differential.

We can finally analyze the following statement; all machine in which the retro rotivity movement will be accelerated further than the clockwise movement, and which will consequentially realize its next expansion location before the area of the next expansion in this machine will not only become retro rotary, but will also loose its contrario capacity, and will become differential. This machine will thus be a rotativo circular differential machine.

In fact, as in rotor cylinder piston machines which we have previous presented as an example, rotativo circular machines can be subdivided in motricity classes, being the contrario, and the anterior or posterior differential classes.

If we intend to then realize a visual image of the group of these possibilities, we'll determine the following hinge points (FIG. 49.2)

a) The fixed position, the unison: a strictly figurative representation of machines of various degrees, when not in motion

b) The “fifth” position: a position of first compression when the machine is realized by fixed cylinder, with planetary paddle

c) The “third” position: a position of the first compression of the decelerative dynamic

d) The “octave” position: a position of the parts when all the movement has been completed, when the next compression position is at the same point of that of the unison

We could then create rotativo circular machine zones.

We'll thus find:

a) Between the unison and Clockwise position, anterior differential types of machines

b) Between the Clockwise and fifth positions, standard, rotativo circular contrario machines

c) And between the standard fifth and octave positions, the posterior differential rotativo circular dynamics.

It is to be noted that we make distinction here for post rotary machines. We'll show that these distinctions apply, by regularizing them, as evidently to retro rotary machines, as to planetary cylinder/fixed paddle, or birotary machines.

These distinctions are still insufficient to fully describe all machines. In the next section, we'll show how, with the help of virtual and real figures, we can complete this final table and realize a correct report of more complex machines.

Material and Virtual Figures

In our last examples, we have applied a general displacement regularization rule of the displacement of the next explosion, allowing counterbalancing of this positional material change by correct rotary cylinder activation. We'll note that if we have chosen alternatively the new compression position, and in addition that we have effected the corrections statically and that for this new compression.

We'll however note that even if the rule that we have given is applicable to all new position, the realization of the obtained machine will pose problems when these new positions will realize more complex angles. For example, in a standard machine, if the new compression is found at seven degrees, this will take many rotations of the machine before finding its initial position.

In addition we'll also notice that we can determine certain new positions which have a mechanics semantic value. The most obvious, for example, for a machine of a given rotivity type, for example, post rotary, consists in giving to a given paddle, the new compression position of it's counter part, here, for example is retro rotary.

For example, since we know that a two sided paddle can feed a one sided post rotary cyinder, or three sided retro rotary cylinder, we could take a paddle of two sides and a one sided post rotary cylinder, and determine the point of the next explosion at the same points as in retro rotary triangular engines. We'll compensate this change by a cylinder rationalization, mechanically organized in the same way as for all clockwise movement machines (FIG. 35.4)

We'll thus realize that the mechanic supporting the paddle is exactly the same mechanic as a triangular retro rotary machine, and that for this reason, if we follow the paddle displacement, we'll note that it describes exactly this form. In addition, since the cylinder is rotary and this arrangement has been obtained by the change in position of the new compression of a post rotary machine, the material figure of the paddle and cylinder will remain post rotary.

Let us give a second example, this time starting from a retro rotary form, more precisely with triangular paddle and squaroid cylinder. Normally, each new compression of this machine occurs at each ninety degrees (37.3). We can however intend to determine this new explosion at one hundred and eighty degrees. According to the previously given rule, we'll proceede to a regularization by a post activation of the cylinder of ninety degrees, being the difference between the degrees of these two standard and projected positions.

Doing this, we'll state that the paddle control will have to be assured by the same mechanic of that of a post rotary paddle of a triangular paddled and double arc cylinder machine, by however conserving the length of the reach of the crankpin of the material form. This will be confirmed by an isolated observation, of the action of the paddle. In addition, the rotation of the cylinder allows the conservation of the material cylinder of the first machine.

We thus see that it is absolutely necessary and pertinent to determine some notions, apt to allow us to take in account these situations. Consequentially, we'll call the form of the paddle and cylinder before alteration, material forms, or material figures. In addition, as the form described by the paddle only allows not only to prescribe the mechanic, but also to determine the location of accessories such as, the spark plugs, the fueling and exit areas, we'll say that the form of the paddle and of the cylinder visually realized will be called virtual forms or figures.

We could then give other examples which aren't simple counter parts. We could, for example, realize a two sided paddle figure, one sided cylinder, post rotarily in a retro rotary machine of four sided virtual cylinder, with explosions at ever ninety degrees. We could realize a post rotary machine of triangular paddle, in which the explosions will be at ever sixty degrees, thus realizing a six sided virtual cylinder retro rotary machine. Take note to consult our antecedent patent application to take knowledge of many other examples. (FIG. 35-50)

Let us simply note in addition, the originality of the Clockwise movement machine from this point of view. The paddle movement is realized in fact as if we wanted to realize the explosion exactly in the same locations as its counterpart and not by mechanic, but rather reversive, mirrored, being that of the triangular engine, being at ever one hundred and twenty degrees. The paddle retro rotation is thus accelerated, and the cylinder retro rotation is consequentially produced.

In summary, we could thus enact that which follows, that all rotativo circular machine is composed of a material and virtual figuration and that the paddle mechanic and the positioning of the accessories and elements could be realized according to this virtual form.

Independent and Connected Virtual Figures

As we have stated, in standard fixed cylinder figures, a same paddle can be activated in a cylinder with one additional side, in the case of retro rotary machines, and one side less, in the case of post rotary machines. The machine realization having a material and virtual form which is evident thus consists in realizing a machine with a given material cylinder and paddle form, and a virtual cylinder form of the opposite rotary part. For example, we could realize a two sided paddle machine, turning in a material cylinder of one side, which is consequentially post rotary, and a three sided cylinder, giving it its retro rotary substance. We could even, realize a three sided paddle, turning in a two sided cylinder, this machine being consequentially of post rotary material figuration, and simultaneously a three sided paddle machine turning in a virtual four sided universe, similar to retro rotary machines (FIG. 35.5, 37.3)

It is important to note here that one of the originalities of virtual-material machines consist of that in their virtual aspects, and these machines are not subject to the side rule. In fact, we can realize the machine in such a way so that a paddle, for example, of three sides, realizes a virtual cylinder of four, five, six sides and so forth (FIG. 38, 39.1, 39.2)

These possibilities will give an increased liberty for the realization of various rotary machines, since they will no longer be subject of the rigid side rule.

In summary, the standard even paddle figures lead odd cylinder figures, and inversely. The virtual figures introduce a liberty since the numbers and their odd or even characters can all be useful.

Material and Virtual Figures, Versus Real Figure

Slinky Movements and Real Forms

The last notions which we have just described must now be put correspondingly with the notions of motor and compressive type machines, these last ones being expressed, in rotativo circular machines as the idea which we have also commented, of differential and contrario machines.

In all the previously given examples, we have spoken but of machines in which the next compression will occur, for standard machines on the next face of the cylinder, and for rotativo circular machines, on the next face of the virtual cylinder.

Thus this only dynamic set up deprives us of interesting developments. In fact, we have understood that the contributions of rotativo circular machines is to, with a cylinder with a number of sides low enough, for example two sided cylinder with triangular paddle, produce a machine with a high compression degree, and also realize this machine with an increased number of explosions, as it is the case with multi faced paddle and cylinder machines. For example, by realizing the machine with a two sided material cylinder and a six sided virtual cylinder, we'll obtain six compressions per rotation, whereas we would normally obtain but two.

In addition, as we have shown, we'll need to over retro activate the paddle of this machine beyond the point of Clockwise bi rotivity, and consequentially, the machine will not only pass from post rotary to retro rotary, but also from standard push machine to simply differential push, which would reduce even more the motor power, and will only be realized dynamic compressively.

It is thus important to realize the dynamic of the machine in such a way so that it profits from its material figuration, as well as its virtual figuration, but also in such a way so that the machine can not only conserve, but also increase its motor capacities. The machine must thus be able to realize simultaneously contrario movements.

It is here where the Slinky dynamic comes to the rescue, which we have previously, exposed for piston engines. We will once again serve ourselves of realizations from our previous corpus, however with pistons, to give an example of the following matter.

As we have already shown, we can realise a piston machine in a rotary manner, as the idea of rotor cylinder machines. In the Slinky dynamic, we are looking to make a same piston work from one side of the cylinder to the other (FIG. 34). This type of realization is impossible in the works of the previous art, since the mechanic allowing the realization of this machine requires either a semi transmission combined to a rectilinear action obtained by poly induction, being the means of polycammed gears, which would allow to modify the first degree induction form, or even the rotor speed, in such a way so that the induction and rotor can be combined. We won't venture further on these statements, for the matter of the current exposition, and we will content ourselves to mention that this procedure allows, in relation to standard rotor cylinder machines, firstly to realize alternative compressions on each face of a same piston, and secondly to realize compression by “jumps”, the sum of all the compressions taking place in two rotations or more. (FIG. 41.1 and the following) We see well in the unfolding of the figures that the piston acts in the way of a Slinky, which is where the name has been taken from.

We can understand this solution otherwise, by saying that comparatively to standard machines, we can produce successive explosions which correspond not to material successions nor virtual successions. This type of realization seems perfect in rotary machines. From this fact, this type of realization is not only possible, but also desirable.

We can in fact determine the placement of the new expansion at a location which is not determined by either its successive material position when it is realized standardly, neither in its successive virtual position when we consider the next expansion. We can in fact, as it is the case in Slinky piston engines, produce this new compression by jumps and realize subsequent continuations of these jumps which will gradually pass through all the faces of this new figure, in two, three, or even more rotations. It's in this new way of realizing continuations in compressions that we'll need to establish new spark plug, fueling and exhaust system locations, and this is why we'll say that the figure traversed by these jumps comprise the real machine figure. We'll name this figure, real figure, since it is on this one which we must rely on to realize the machine, knowing that, to correctly determine the spark plug, and combustible fueling and exhaust locations.

Consequentially, we'll thus have for these machines a material figure, constituted by the figure of the relation of paddle and cylinder sides at rest, a virtual figure, which corresponds to the realization figure of the number of faces and consequentially the machine total, and the real figure, corresponding to the trajectory traversed by the paddle to realize the number of faces in totality.

We'll thus state that for a material figure and a same virtual figure, many real figures are possible. If the number of virtual figure faces is elevated, some of these real figures will realize their first compression, even non-successively, anterior to the Clockwise point. The machines will consequentially remain anterior differential, in lack of these contributions. Some of the real figures will also have their first compression beyond the standard first compression location. They will also remain differential, however posterior.

But what interests us really is to consider that the location of the first jump, of the first compression on the material face and non successive virtual face will be realized between the location of the first Clockwise compression and the location of the first standard compression. The machine will thus possess a contrario dynamic, and consequentially be realized as its motor form and not as its differential or compressive forms.

As previously, for a same material figure, many virtual figures are possible, and for a same group, many real figures are possible. For example, we'll note, for a triangular paddle, two sided cylinder figure, a eight sided virtual figure, and a procedure by jumps of three sides, which would allow the paddle to realize eight compressions in Slinky movement (FIG. 42 to 49). We'll take note to read more attentively our patent application deposited antecedently to the current to take in account the multiple possibilities and varieties of this contribution. For the means of the current, it is however of an absolute necessity to say why this type of figure is necessary and to realize that the contribution of these realization and distinction criteria are essential to rotativo circular machines. This contribution is necessary since it allows the realization of contrario figures by determining the point of the next explosion of any figure, independently of its material or virtual characteristics.

This contribution will thus allow, from material figures realizing a good compression, for example three of two figures, to realize virtual figures realizing an acceptable number of explosions, for example figures with eight or twelve sides, but in addition to do this from a sequential figure possessing many real faces, this having for consequence that each explosion will be contrario, since it will not realize the next successive material or virtual explosion, and is inside the Clockwise/standard realization limits.

It is thus important to note here that not only virtual figures are independent of the side rules of material figures, but in addition that the real figures, synthetic, are themselves in part independent from material and virtual figures.

Mechanical Support Processes

Circular, non clockwise, rotary machines can be supported by the same technical proceedings as clockwise movement machines. It is however important here to specify that they will have a hybrid character, which will respect the material, virtual and real aspects of the machine. In fact, its by the length of the reach of the crankpin or of the eccentric that the material figuration will remain efficient. The chosen mechanic will comprise this length.

When the figures are realized virtually, but linked, we'll use the orientational retro rotary mechanic of the virtual figure. For example a post rotary triangular paddled, two sided cylinder machine will have a standard length crankpin. But if this machine has a virtual square cylinder, triangular paddle retro rotary form, the mechanic will be of retro rotary type.

In the case of successive, non slinky, virtual figure compressions, but in which the number of sides of the virtual cylinder is not linked to that of the paddle, we realize an induction corresponding to the virtual figure, taking in account the angulation differences of the sides of the material figure and of those which should comprise a connected virtual figure. For example, a triangular paddled figure turning in a six sided virtual figure will rotate twice on itself per rotation. We'll thus give it a retro rotary mechanic using an induction gear of half the size of the internal support gear.

In the case of contrario movement slinky machines, we'll need to, as previously, all while conserving the length, calculate the retro rotation of the paddle in such a way to realize the desired jumps, realizing the most often the group of virtual sides on more than one rotation. Consequentially, in the case of even virtual figures, the real figures will generally be odd, and inversely in the case of odd virtual figures, the real figures will be even.

Vertical and Figurative Levels of Machines and Horizontal and Dynamic Levels of Machines

We can thus summarize the first part of our works by saying that we have, so to speak, exposed, the vertical level of machines, and in other terms, the way to elevate the machine degree by layering or other cylinder modification methods, such as the use of polycammed gears.

In the current work, we'll show that the machines can be modified in their degrees, but this time dynamically. We'll show that the Clockwise dynamic, presented in the first part has a value not only due to its bi rotary qualities, but also a systematic value since it allows to realize a cutting away between differential, anterior, and posterior machines and consequentially, compressive type machines and contrario type machines, in which the Clockwise unity is the first representation.

We thus have a vertical and horizontal development level for machines. In the current section, we want to add that these two levels are not incompatible. We can in fact increase figuratively the degree of a rotativo-circular machine, as we can inversely increase rotativo circularly a standard machine.

It's for example what is produced when we increase the degree of a rotativo circular Clockwise movement machine by realizing, for example, an oscillatory paddle, by polycammed gears of one to one. (FIG. 35a) We have thus figuratively increased the degree of the machine.

WE can for example increase the degree of a rotativo circular clockwise paddle movement machine by realizing it not with a simply rotary cylinder, but a planetary one. This procedure can prove to be very interesting if this cylinder is bi functional, in other words, if we also intend to use it as exterior paddle. This will notably the realization of retro rotary clockwise contrario machines, with contrario eccentrics.

Counter-Machines: Planetary Cylinder/Fixed Paddle, and Clockwise Cylinder/Planetary Paddle Machines

We must mention here that the forms of machines in their inversed state, which we have named counter forms, are realizable in the standard manner by realizing the cylinder and paddle in the orientation opposite to the original orientation, and by granting to the cylinder, the same mechanics as the original.

For example, a triangular machine form, is, when the cylinder is planetary and the paddle is fixed, has an orientation opposite to a post rotary three paddle sided, two cylinder sided machine and uses the same mechanics as it. This is why, in lack of its form, this machine remains post rotary. (FIG. 50)

This is also why, the rotary cylinder can at once be realize bi functionally and on its exterior surface realize the paddle of a standard machine.

The same procedure is realizable for rotativo circular machines, and notably clockwise paddle movement machines (FIG. 56, 57).

We can realize the machine this time with a clockwise cylinder movement, orientationally opposite to its initial position, and a rotary paddle movement. We could then use the exterior cylinder surface as Clockwise paddle of a superior system.

Let us finalize by saying that the chromatic scales already shown for standard dynamics are also true for the figurative counterparts. Thus, we can place machines in a series of dynamics, in rotational double from point zero, of Clockwise cylinder, then in planetary cylinder, and realize differential and contrario rotativo circular groups between these parts.

Wankle's Overcome Semantic Gaps

As we have specified at the beginning of this work, Wankle rationalizes effectively retro and post rotary machines of the previous art, when they are realized with planetary paddles and fixed cylinders. For these figures, it is rather the only two mechanics which Wankle proposes which have become the default, always realizing, as we have shown, counter forces which are harmful to the machine's motricity. In many other areas, however he seems to make errors by semantic inversion or omission, which literally prevents him from systemizing the plans of the machine. We think that the group of these gaps is corrected here and the corrections brought forth are inscribed in a superior machine comprehension.

We'll summarize these errors as follows:

A) Relatively to planetary cylinder machines, there is directional error or omission or mechanization contradiction. In fact, the correct direction of these machines is complementary to the direction of their counter part, and the mechanic must not be that of the figure, but rather that of the counter part. A correct comprehension of these elements allow, as we have shown, to realize the cylinder perfectly bi functionally.

B) Relatively to rotary cylinder and paddle machines, their direction must be inversed since according to the rule which we have given, the next expansion taking place in the same location, the paddle must realize a retro rotation of one hundred and twenty degrees, and the rotary cylinder must undergo a retro rotation of one hundred and eighty degrees. This re-orientation of the machine allows us to consider it as the octave machine from the chromatic scales.

C) The rotor cylinder machine realizes a virtual paddle figuration of a square cylinder machine, and becomes differential retro rotary, which lowers the motricity of the machine. The comprehension of this machine is incomplete, not only by absence of the general rule, but also by the absence of the clockwise movement machine, and by the absence of the establishment of virtual and real figures. As Fixen's, Cooley's, and Malaird's figures, this figure is an isolated realization and is not systematic.

In addition, as before, we note a mechanization absence of this figure, which would have shown the retro rotary character, and the necessity of semi transmission or of descending inductions.

D) The ignorance of bi inductive figurative figures, being the poly turbines, and dynamic figures, being that of Clockwise paddle or cylinder movement machines

E) The absence of establishment or determination of mechanical figuration or dynamic levels

F) The absence of mechanized accelero-decelerative dynamics

G) The absence of knowledge and use of polycammed gears, which allows the support of figures impossible for Wankle, such as differential turbines, Slinky machines, and machines with ovalized, squarified paddles and cylinders, and so forth.

Machine Determinations

One of the qualities of the advancement of any theory—scientific, artistic, or lingual—is the increase in the capacity of determination criteria of the object on which or by which is realized. We pass progressively from a universe of symbols to a more subtle, complex articulated language.

To conserve our main examples in the arts or science, we can for example say that to analyze a sentence of the antiquity melody, we needed but a few criteria. This sentence was generally a chant with a few intonations and alternations of voice and of silence, and maybe with a bit of humming. In the same way, from the point of view of the harmony, the women sang on the octave and we thought it was the same note.

It is much different to analyze a piece by Bach, and subsequentially, by Beethoven, by Ravel or Rachmaninov. We note during the course of history an increase in the musical proceedings intervening in the same musical sentence, and from this fact, an explanatory report of this requires the knowledge of these caracters and their combination. It is the same for science. The notion of weight in ancient Greece was established by balance. In ancient times, we had very few criteria of comprehension of a body which was falling. With Newton, a weight is connected with a rational attraction rule. This body falls not only at a certain speed, but also invariable, depending on its group of criteria. With Einstein, we know that if this body is an atom, and that its speed is close to that of light, the application rules of comprehension will have to be enlarged, and enlarged in a way to respect the limit cases and to corroborate Newton's theory in non cosmological spaces.

In the same way, if we compare Wankle's works to those of the inventors of the previous art, we notice that, on this level, Wankle's contribution was to bring new rational and generative criteria of machine comprehension.

In fact that for the inventors of the previous art, each machine has its autonomous configuration and remains without mechanical modus vivandi relative to the orientational aspect, with Wankle, we insist in the enunciation of rationalization criteria which are those of serializations of cases of first degree machines and of mechanization.

We can thus say that we find with Wankle the elaboration of these two critera, one of figures, and the other mechanical. The figure criteria allows a classification of figure types which we have named post and retro rotary.

As for orientational suspension criteria, we see that they remain in the order of figure criteria, one one part, knowing that the propsed mechanizations are strictly post or rero rotary, and on another part, they are limited to two, being the post or retro rotary mono induction, and the mechanic by post or retro rotary intermediate gear.

Always relative to figures, we can from Wankle logically determine the figurative situation of a machine of one class to that of a same class by comparing the number of sides, according to the sides rule.

We'll thus say that it is the case of a machine of 3:2, of 4:5, of 7 these values corresponding to the number of paddle and cylinder sides.

We can from these criteria analyse standard machines. For example, for the case of commercial type engines, we'll say that it is:

Engines
1) of post rotary class
   H) Of 3:2 paddle cylinder caracteristics
   I) Of orientational support by post rotary mono induction, or reductive

We can suppose, as a second example, the realization of a machine in which the paddle has the same number of sides, but its cylinder has four. It would therefore be:
1) Of retro rotary class
2) Of 4:3 paddle cylinder side caracteristic
3) Of mono inductive orientational support
4) Of retro rotary or inversive support type.

As we have shown, we can produce an almost unlimited number of machines which can't be totally comprised by the only criteria of the previous art, which was very confined and limiting. We think that a correct comprehension of these machines require a much larger group of criteria.

These criteria are sufficient to understand a part of these machines, even of first degree. Let us give a few examples. If we suppose a machine of a 3:2 figuration, but supported by a hoop gear realized in the shape of a chain, the machine mechanic will remain unexplained, if we have but the criteria of the previous art.

We'll determine the machine in the following way:

Standard 3:2 paddle cylinder

Hoop gear mechanic, used as a chain

We can even suppose the realization of a machine with a unitary paddle compression group, in counter direction, retro rotarily and supported by a hoop gear mechanic with a third de-axation gear

We'll consequentially determine this machine in the following way:

a. retro rotary class

b. virtual 2×3:2 characteristic

c. compression doubling internal explosion

d. hoop gear support

e. bi rotary support

Let us give another example.

In this example we realize a triangular, layered support engine, and in addition with an accelero-decelerative paddle action. The machine is thus characterized as follows:
A) retro rotary class
B) second rotivity degree
c) in height
d) master mono induction and by peripheral hoop gear, or secondary, support methods
e) rounded cylinder
e) poly cammed accelero-decelerative gear mono induction
f) rounded cylinder forms and counter forms

Let us give another example. In this case, we realize a machine in which the compressive figure is issued from our generalization of Wilson's base figure, and in which the retro rotary mechanic and with geometric addition is our own.

The machine can be described as follows

A) Bi rotary class

B) Compressive part by paddle structure

C) 6:3 number of sides

D) bi rotary mechanic

E) by first degree mechanic

F) mechanic modification by geometric addition

Let us give a final example. Here it will be the case of a contrario rotativo circular machine with a material paddle and cylinder of three to two and a real cylinder of eight sides.

The machine is therefore:
a) post rotary material class
b) of contrario rotativo circular type
c) of slinky dynamic
d) of material 3:2 figurations
   of virtual <<leap of three>> figuration
   of real 3:8 figuration
e) of mechanic by combinatory link by the support gear
f) of semi transmission mechanic by pinion gears.

As we can state, other than the mechanic before the regularization structure, being that of retro rotation mechanic, there is no criteria belonging to the critereology of Wankle or his predecessor, and he could not have realized a correct report of this machine.

The number of examples of machines being partially or totally determined by the criteria not belonging to the previous art is almost unlimited.

It is almost impossible to index all possible machines, only being described by Wankle's and his predecessors' limited systematic. The way to enclose all of these possible machines is that of their determination from a descriptive and rational grid, indexing all the constituting characters of machines, such as Wankle has given us a base for, and which we have completed in parallel to our works.

This determination grid will be comprised of generative criteria which could be applied to all machines, which will assure to each of these criteria the generality necessary to allow considering them to this title.

These criteria are:
a) The machine class, post rotary (Wankle, Beaudoin), retro rotary (Wankle, Beaudoin), bi rotary (Beaudoin)
b) The number of paddle cylinder sides Retro rotary (Wankle), Post rotary (Wankle), Bi rotary (Beaudoin)
c) The first degree mechanic used:
   mono induction (Wankle)
   Intermediate gear (Wankle)
   Hoop gear (Beaudoin)
   With third gear, chain, belt (Beaudoin)
   By poly induction (Beaudoin)
   Method by semi transmission (Beaudoin)
   Method by hoop gear (Beaudoin)
   Method by intermediate gear (Beaudoin)
   Method by heel gear (Beaudoin)
   Method by internal juxtaposed gears (Beaudoin)
   Method by internal superposed gears (Beaudoin)
   Method by central post active gears (Beaudoin)
   Method by gear like structure (Beaudoin)
   Method by unitary gear (Beaudoin)
d) The type of paddle:
   Standard (Wankle, Beaudoin. Fixen, Cooley);
   Simple paddle and cylinder group (Beaudoin)
   Paddle structure (Wilson, Beaudoin, St-Hilaire)
e) The type of dynamic:
   regular (Wankle Beaudoin)
   accelero decelerative (Beaudoin)
f) The machine degree
   Vertical figurative (Beaudoin)
   Dynamic (Beaudoin)
   Mixed (Beaudoin)
g) The type of second degree mechanic: by dual or tri parted poly induction (Beaudoin), by anchoring in the points (Mulling), in tri parted descending anchoring, by positional support in the centers of the sides, or in intermediate parts (Beaudoin)
h) The type of corrective mechanic allowing the realization of obtained degrees: by runner (Beaudoin), by geometric addition (Beaudoin), by oscillatory action (Beaudoin), by induction layering (Beaudoin)
i) The type of machine nature
   Planetary paddle—fixed cylinder (Wankle, Beaudoin)
   Planetary cylinder—fixed paddle (Wankle, Beaudoin)
   Bi functional paddle cylinder (Beaudoin)
j) The type of dynamic
   Standard (Wankle, Beaudoin)
   Rotativo circular retro (Wankle, Beaudoin) or post rotary (Beaudoin) differential
   Contrario (Beaudoin) by clockwise movement (Beaudoin) and planetary movement (Beaudoin)
k) The degree
   Materiel (Wankle, Beaudoin)
   Virtual (Beaudoin)
   Real (Beaudoin)
l) The type of paddle compression
   (Wankle, Beaudoin)
   with pistons (Beaudoin)
m) By slinky dynamic (Beaudoin)
n) The type of material figure used
   Standard figure (Cooley Fixen Wankle Beaudoin)
   Rounded (Beaudoin)
   rectangularised (Beaudoin)
o) Counter part figure
   Planetary cylinder/Fixed paddle (Beaudoin)
   Clockwise cylinder/rotary paddle (Beaudoin)
   Bi functional figure (Beaudoin)
      Conclusion

First of all, for a good number of researchers, it is of evidence that the indexations, rationalizations, and mechanizations of Wankle offer themselves as an opaque matter, hermetic and insurmountable. The key elements are reduced to their greatest simplicity, and that we don't see that it's this very simplicity which is faulty.

As we verify frequently however, with time however, as for all theory and system, we notice after the appreciation errors, the mechanical gaps, and finally the rational contradictions and the various enterprise limitations.

Bit by bit, as we'll finish demonstrating here, these gaps and their corrections will make room for new perspectives, and the exceptions will progressively show their qualities of hidden rules, which will generalize themselves to such a point to result in new motor machines, much more perfect. We could then proceed to rationalizations allowing the understanding of more machine characteristics, more machines, more mechanics, more base machine variants. In addition, the new units, issued from correction concepts will allow the realization of more liable, stronger, more fluid, and consequentialy, which is most important for all, privileged machine units, which we have named rotativo-circular, realizing qualities from piston machines, rotary machines, and turbines, without realizing the defaults.

A bit in the way of a musical system, or a physics system, the general theory of all motor machines has not been developed in a single go, but rather its historical development, which goes from unison, to octaves, to fifths, to sevenths, and so forth, or even from a diatonic system incorporating progressively a chromatic system.

As well in physics, which appeared to be but exceptions to Newton's law, turns out, from the cosmological point of view, a new law.

We can thus say that comparatively to Bach and Newton, we can say that Wankle has thrown the base of a first rationalization of rotary machines, its systematic as much theoretic as mechanical comprises many gaps, both mechanical and semantic. These gaps, overcome coherently, will allow to establish a vaster machine system, and englobing, this system possessing in superior figurative, mechanical and dynamic cutting criteria, more manupulatable and variative from which, could emanate both more complex machine types, but also, astonishingly simpler and more efficient.

The new system will offer not only a larger number of machines, but also machines realizing a better motor propensity.

10) Suggest adequate machine segmentation

11) Suggest support of the compressive parts by crankpins.

### SUMMARY FIGURE DESCRIPTION

FIG. 1 comments the figures of the previous art, in matter of rotary machines

FIG. 2 shows the group of Wankle's first degree methods, as well as those which we have elaborated beforehand.

FIG. 3a) shows the main methods of increasing the mechanical degree which we have also elaborated beforehand.

FIG. 4 shows, also from our previous works, the three main types of bi inductive machines, a) the rectilinear rod machine, b) the poly turbine type, and c) a paddle machine in movement with rotary cylinder.

FIG. 5a shows the push in engines before Wankle. We note that these machines are efficient, from the point of view of the push, firstly, since their explosion is realized at the height of the ascent of the crankshaft and of the straightening of the paddle.

FIG. 5b, shows Wankle's two inductions, being those of mono induction, and that of intermediate gear induction

FIG. 5c shows, on an exemplary basis, the differences of standard piston engines, and runner rod engines.

FIG. 6 shows the precisions brough by the current invention relative to the induction by hoop gear

FIG. 7 shows the precisions brough by the current invention relative to the induction by polycamed gears

FIG. 8 shows the precisions brought by the current invention relative to the induction by semi transmission

FIG. 9 reminds for the two base post and retro rotary figures, the form and coupling corrections brought previously by ourselves by addition of degrees by layering inductions

FIG. 10 shows two types of observations brining to the realization of specific inductions

FIG. 11 a shows the method of observation by specific exterior. This method consists to observe, by an exterior observer, the movement of a specific point of the paddle in course of its planetary rotation.

FIG. 12.1 presents, in a) that the comprehension of the geometric dynamic of the paddle realized by the poly induction is totally opposite to that of the previous art. In b) of the same figure, we see that, no matter what the position of the centers of the subsidiary crankshafts during their total elevation, the explosive push on the paddle remains, in lack of the double part poly induction, always equally distributed.

FIG. 13 shows the precisions brought by the current invention relative to the induction by poly induction

FIG. 14 shows the dynamic for a rotation, of such an arrangement. We'll note here that the inductions have been placed in the sides of the paddles, but as we have said, they could be placed anywhere on the paddle.

FIG. 15, in a), three different piston engine dynamics, and in c), of the same figure, we see the dynamic by layering which we have produced in first part of the current invention. We see that the paddle isn't set up on a central eccentric, but rather on a layering of the crankshaft which the second plays the role of rotary rod.

FIG. 16.1 shows how, from standard piston machines, in a) we can produce between two dynamic compressive parts, here, two pistons, contrario actions, in b), and of the same direction in c).

FIG. 16.2 shows, from examples of rotor cylinder piston machines, how we can grasp the third fundamental gap of machines of the previous art, this time, dynamically.

FIG. 17 is a reminder of the Clockwise dynamic of a post rotary, three sided paddle, and two sided cylinder figuration machine

FIG. 18 shows by which type of observation we can state the Clockwise movement. We have named this observation, observation from the master crankshaft of poly inductive machines.

FIG. 20 summarizes the mechanical difficulties and weaknesses of standard rotary machines, consequential to the previously enounced gaps.

FIG. 21 shows that the Clockwise dynamic is situated halfway between standard piston dynamics, rotary, orbital, turbine and rotor cylinder. This is why we have named them rotativo-circular machines, or even rotativo-turbines, or finally rotativo-orbital.

FIG. 22 shows that all first degree induction obtained from observation on the crankshaft, if it is realized in a ratio of a support gear and an induction gear of one to one, can realize the Clockwise guidance of the paddle from the center.

FIG. 23a) differentiates ascending inductions and the descending inductions. The ascending inductions are standard first degree inductions, or even, as we have seen in the layering of inductions, peripheral inductions, allowing to assure the orientational support of the paddle.

FIG. 23b summarizes the first two types of semi transmission, accelero-decelerative, and shows how to realize them confoundedly.

FIG. 24 summarizes the three important support methods of rotativo circular machines. We can consider that rotativo circular machines are the horizontalized expression of layered support structures, presented by ourselves beforehand. In b) of the same figure, the paddle induction is realized by an intermediate gear induction. In c), the elements will here be connected by a same gear, which will serve at once as a dynamic paddle support gear, and as an induction gear from the axe to the cylinder.

FIG. 25 specifies the contrario movements in same direction for Clockwise movement machines/post and retro rotary cylinders

FIG. 26 specifies that even bi rotary type machines, as for example poly turbines in a and in b the Quasi turbines, in c, are realizable in the manner of rotativo circular machines. In d, we also see that these machines are also realizable for any number of sides. Here the rotativo-circular poly turbine with a six sided paddle structure in a triangular rotary cylinder.

FIG. 27 shows that the rotativo circular dynamics can, from already commented correction mechanics, notably the use of polycammed gears, for standard machines, be realised accelero-deceleratively. In these cases the cylinder curves will be modified.

FIG. 28 shows that the rotativo-circular machines can be realized with different paddle types.

FIG. 29 shows our first dynamics to this subject and shows that the clockwise paddle movement machines can have various degrees

FIG. 30 shows that the polycamation of induction or support gears can be realized not to accelerate/decelerate the positional movement of the paddle, but to modify alternatively the orientational movement of the paddle, making it thus, oscillatory clockwise.

FIG. 31 shows that as for standard machines, we can realize the machine with a center/periphery inversion of the dynamic of the compressive parts

FIG. 32 shows that even inversedly, the cylinder can, like the paddle, be in a single multifaced piece, in a), many uni faced pieces, in b), and in external paddle structure, in c).

FIG. 33.1 shows the three dynamics by planetary paddle/fixed cylinder, in a, paddle/rotary cylinder, in b, and paddle in clockwise movement/rotary cylinder, in c).

FIG. 33.2 shows that we can go further by varying the dynamics in such a way as to realize explosions and expansions in different locations of those of the previous figures.

FIG. 30 shows other examples, this time with a three sided paddle and a cylinder of two, of the rule which we'll name rotary counterpart rule.

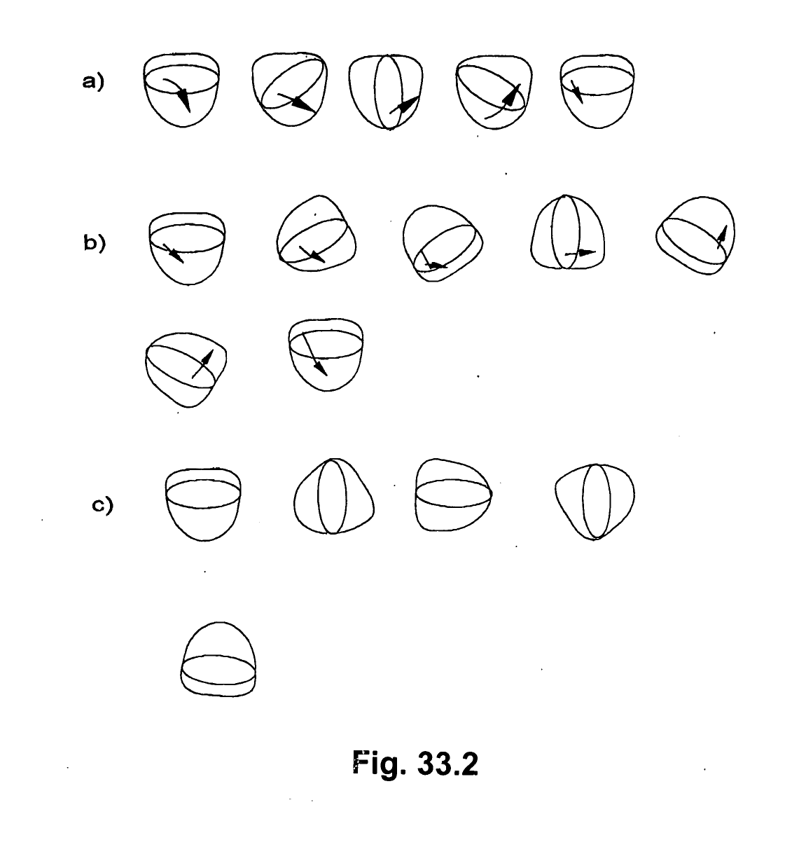

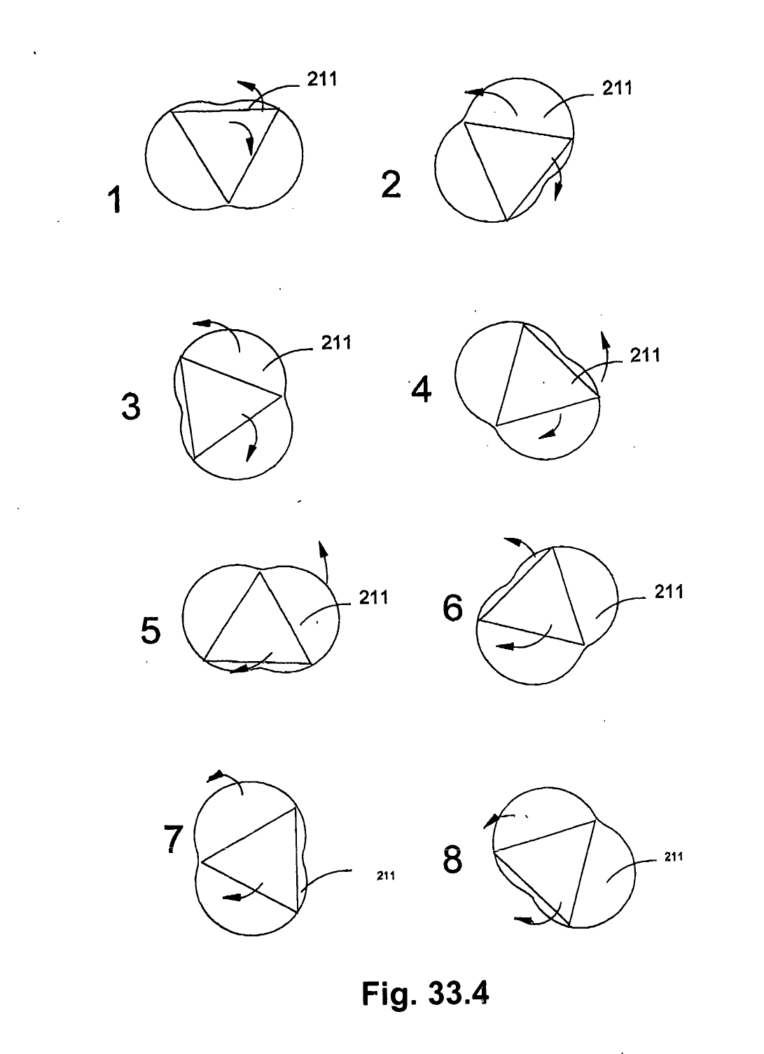

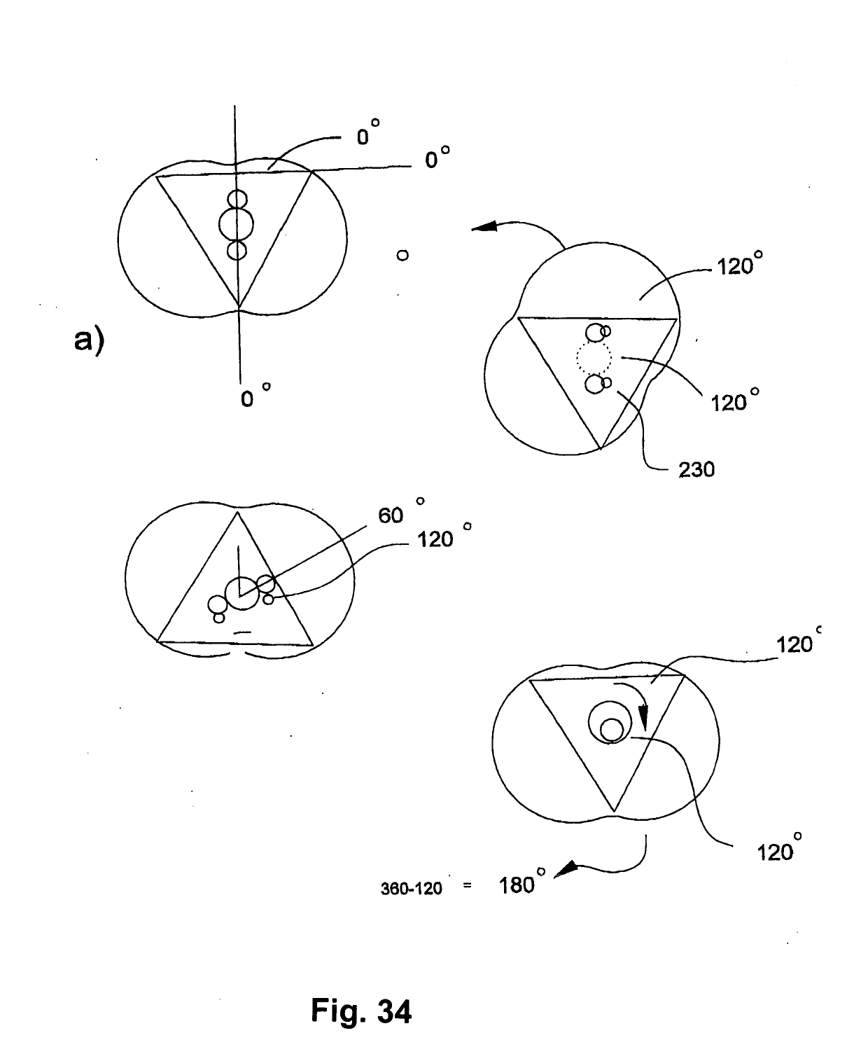

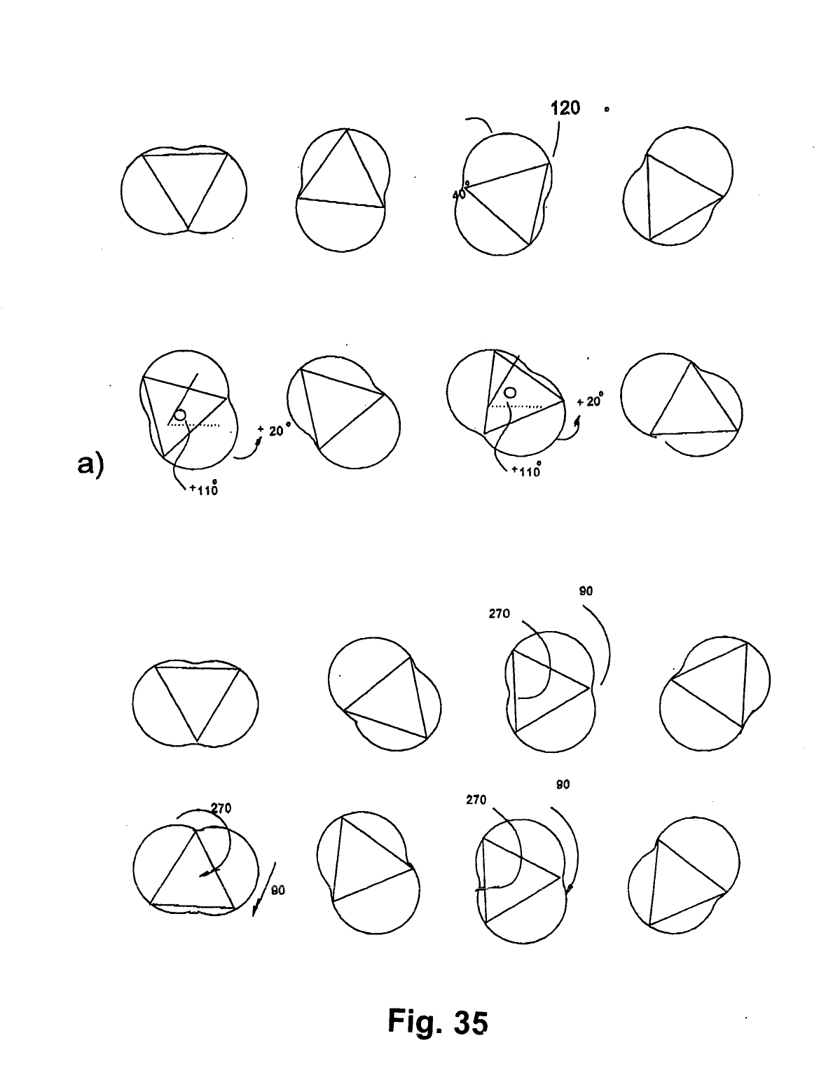

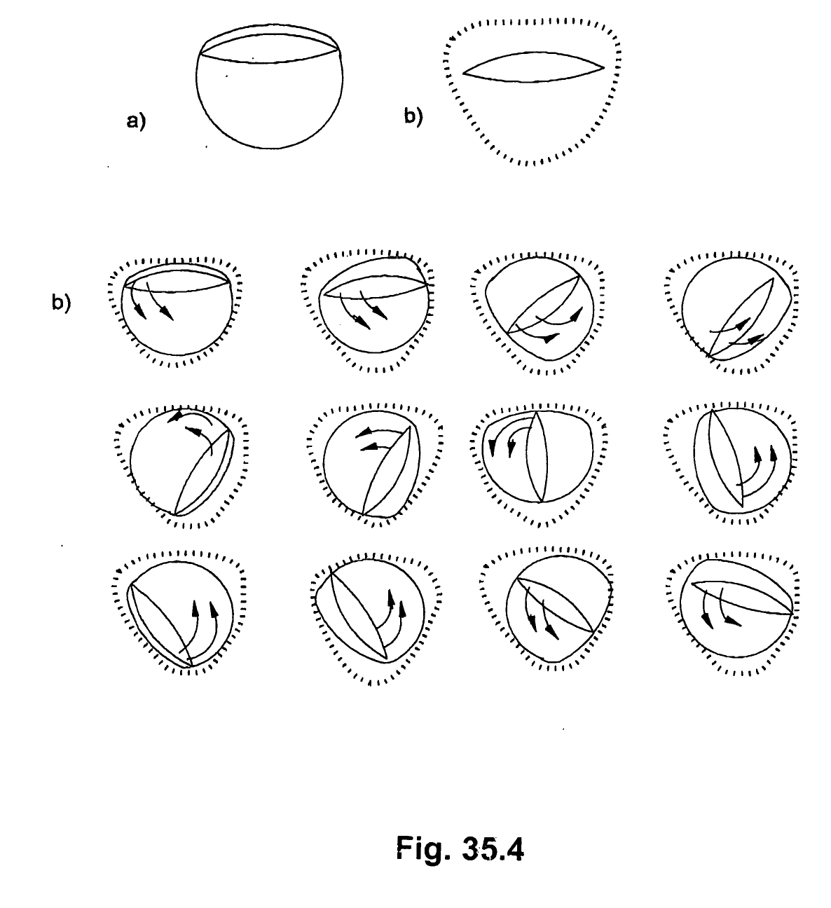

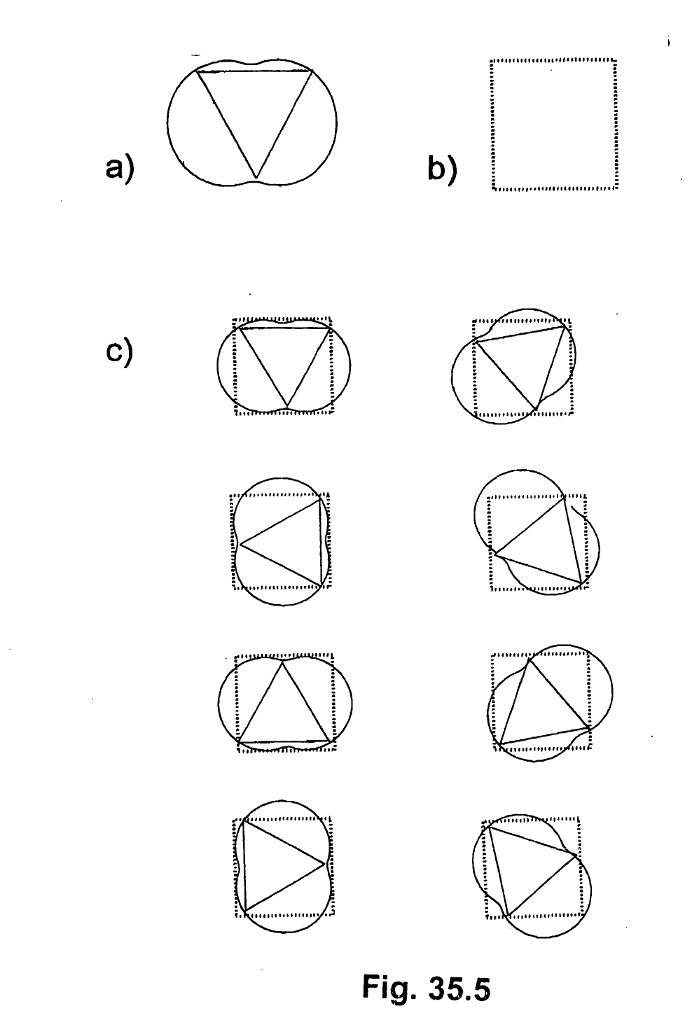

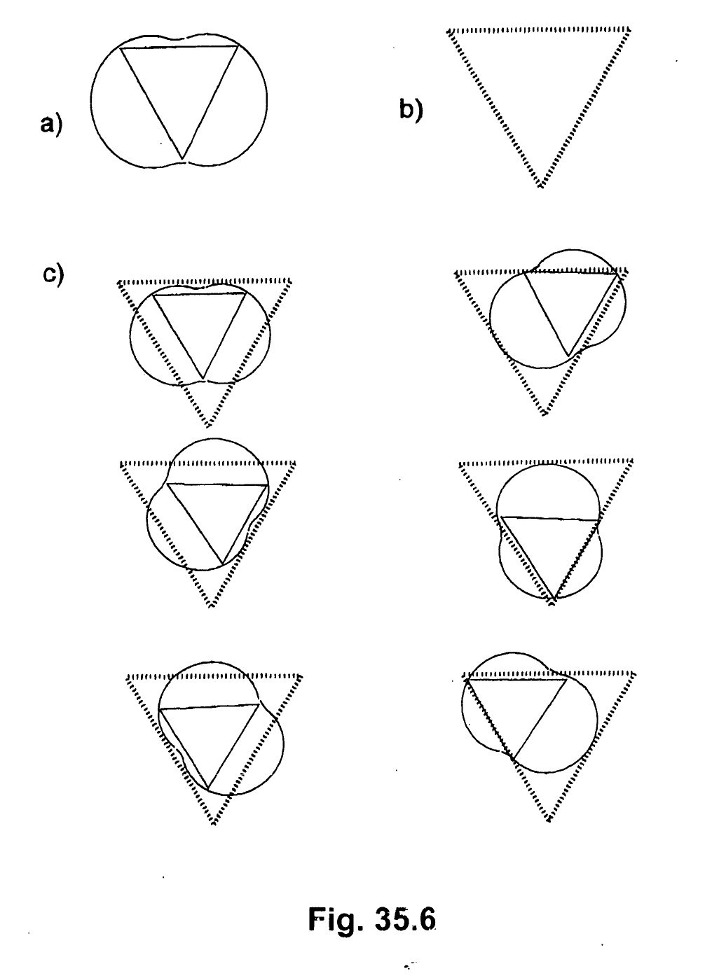

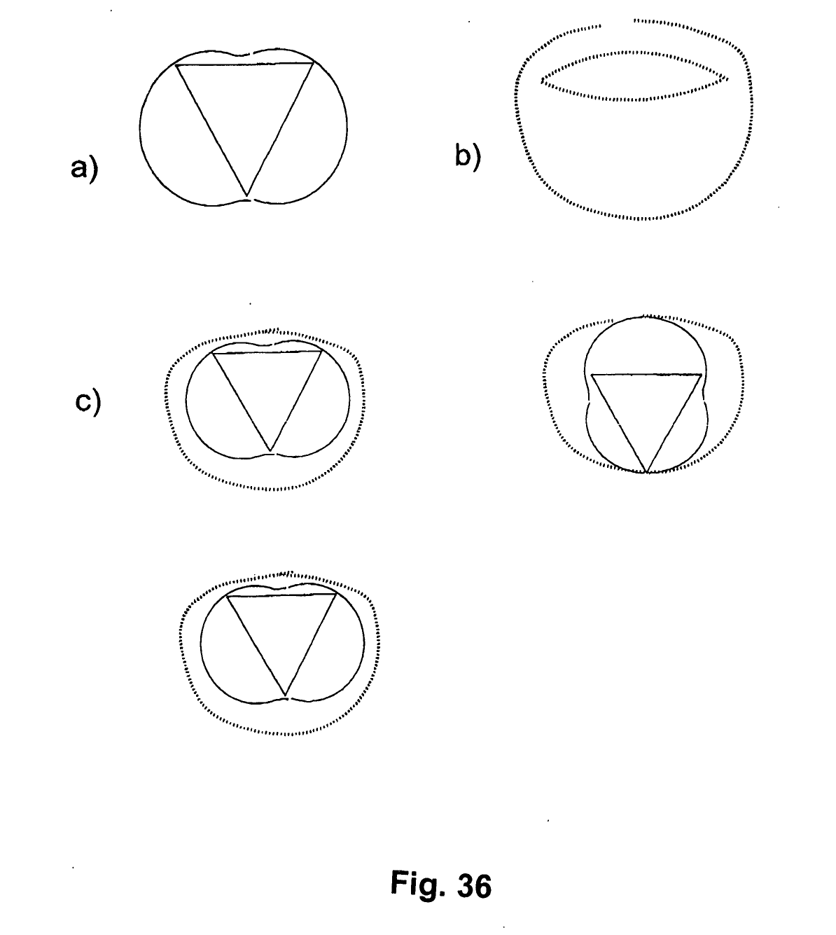

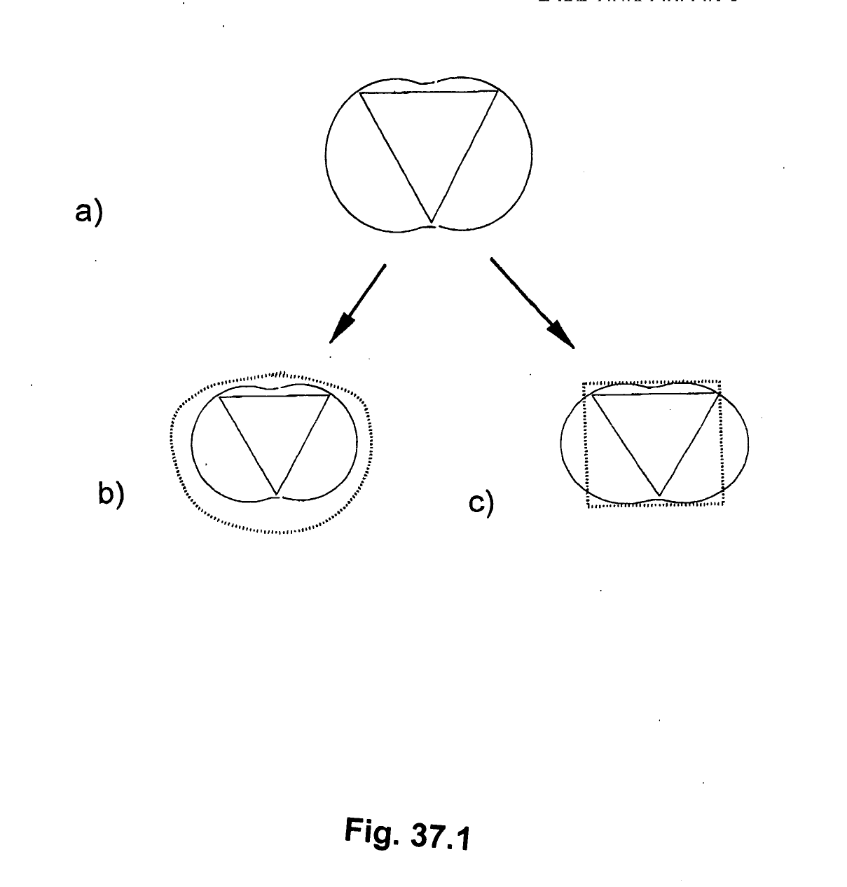

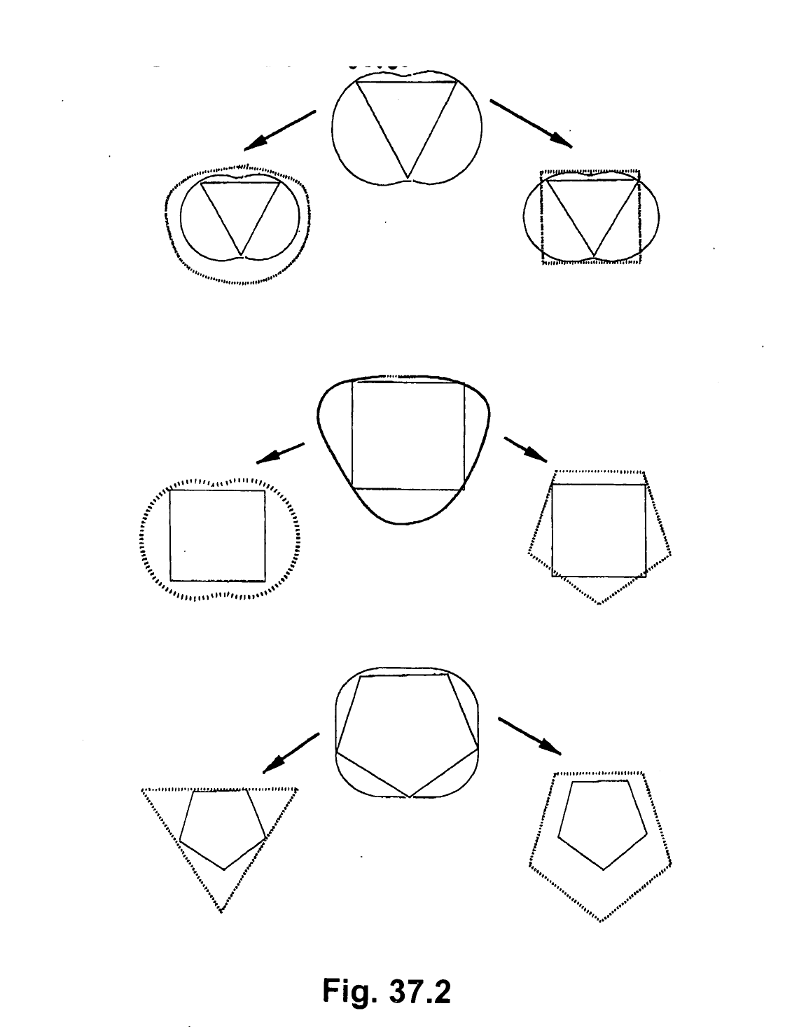

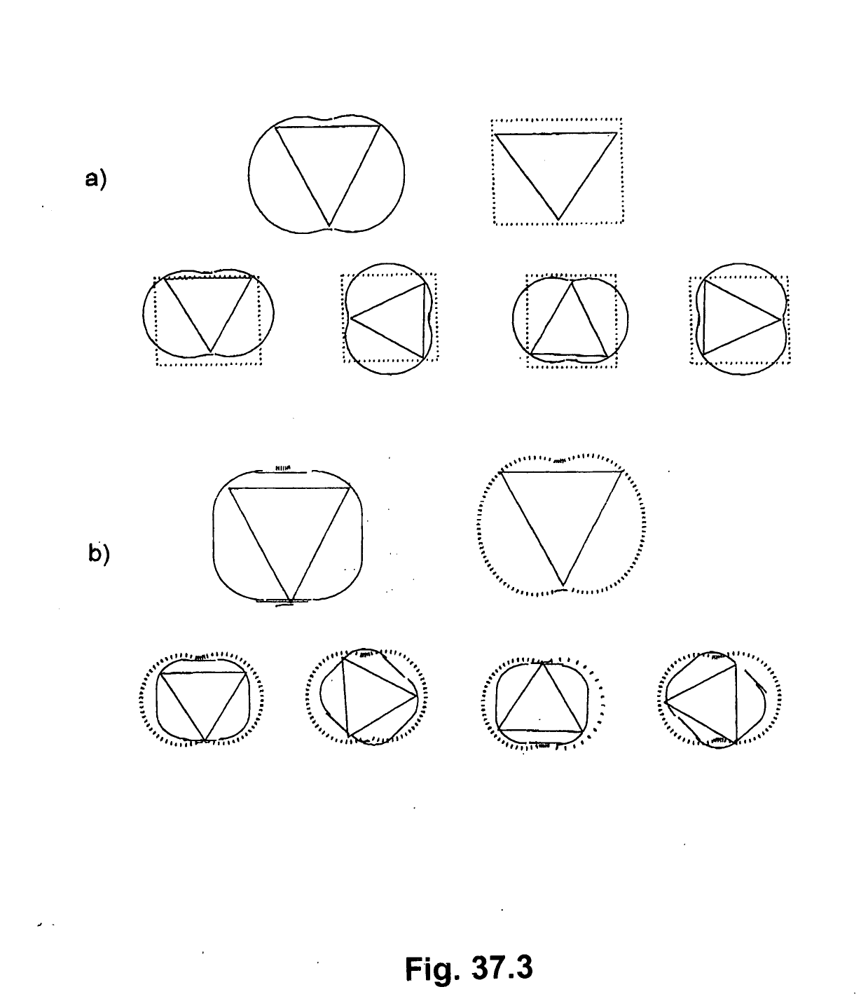

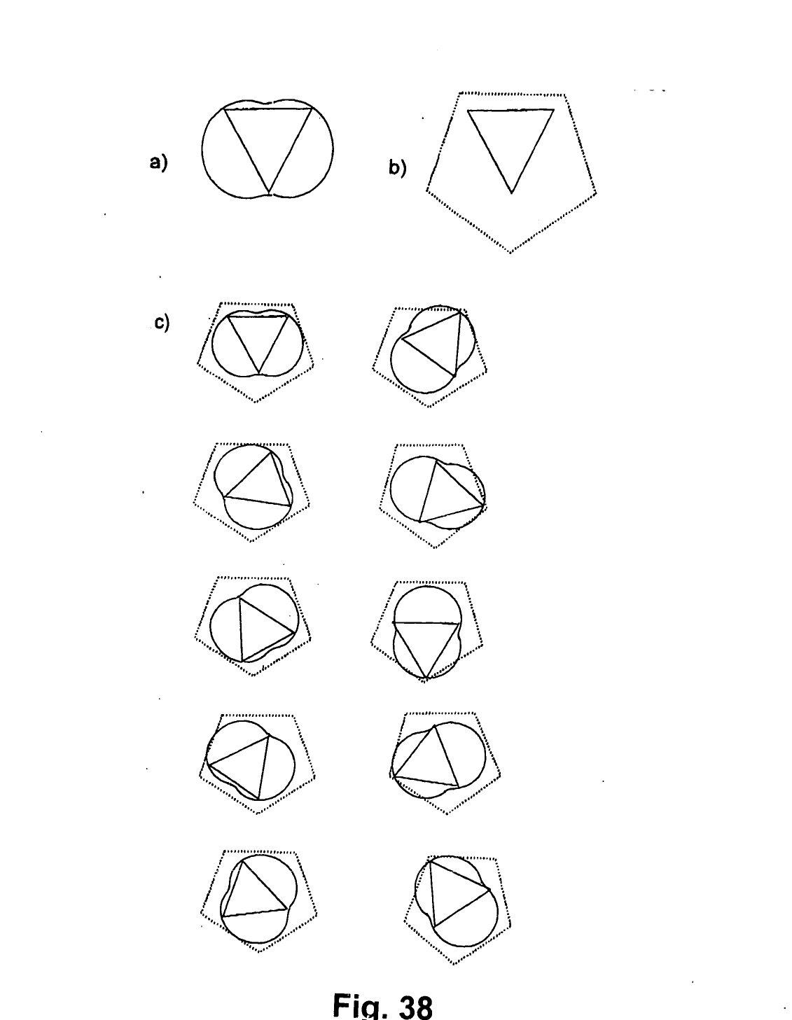

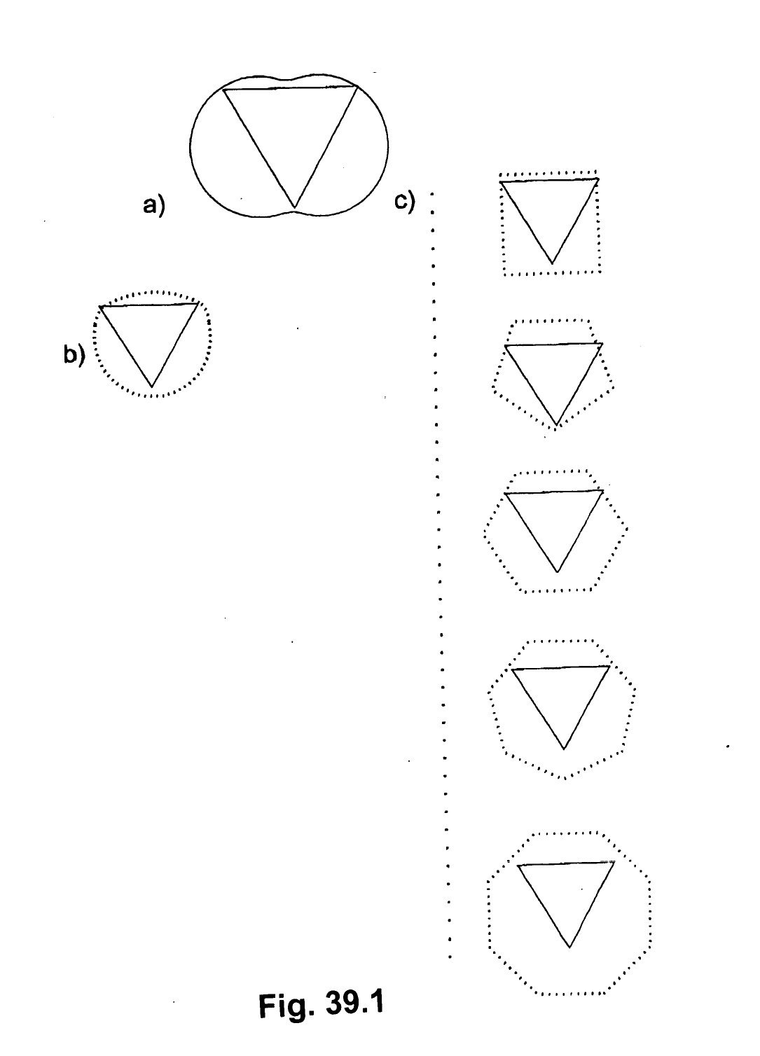

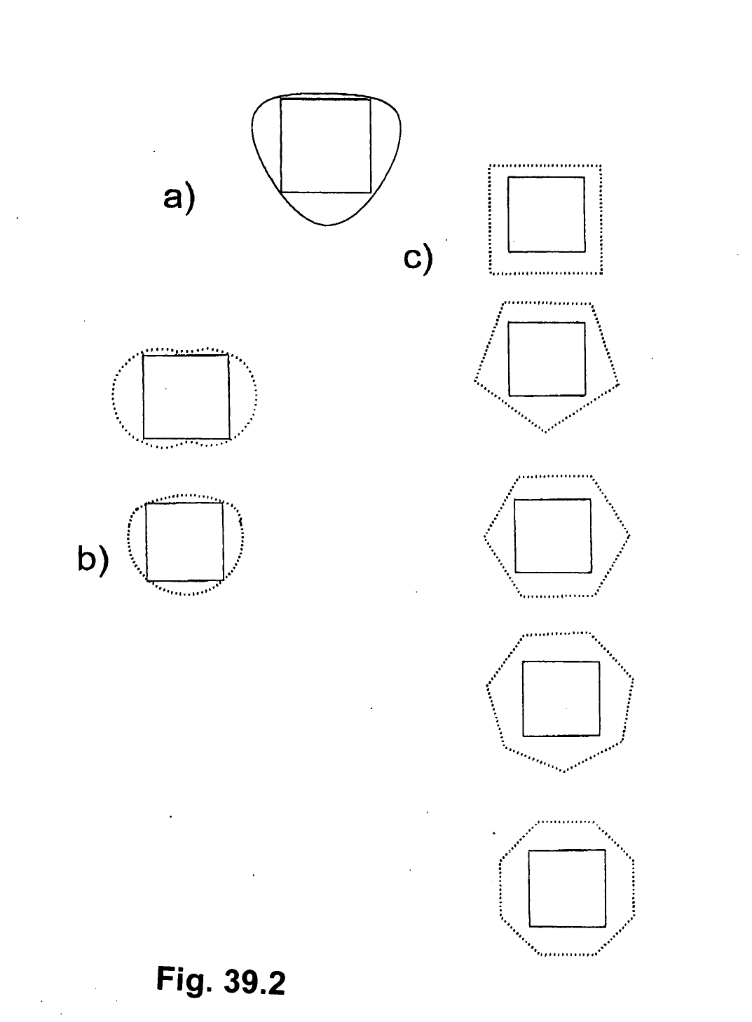

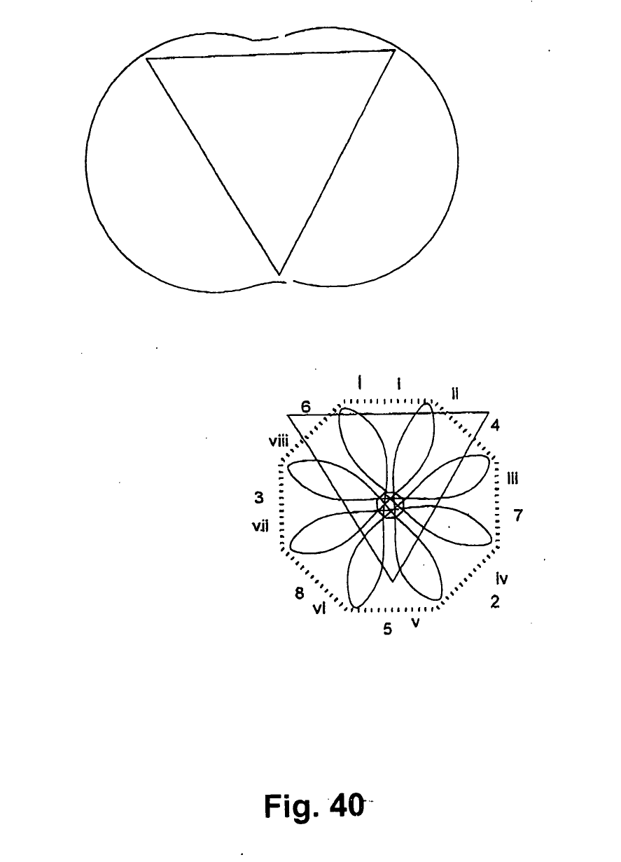

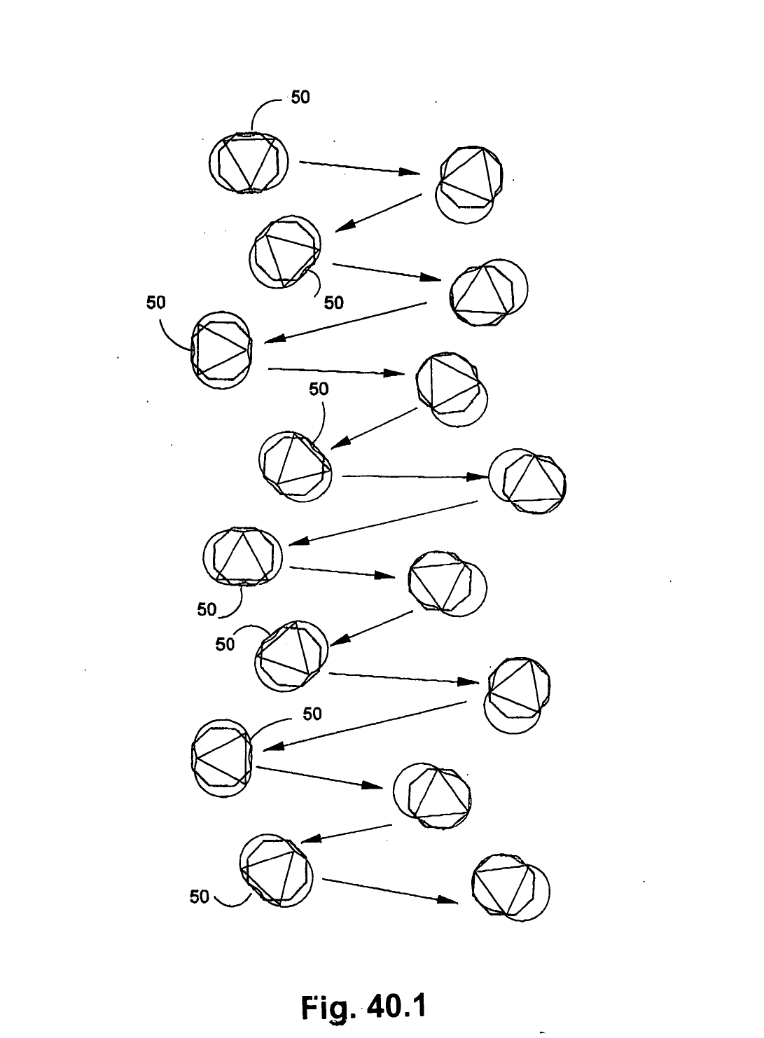

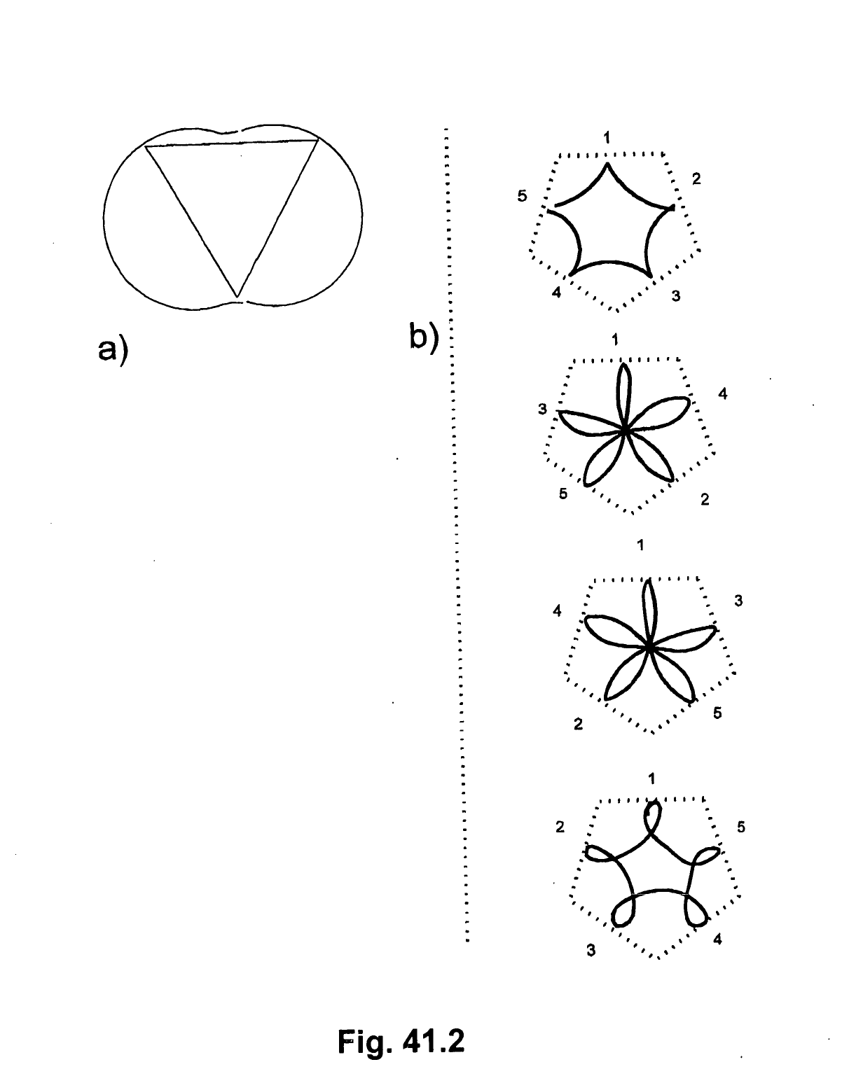

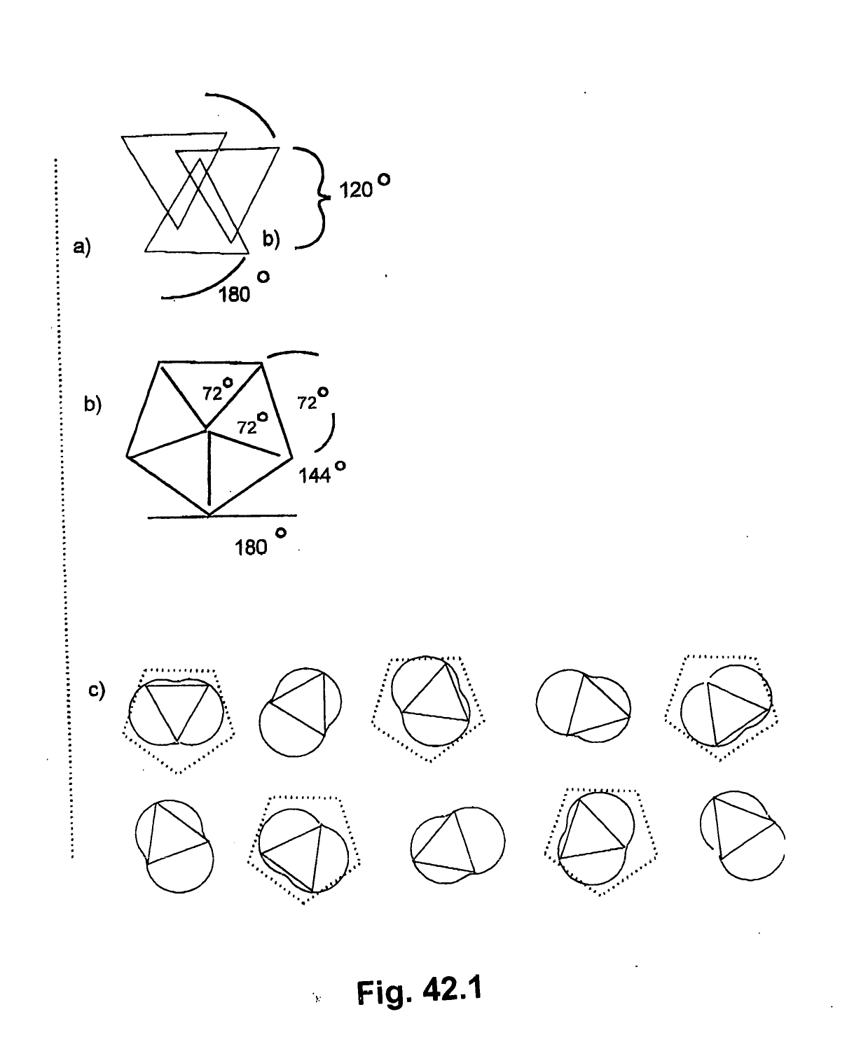

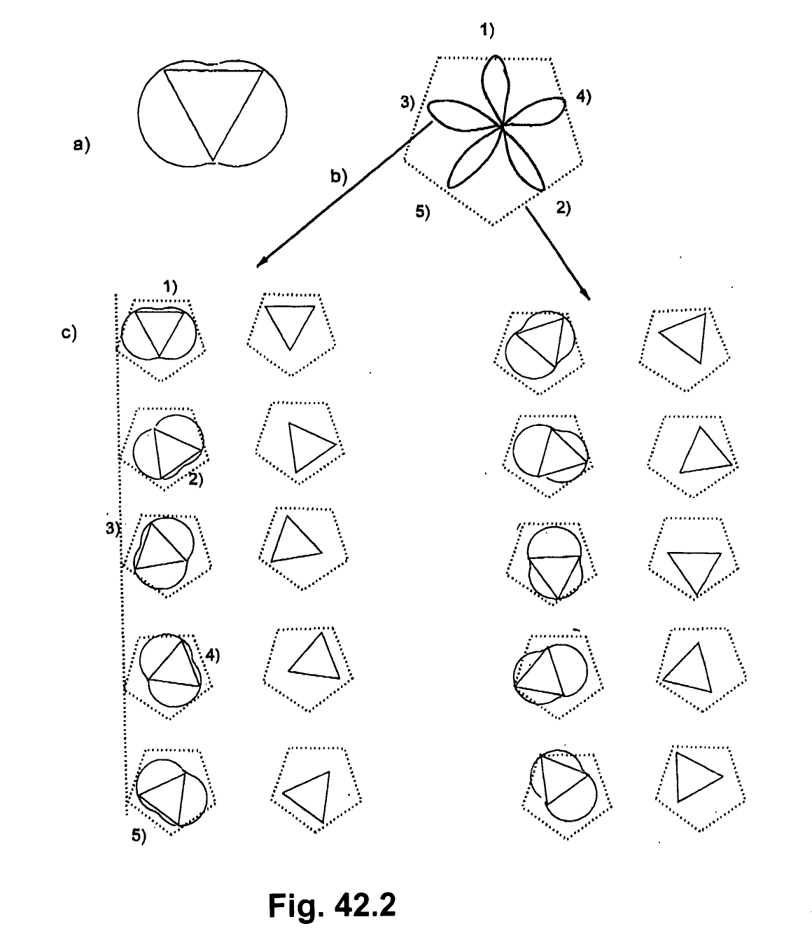

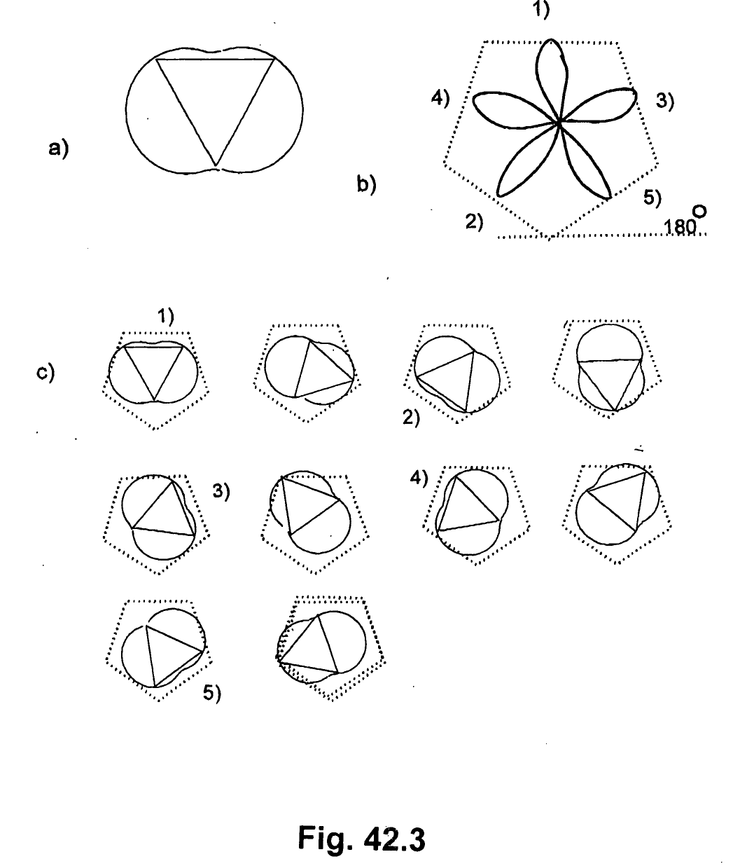

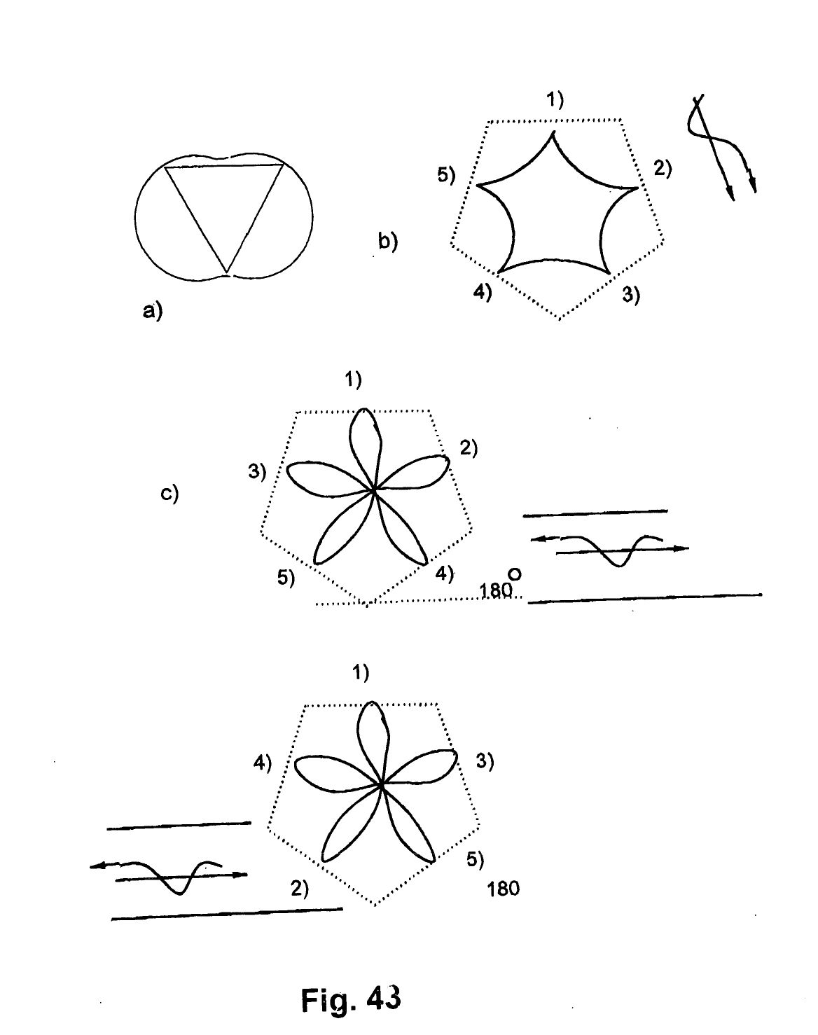

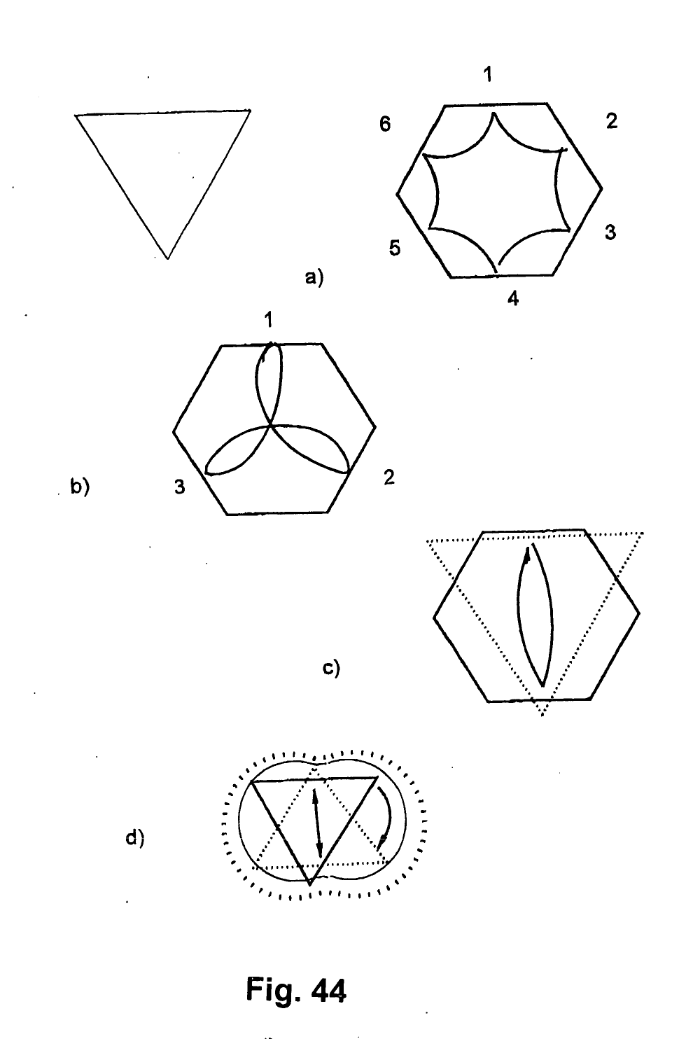

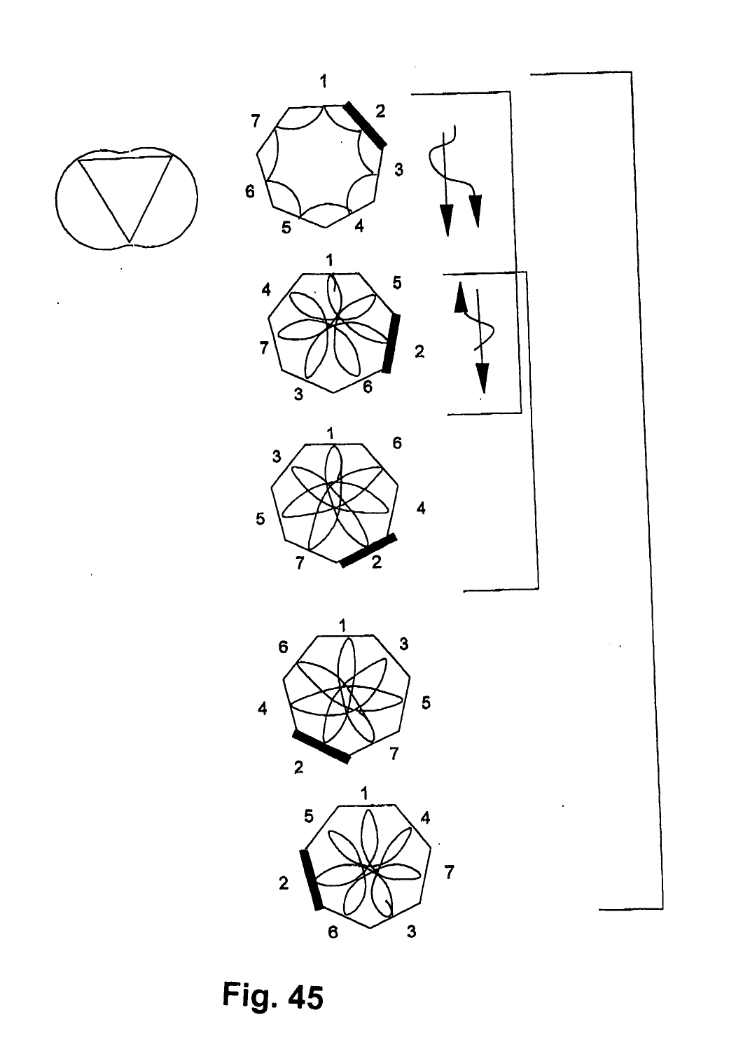

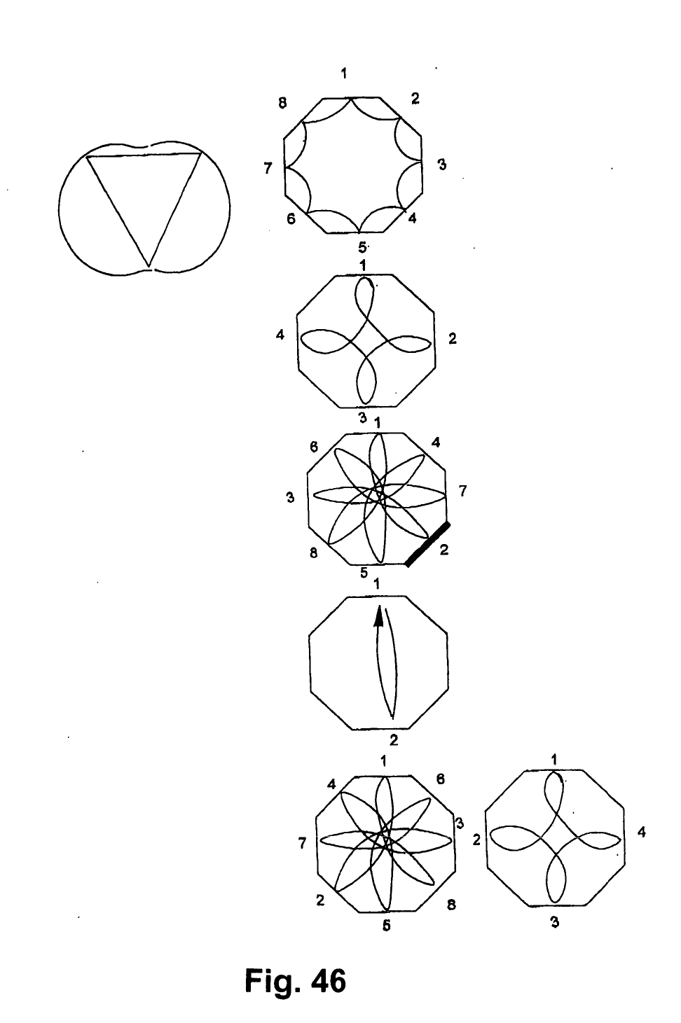

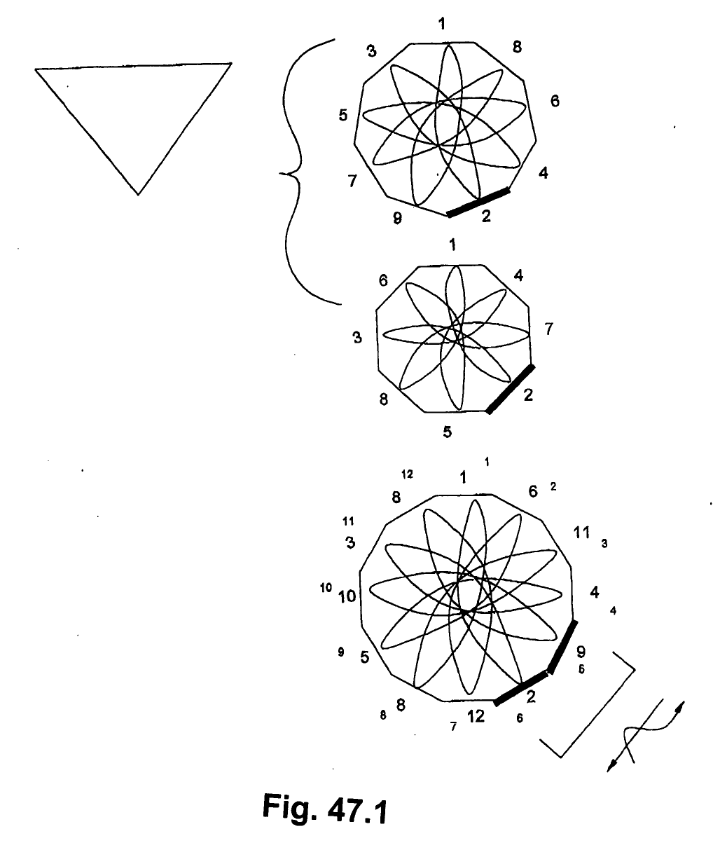

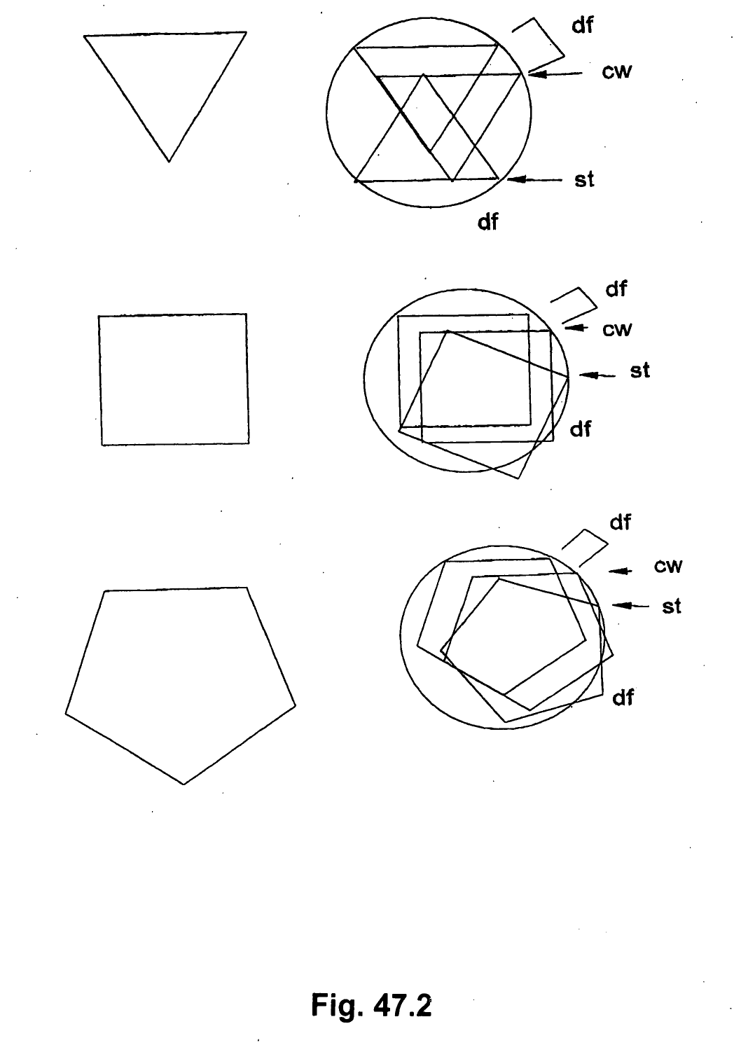

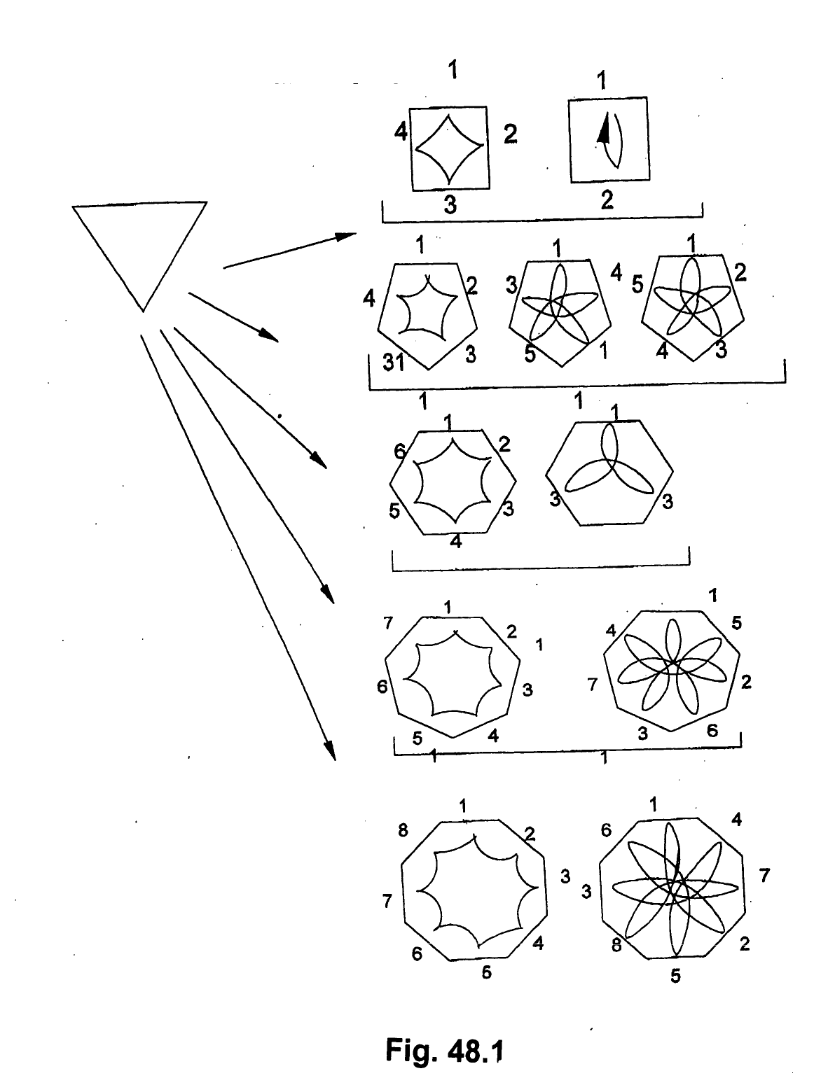

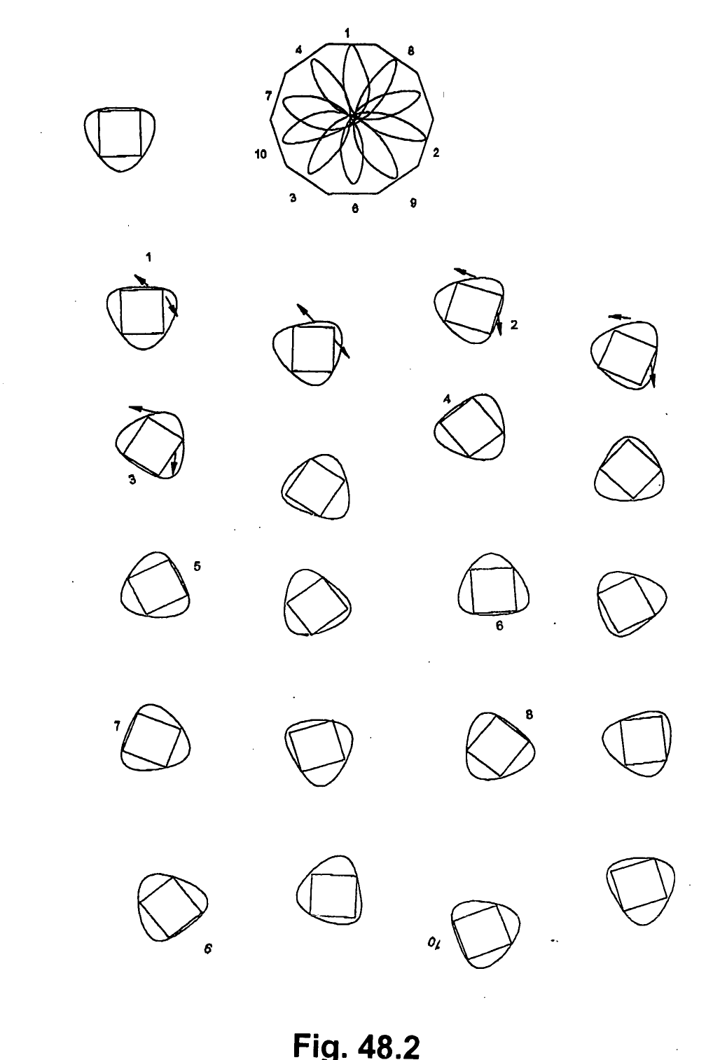

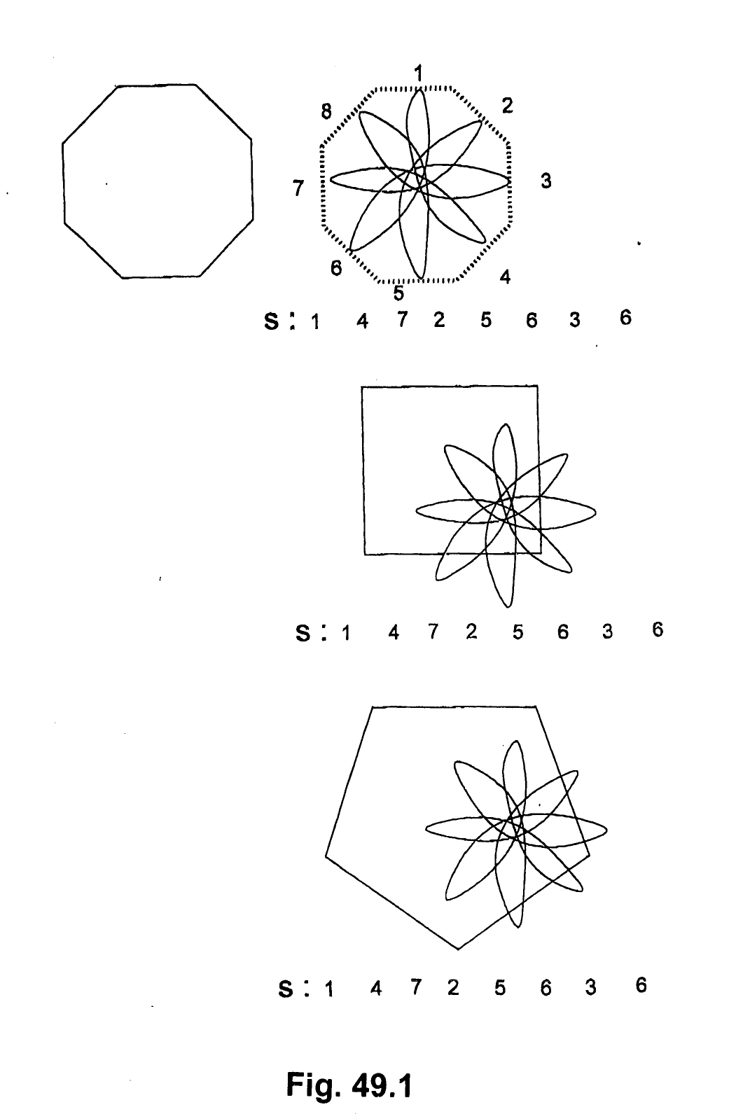

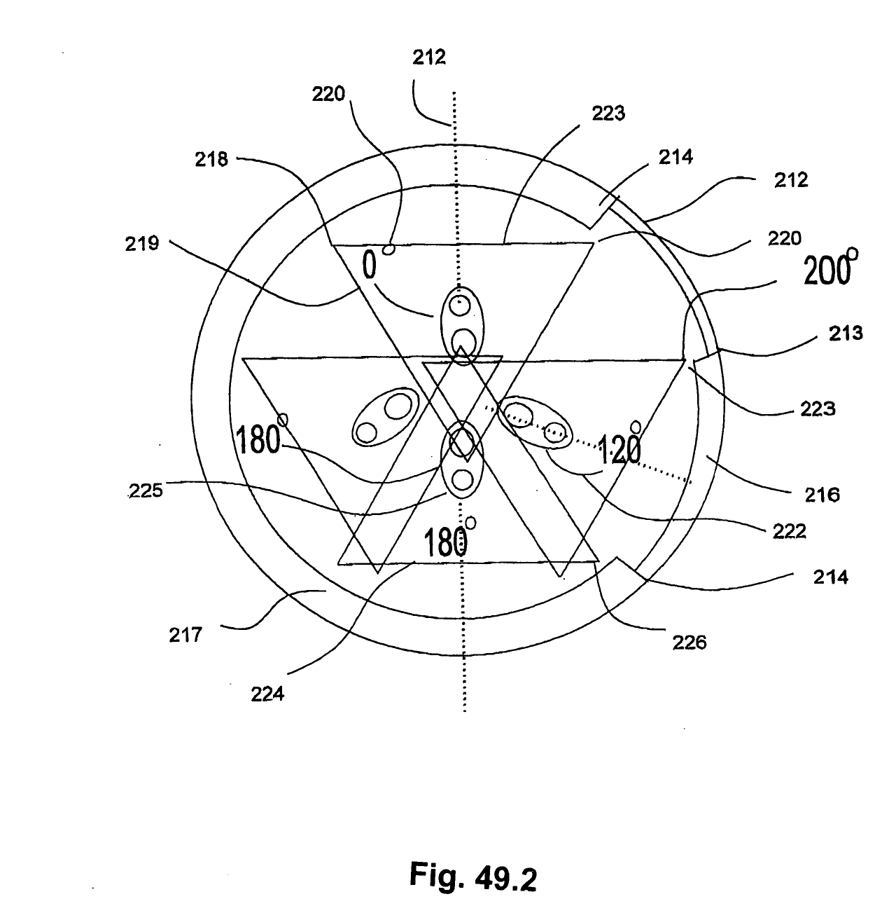

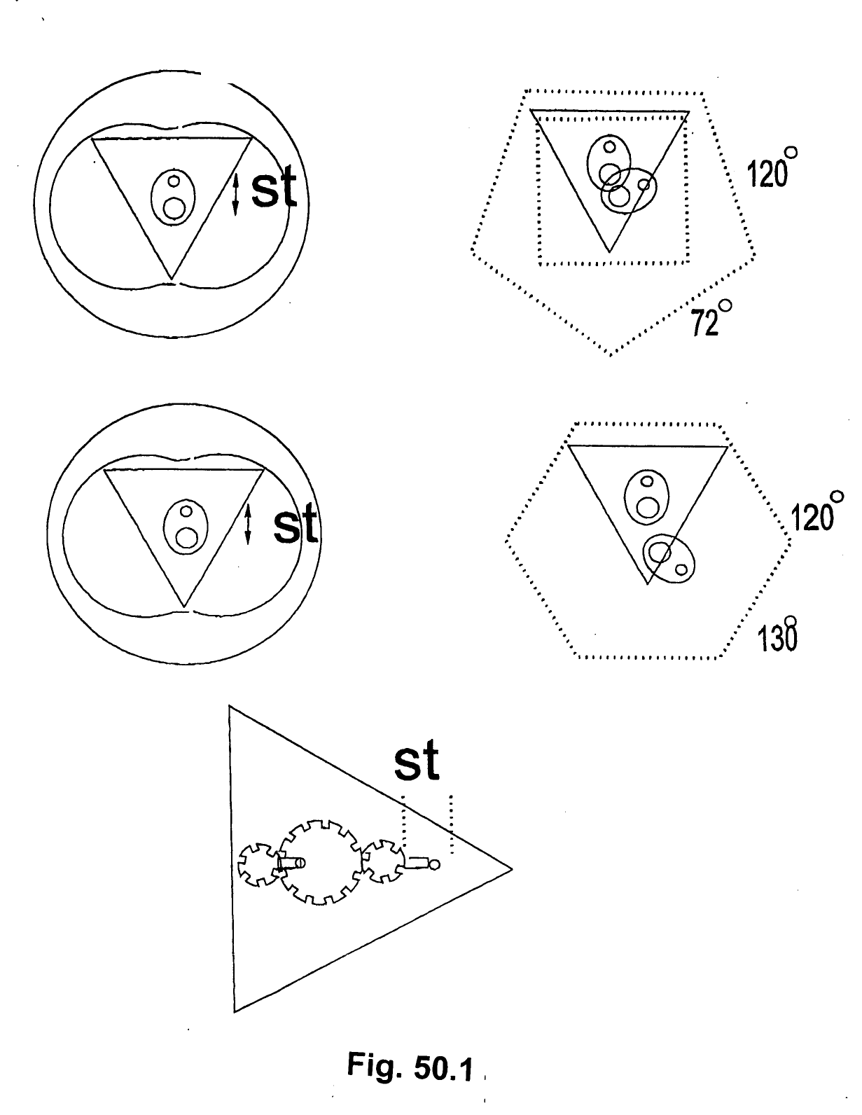

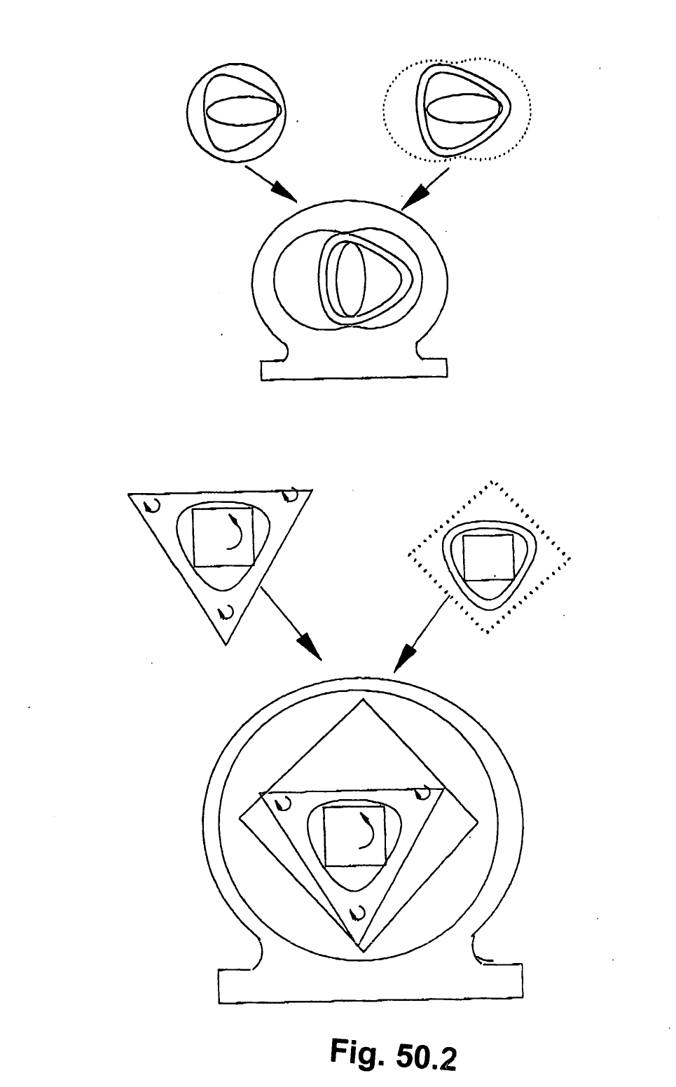

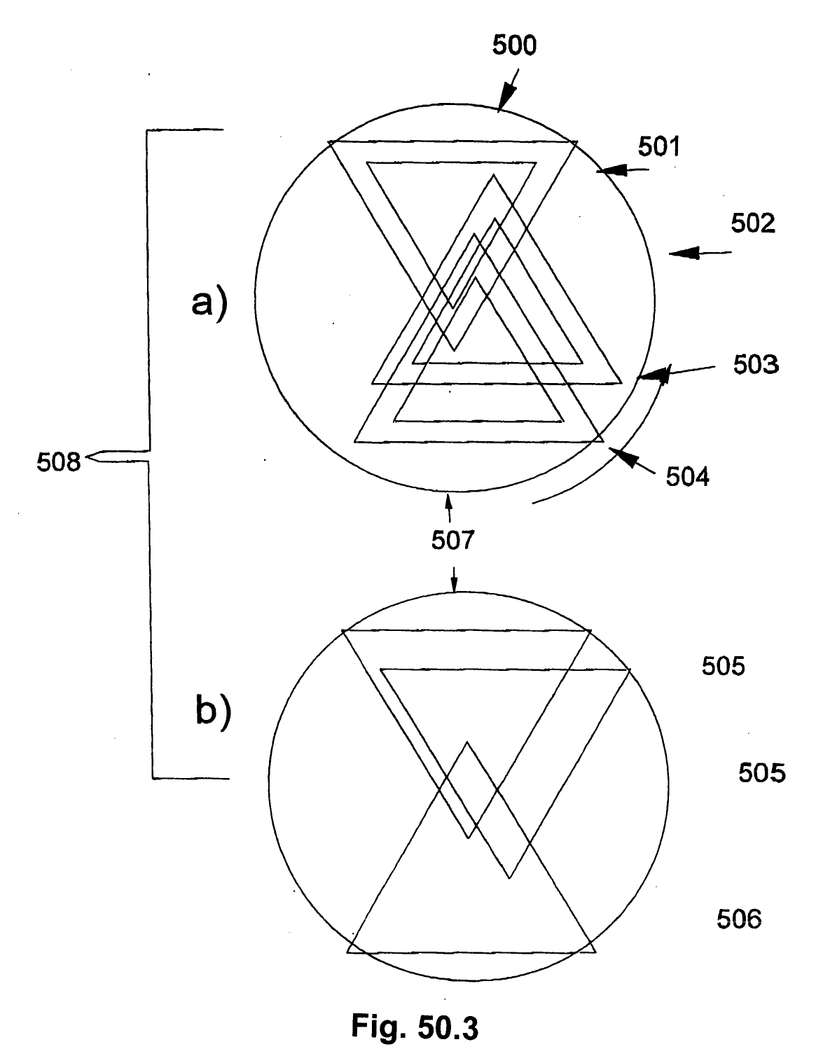

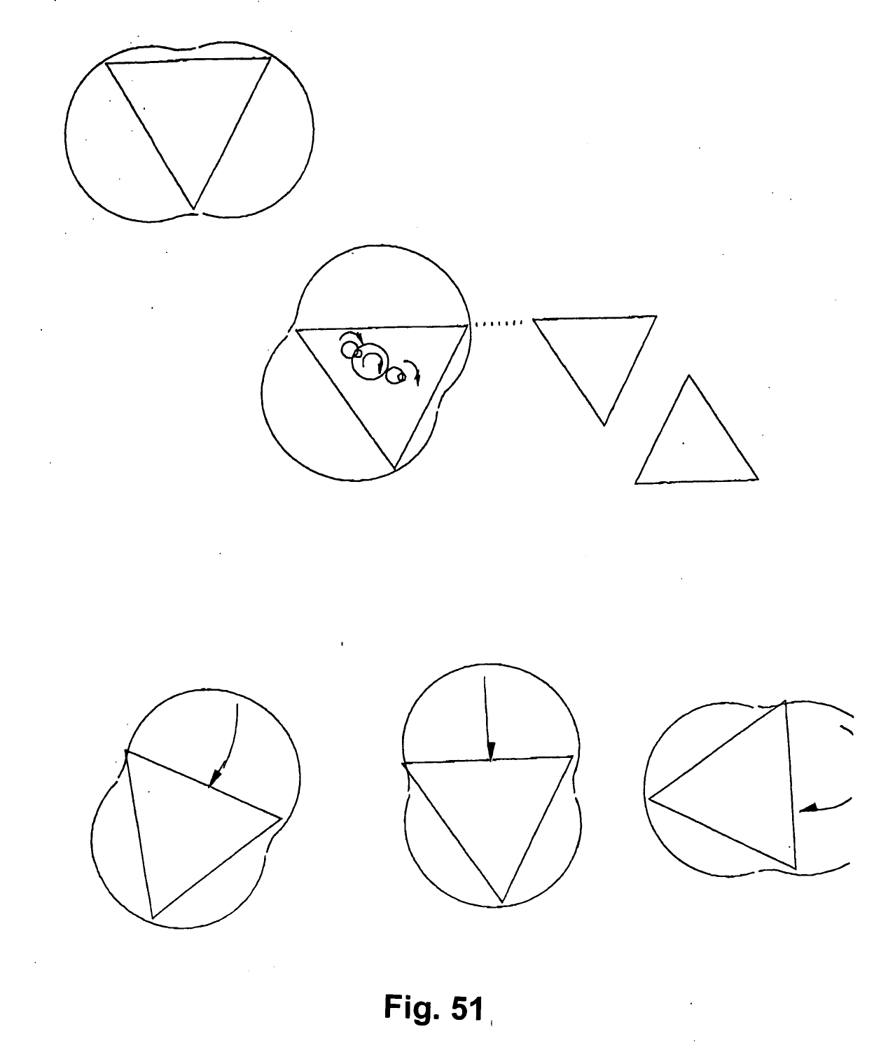

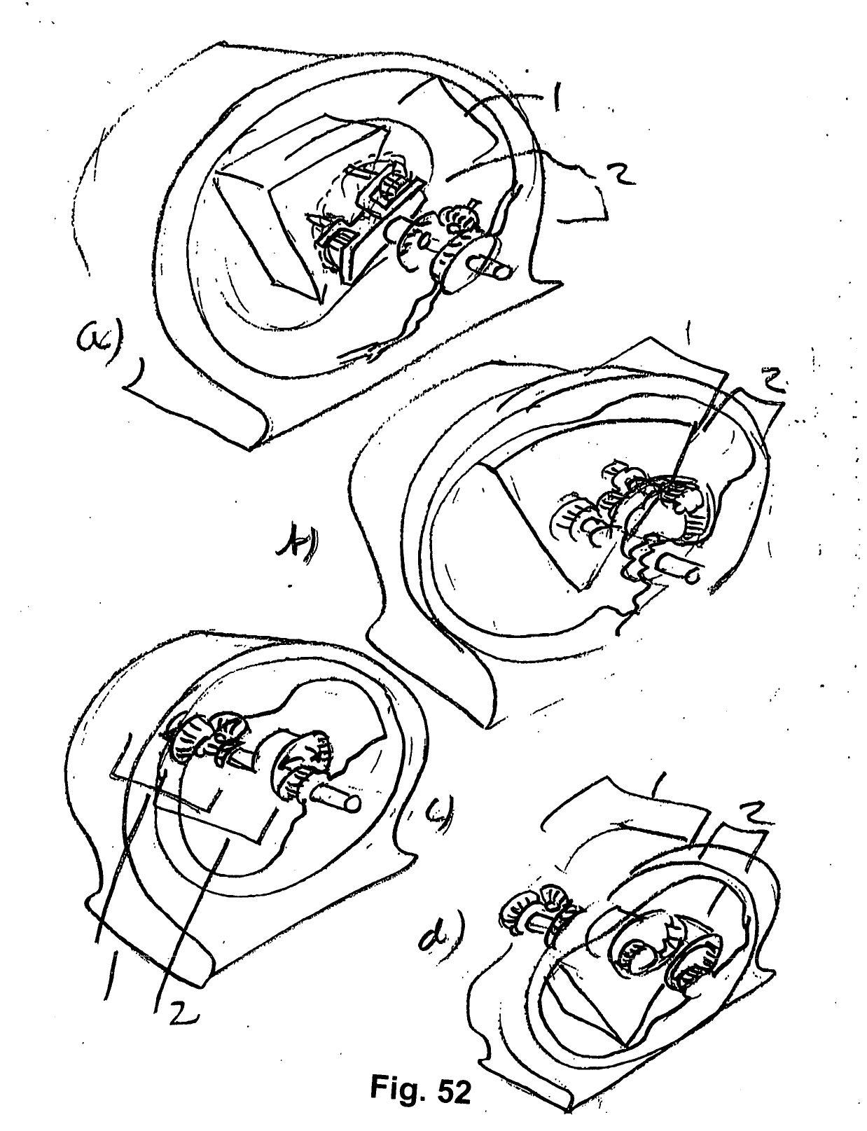

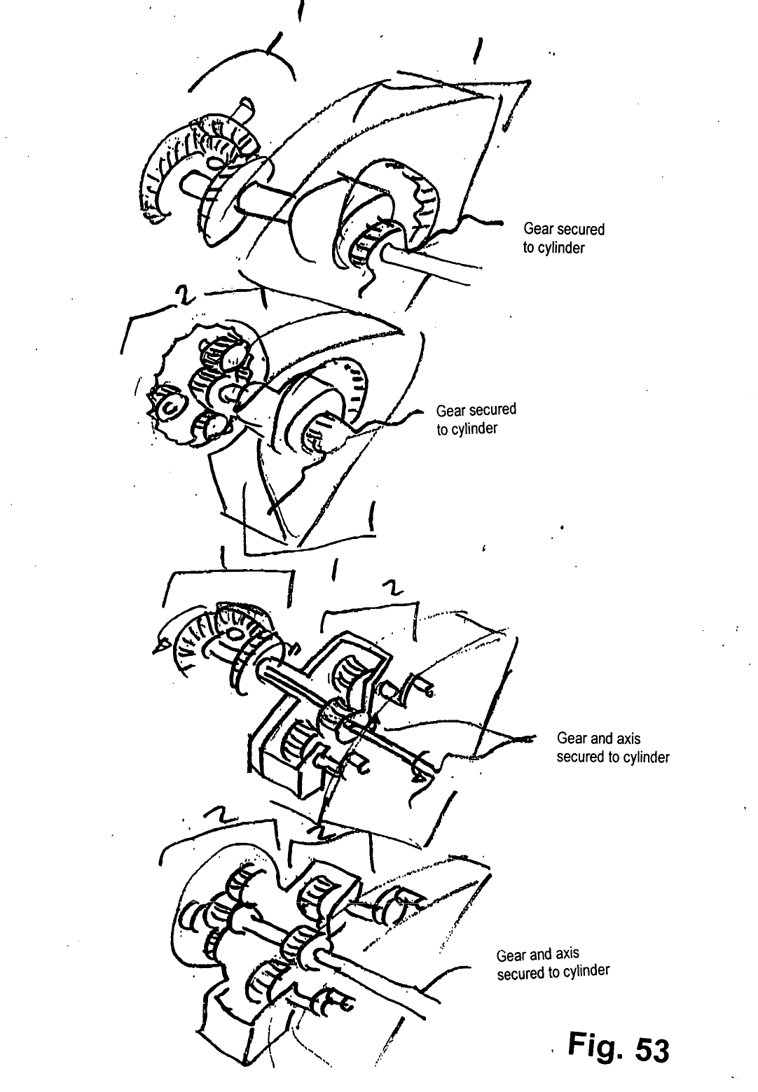

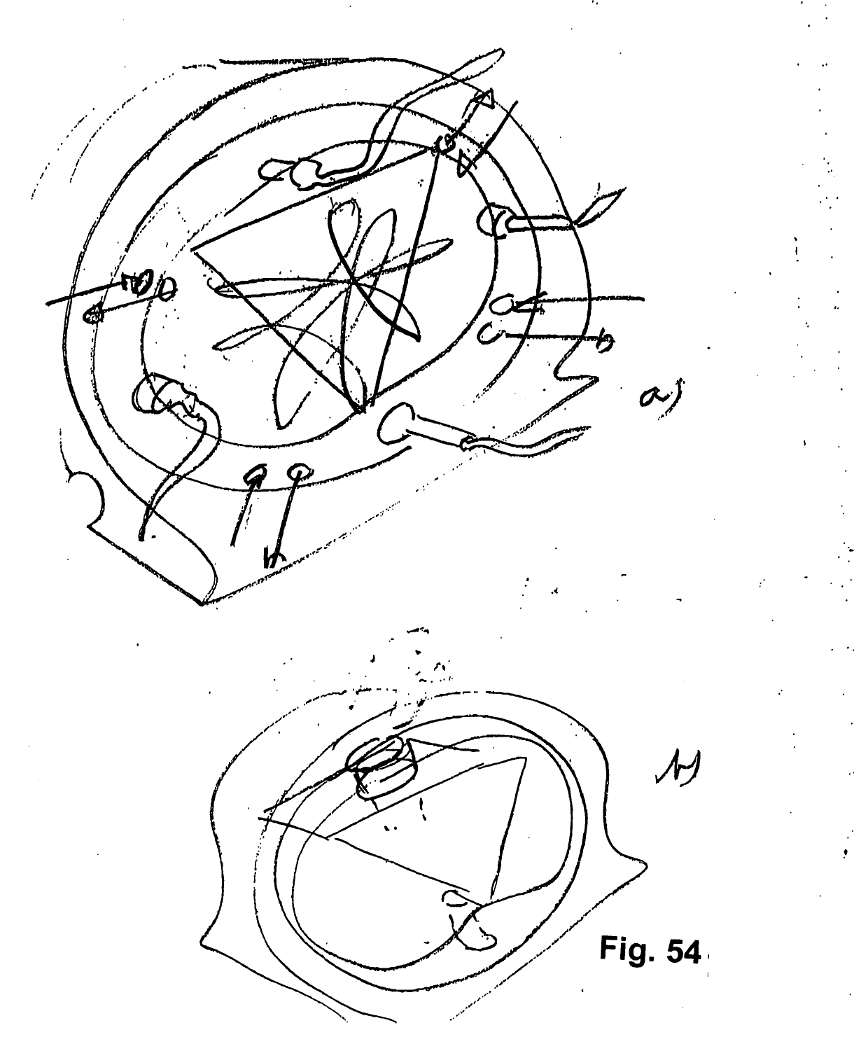

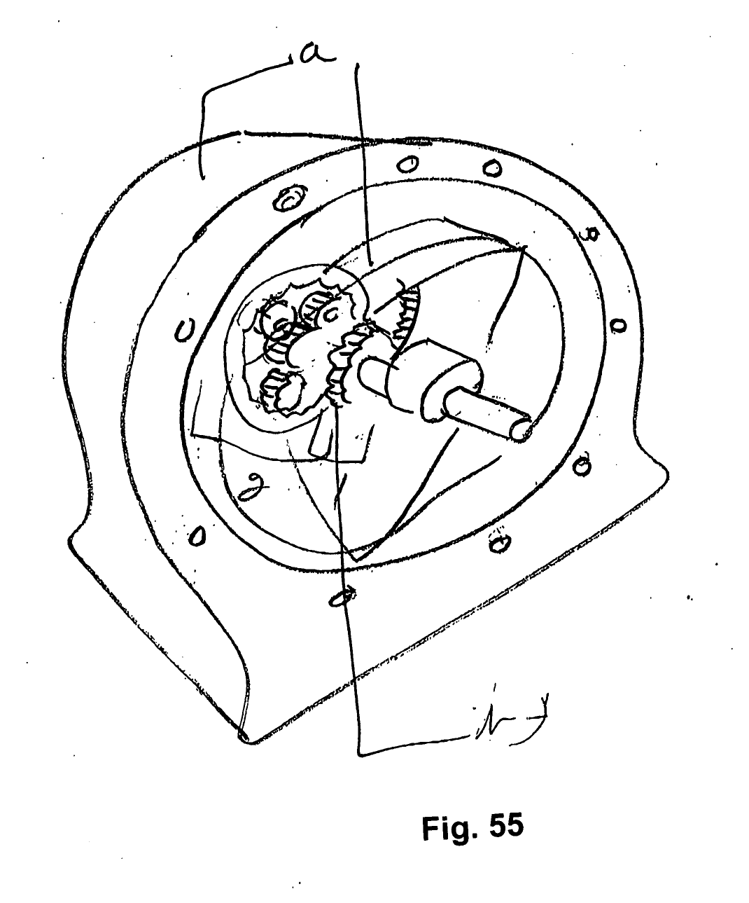

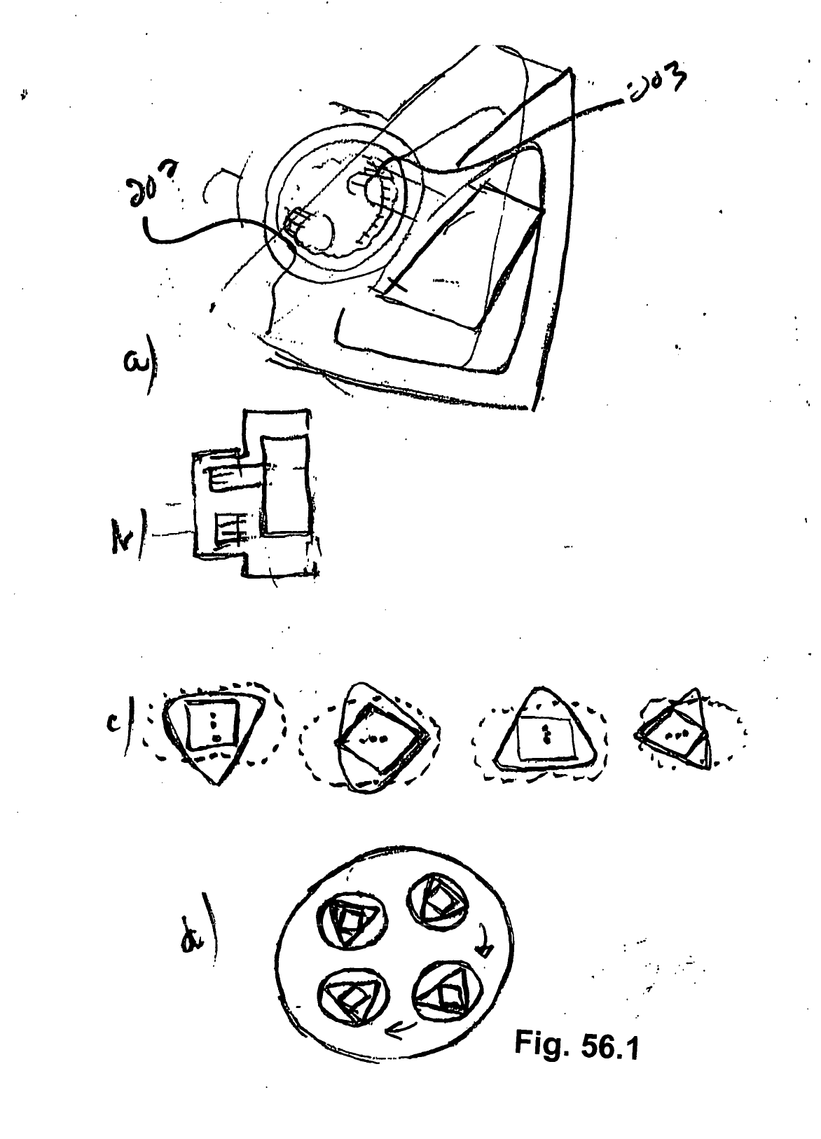

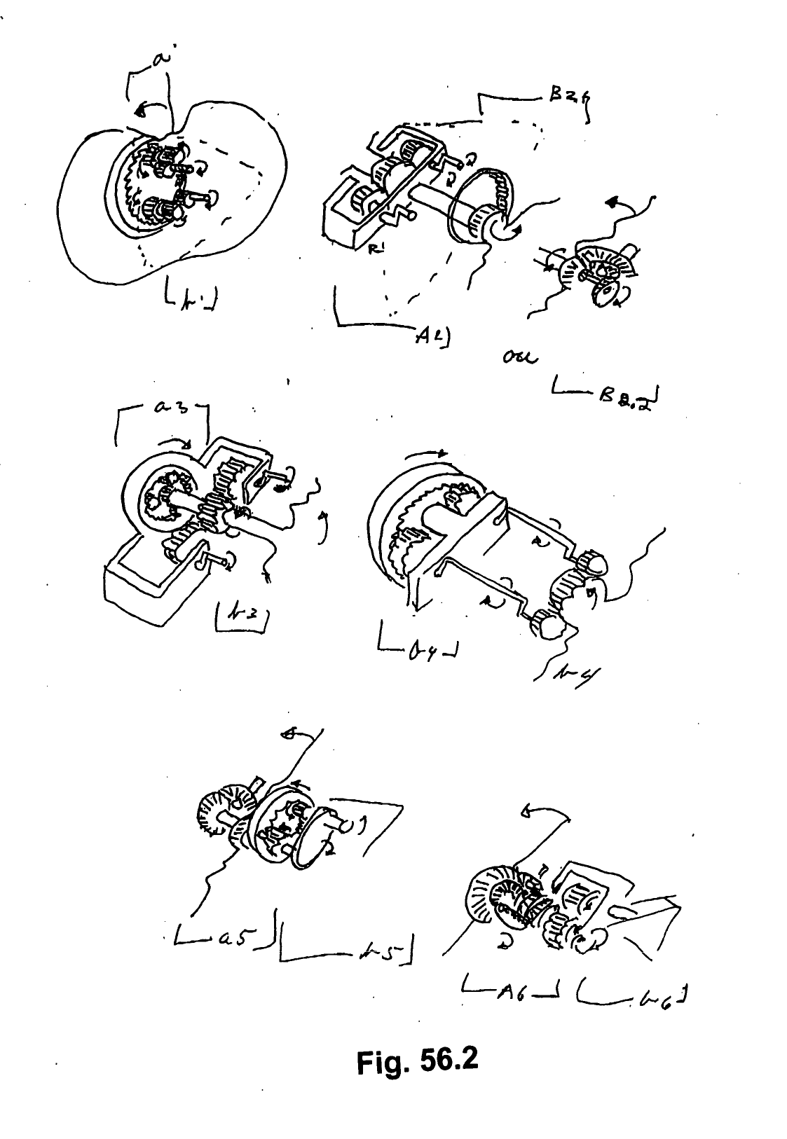

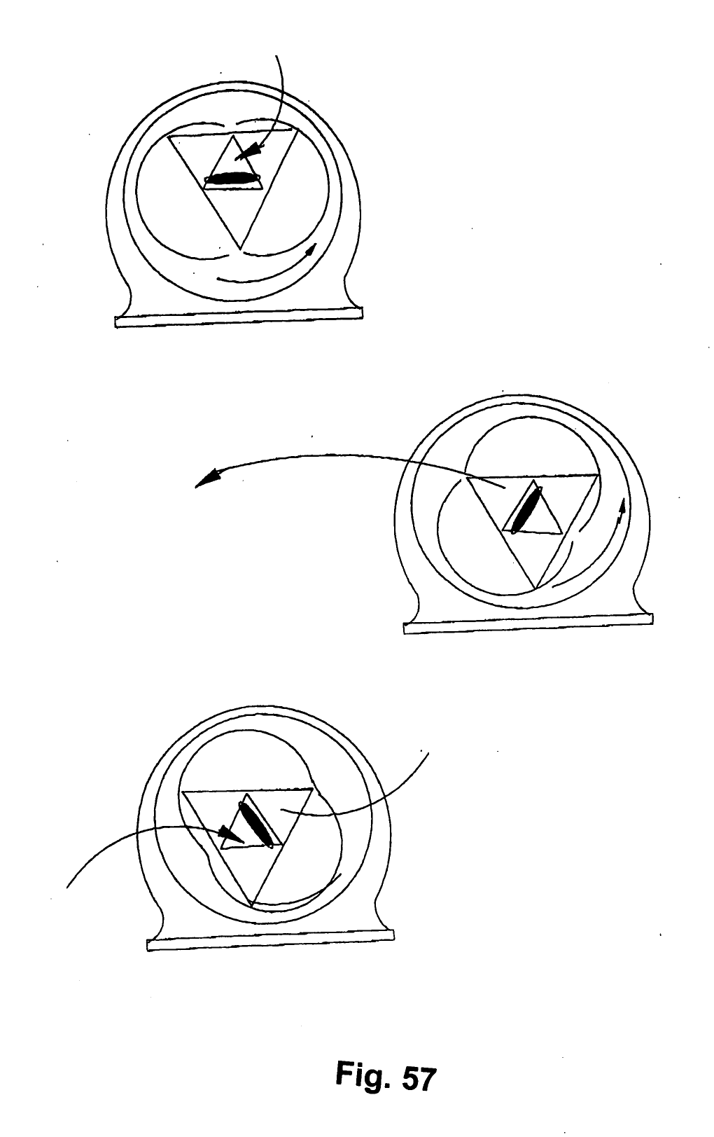

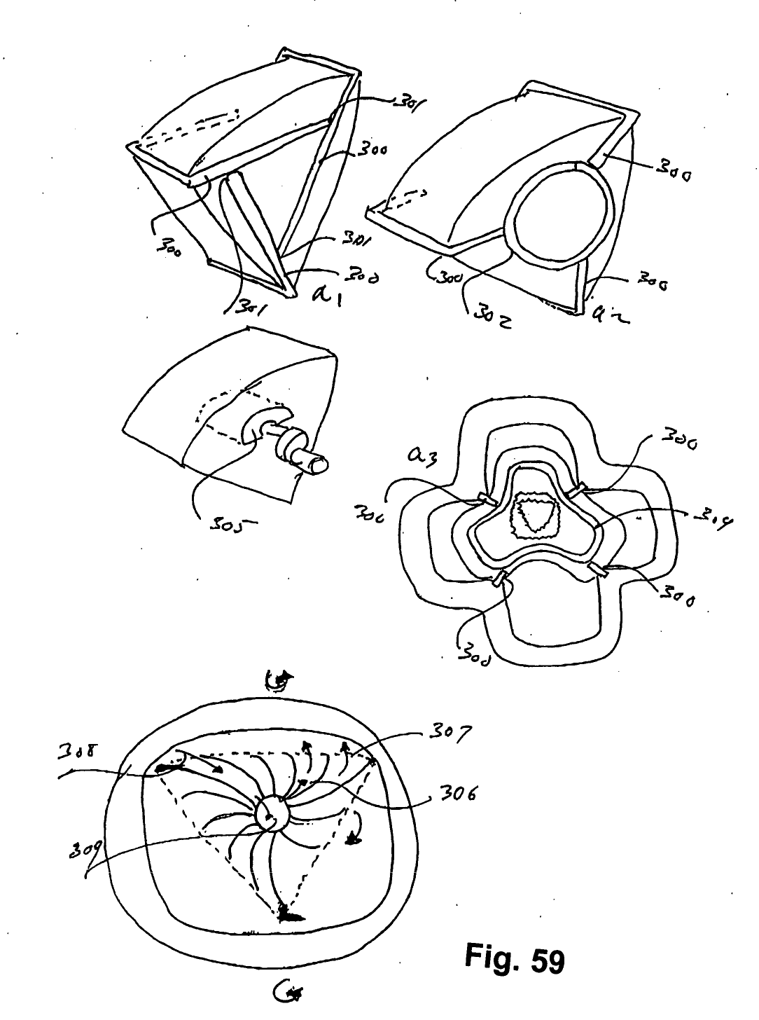

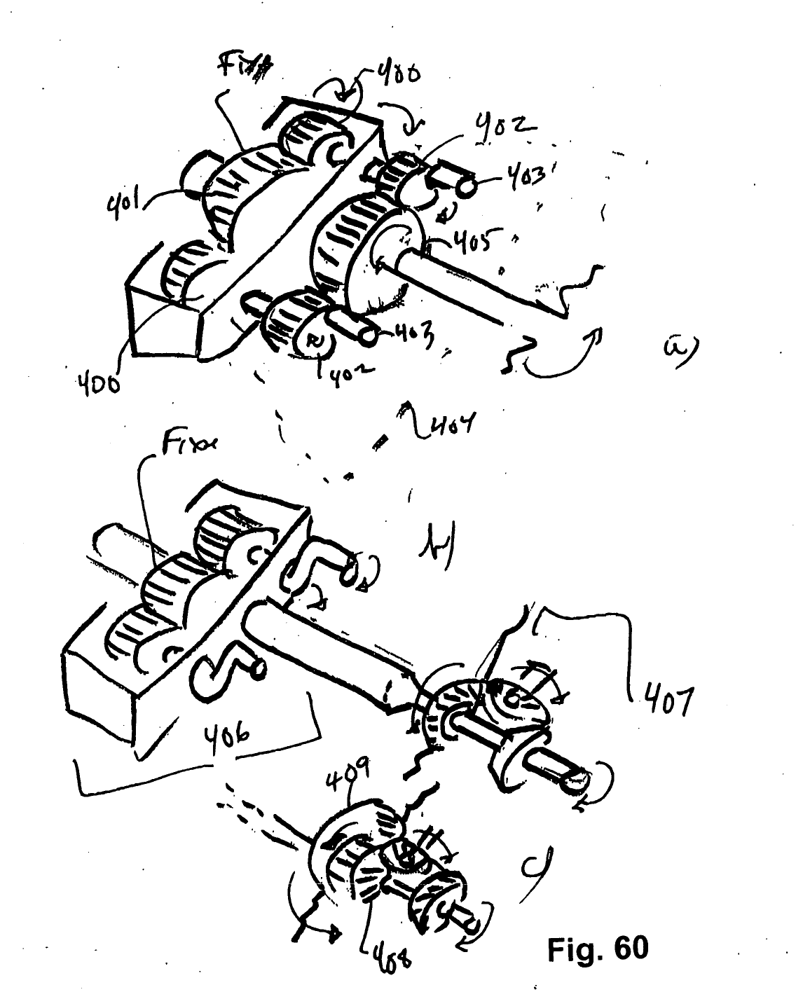

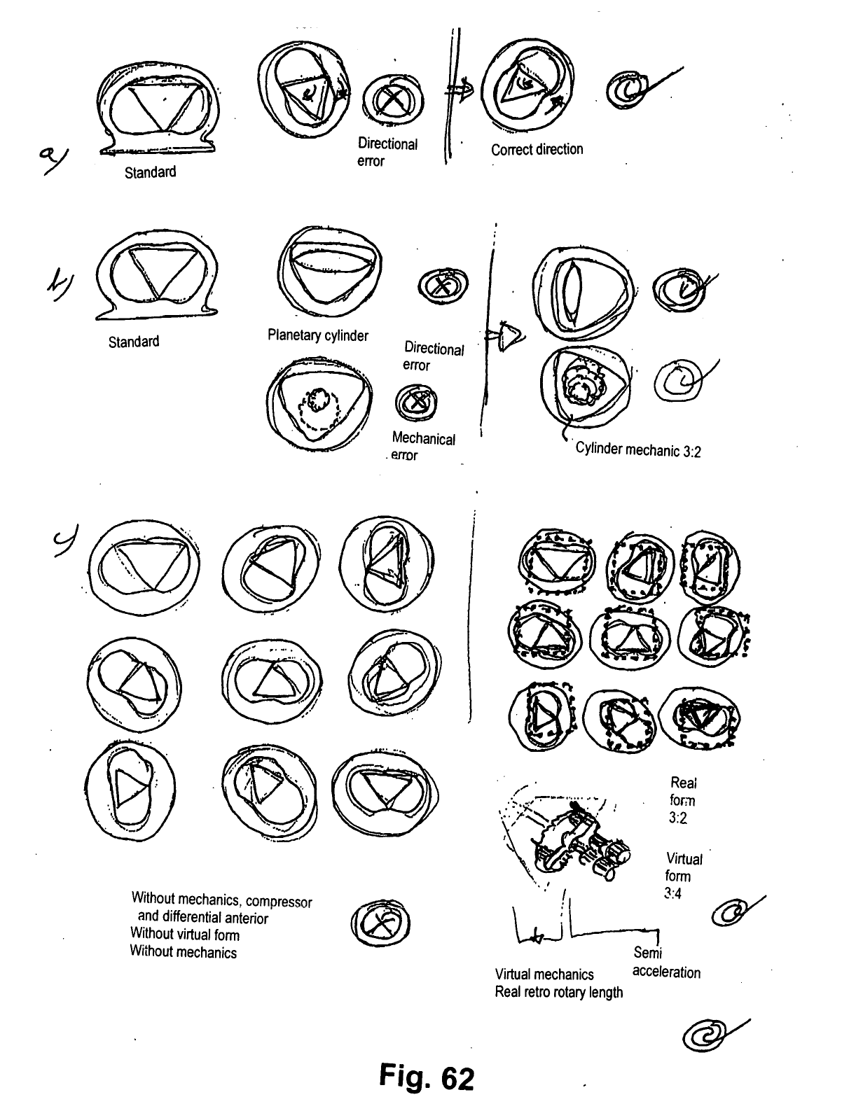

FIG. 33.3 shows for a same material figure of three sided paddle, two sided cylinder, such as shown in a), differential anterior dynamics, in b, and differential posterior dynamics in c.

Group of Figures Relative to Rotativo Circular or Rotativo Orbital Machines

FIG. 33.4 shows that another dynamic is possible, and that this dynamic allos to realize a contrario movement of the cylinder and the compressive part, such as we have previously shown for rotor cylinder machines.

FIG. 34 shows what we'll name the rule of cylindrical counter-part.

FIG. 35 shows that this counter part rule is a generalization, and is applicable no matter the location of the new projected explosion.

FIG. 35.4 gives a first example of a more complete dynamic allowing to make appear these figures which we'll name, by opposition to material figures, virtual figures.

FIG. 35.5 gives a second example of a material and virtual figure.

FIG. 35.6 re-exposes the continuation of the positions of a machine in Clockwise movement. As we can state, the originality of this type of machine is to describe a limit point between two areas of the chromatic scales of rotary machines.

FIG. 36 shows that we can inversely diminish the number of sides of the virtual figure in relation to the standard figure, which implies, in the measure where the compressions will be successive, which we'll realize a differential posterior form.

FIG. 37.1 shows that consequentially we can by adding or subtracting from one side of the virtual cylinder, transfer a post rotary machine, in rotary machine and vice versa.

FIG. 37.2 shows that this is true for all figure forms. We have here, as an example, in a, a triangular paddle machine, in b a square paddle machine, in c a five sided paddle.

FIG. 37.3 shows that the realization of synthetic figures are just as true for retro rotary figures as post rotary figures.

FIG. 38 shows that the realizations, for a same material figure, the virtual figures are not limited to the figures of a number of sides superior or inferior to one.

FIG. 39.1 shows that in reality, we can realize, for a same material figure, all the base geometric figures as virtual figures.

FIG. 39.2 shows that this is true for all the figures, and gives the example of a post rotary square paddled material figure.

FIG. 40 shows that we can realize the virtual cylinder of a machine by realization of each of its faces non successively, by jumps. For example, for a triangular paddled post rotary machine, realize this machine by locating each compression by jumps of eluded faces.

FIG. 40.1, gives the unfolding, for a rotation of all the paddle compression and expansion positions. It is important to make the following comments.

FIG. 41.1 reminds the slinky dynamic for a rotor cylinder machine, this dynamic realizing a course by part jumps.

FIG. 41.2 shows that, since the course of the non successive faces are possible, the continuations of synthetic courses, which we'll also name real courses, are multiple for a same virtual figure.

FIG. 42.1 thus enlarges the construction rule of a cylinder's rotivity by enouncing that we must take in account not the virtual figure, but the virtual course of realization of this figure.

FIG. 42.2 realizes a real, non successive, synthetic course, and which the jumps are realized in such a way to be located in the contrario area of the machine. Here, we elide consequentially a virtual face to each compression.

FIG. 42.3 shows the same real and virtual forms, but once again, with a different synthetic course. Here, the jump is of two the sequence is thus the following; I:1, IV:2, II:3, V:4, III:5

FIG. 43 summarizes the three previous figures and links concededly the synthetic course and the belonging of a realization to an area or another.

FIG. 44 shows that certain figures, in which the number of sides is even and low enough bring back inferior figures.

FIG. 45 shows various real courses of a virtual seven sided figure for a post rotary material figure with a three sided paddle. We can find here, from one to seven for each figure, the continuation of the compressions.

FIG. 46 shows various real courses of a virtual eight sided figure for a post rotary material figure with a three sided paddle.

FIG. 47.1 shows that more the number of sides increase, more the number of possible courses increase, and consequentially contrario courses.

FIG. 47.2 reminds that each material paddle figure has its specific surface and that more the paddle has of sides, more the contrario surface is restraint.

FIG. 48.1 summarizes the previous figures, and shows, in a single FIGURE, that many virtual figures are possible for a same material figure, and that many synthetic courses are possible for each virtual figure.

FIG. 48.2 shows, for a rotation, this time, a material post rotary figure of four to three sides of paddle and cylinder, realized on a ten sided virtual structure.

FIG. 49.1 shows, inversely, that many material figures are possible for a same virtual figure and that each of them will possess a preferable contrario surface.

FIG. 49.2 shows the chromatic scale of a machine with a material figure with a three sided paddle, and two sided cylinder. We can see here the differential anterior surfaces, realized when the explosion occurs before the clockwise movement of the machine.

FIG. 50.1 shows the mechanical specifications of these machines.

FIG. 50.2 shows, as for standard machines, clockwise machines can not only be realized inversedly, but also bi functionally.

FIG. 50.3 distinguishes, for the group of realizations of differential retro rotary, differential post rotary, and contrario chromatic scales, for machines which are virtual.

FIG. 51 shows the qualities of a machine in which the virtual cylinder is of eight sides and of jumps of two, and is consequentially contrario movement.

FIG. 52 summarizes the four types of possible mechanizations for rotativo circular machines:

Being:
a) by real mechanic of the virtual movement of the paddle
By semi transmitive mechanic of the rotary cylinder
b) by real mechanic of the virtual paddle movement
by descending mechanic of the rotation of the cylinder
c) by semi transmitive mechanic of the paddle
by confounded semi transmitive cylinder mechanic
d) by semi transmitive paddle mechanic
by descending mechanic of the rotary cylinder

FIG. 53 shows that each of these mechanics and semi transmissions can be standard, or poly inductive.

FIG. 54 shows that we can increase the efficiency of differential piston engines by realizing them with rotor cylinders or added superior pistons.

FIG. 55 is a mechanization example of circular rotary machine in which we use a poly inductive semi transmission in a, and in b, a mono inductive descending induction.

FIG. 56 shows a few other combinations, among the hundreds of possibilities.

FIG. 57 shows that the clockwise movement is also possible peripherally.

FIG. 58 shows that the clockwise movement can be realized bi functionally, the external cylinder, and the internal sub paddle being strictly rotary, and the paddle in clockwise movement.

FIG. 59 shows in a) that we can realise in a simplified manner the segmentation of rotary machines by use of “U” segments. In b) of the same figure, we show how to realize a machine with the means of a crankshaft rather than an eccentric. In c of the same figure, we show that we can realize the paddle in a rotary manner of clockwise movement cylinders by reconstructing it in the manner of a turbine paddle.

FIG. 60 shows three other supplemental mechanical combinations.

FIG. 62 shows, in addition of the previously mentioned mechanical gaps, the semantic gaps overcome by our works relative to planetary cylinder machines, there is error of directionality or mechanical contradiction.

### DETAILED FIGURE DESCRIPTION

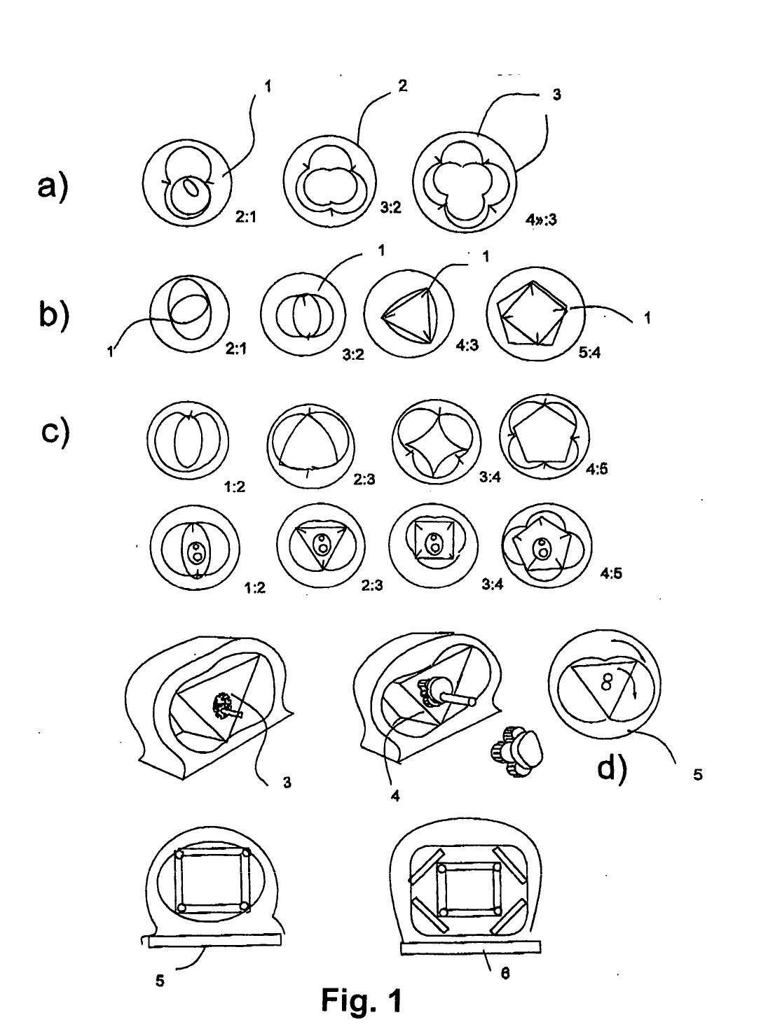

FIG. 1a) shows the main retro rotary figures of the previous art, notably those of Cooley. In 1b), we see Wankle, Herman, and Fixen's work, who have mainly realized a modification of the base forms in such a way as to realize machines with a paddle segmentation 1, by opposition to a cylinder segmentation 2, as in machines of the previous art. In b), we notice post rotary figures of the art previous to Wankle, also segmented on the cylinders. In the second part of b), we notice Wankle and Fixen's figures in which, as in a) 2), have set up the segments on the paddles. In 1c), we notice Wankle's two unique mechanics for planetary paddle machines, being mono induction 3 and by intermediate gear 4. In 1d), we notice the only dynamic variant for which Wankle has provided support mechanics. In e), we show two compressive structures of the previous art, before Wankle. Specifically, they are Wilson's polyturbine 5 and St-Hilaire's Quasiturbine 6.

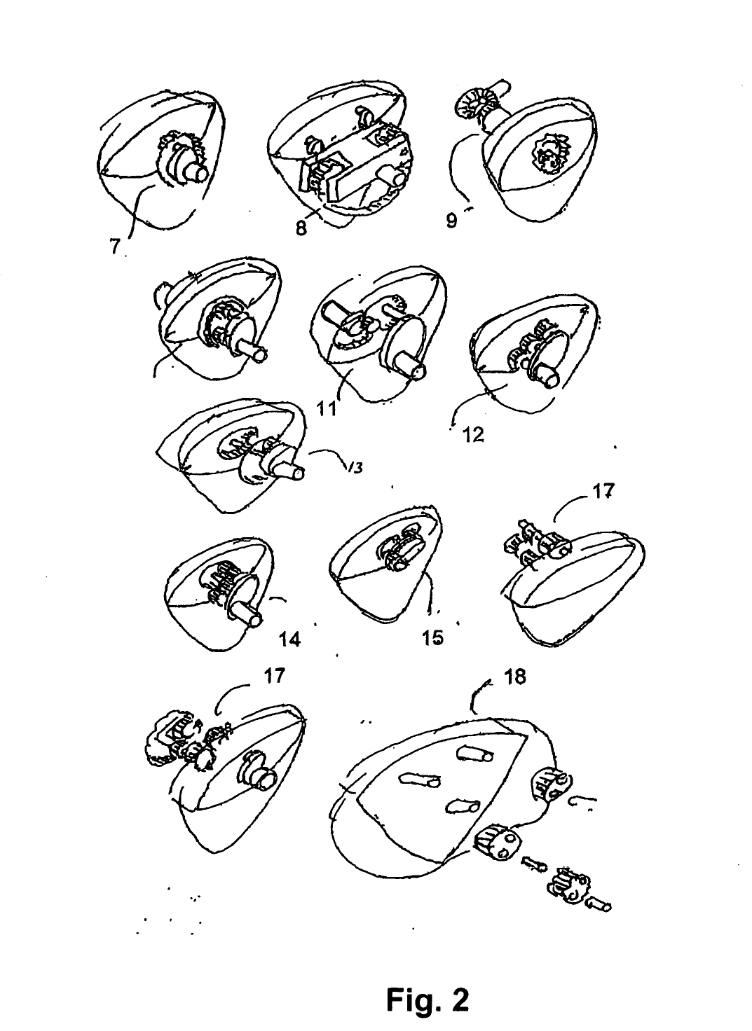

FIG. 2 shows the group of Wankle's first degree methods, as well as those which we have elaborated beforehand. In 7, we find Wankle's method by mono induction, in 8 the method by poly induction in double part, in 9, the method by semi transmission, in 10, the method by hoop gear, in 11, the method by internal layered gears, in 12, Wankle's method by intermediate gears, in 13, the method by internal juxtaposed gears, in 14, the method by intermediate internal gear, in 15 the method by unitarian gear, in 16, the method by heel gear, in 17, the method by dynamic central gear, in 18, the method by gear-like structure.

These methods have all been commented on previously. We bring them up here because they enter in composition with other methods to support the compressive parts of machines disclosed in the current exposition.

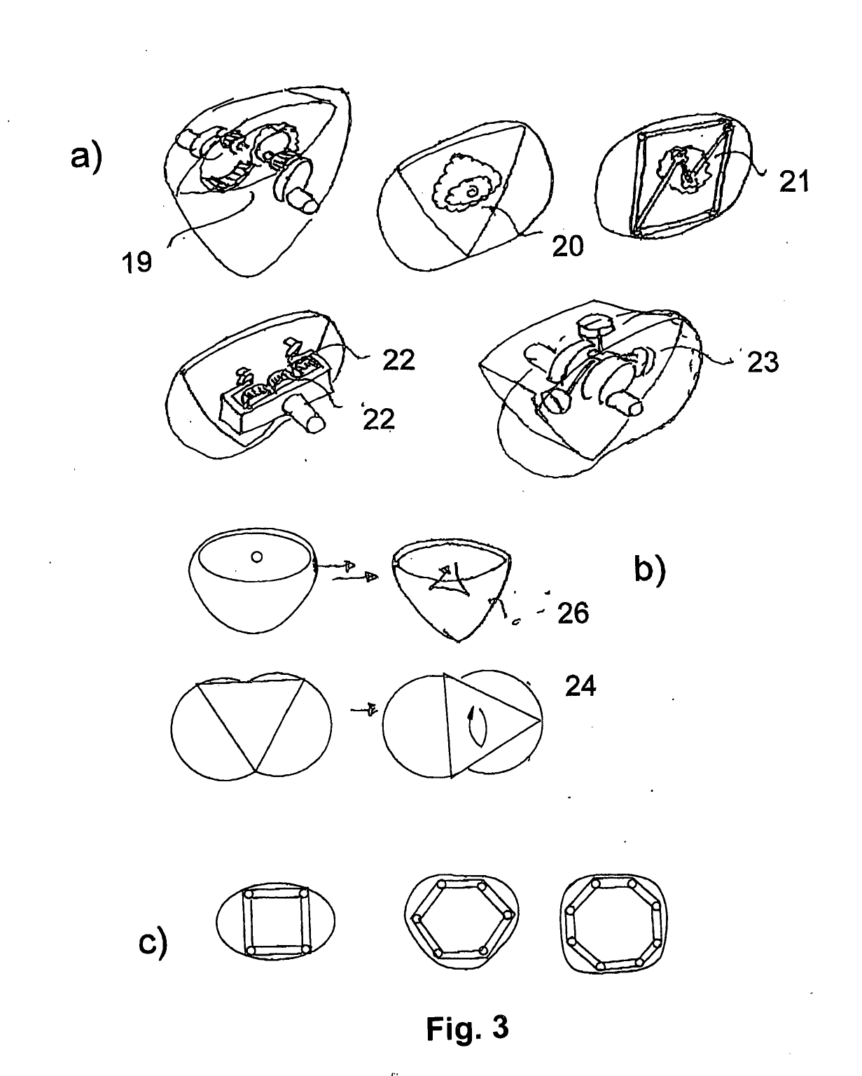

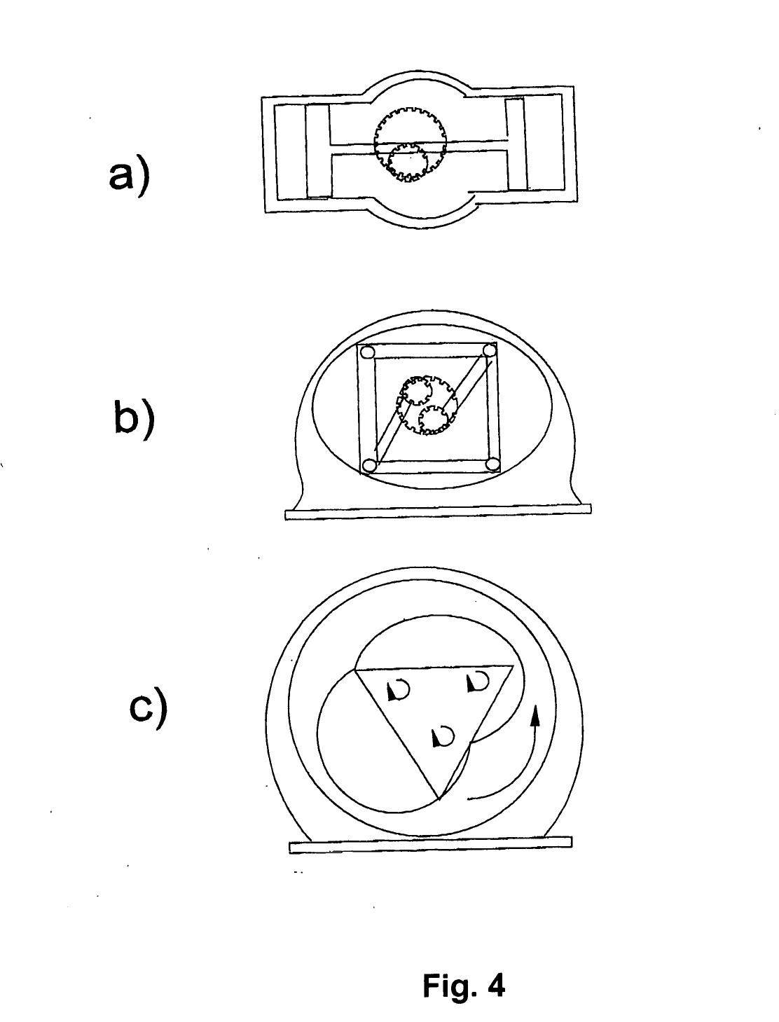

FIG. 3 a) shows the main methods of increasing the mechanical degree which we have previously elaborated. These are the methods by layered combinations of central and peripheral inductions, 19, the method by polycammed gears, 20, the method by geometric addition 21, the method by semi transmittive poly induction 22, the method by poly crankpins 23.

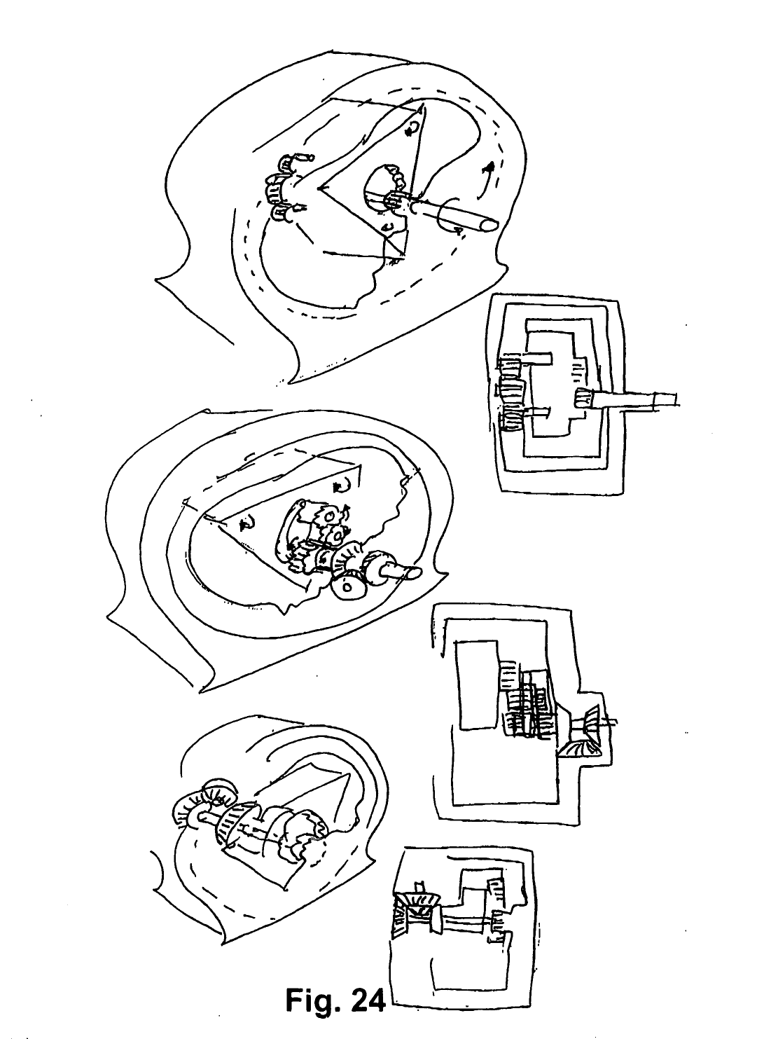

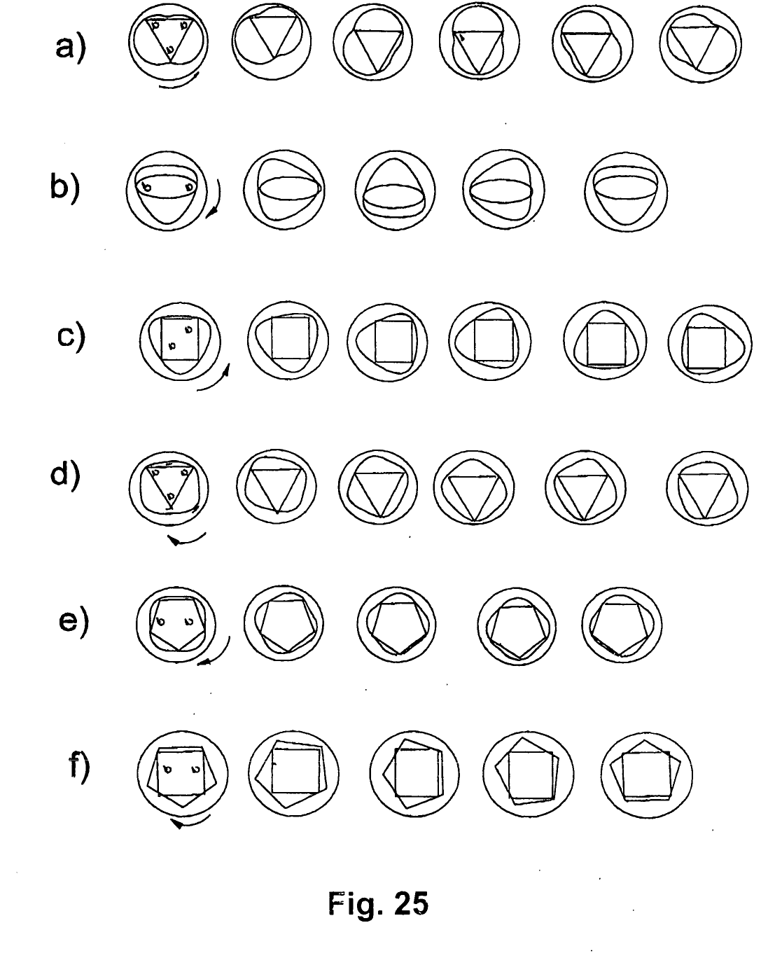

In b of the same figure, we simply bring up the fact that these methods generally have as result to increase the coupling and an improvement of the curve of the machine FIGS. 24, 25.

In c of the same figure, we bring up the generalizations of sizes which we have produced for paddle structure machines, being Polyturbines.

By these methods of degree increasing by modification of paddle course, we have shown that we could increase the compression of retro rotary machines and the coupling of post rotary machines. We have also shown that we could realize retro rotary machines of various degrees, these machines, for example, poly turbines, realize new cylinder forms which are more subtle and which are supported by an increase in the number of inductions. We have shown that we can produce, with the means of polycammed gears, accelero-decelerative actions of the compressive parts, increasing their oscillatory effect, and thus increasing the course of its compressive parts and the forms of the relative cylinders. We have shown the mechanical layering combination rules. We have generalized the cylinder forms of poly turbines. We have shown the effects of poly crankpins on rotary machines. We have shown that the machines could be constructed by groups of unitary paddles, standard polyfaced paddles, paddle structures. We have shown the perfectly bi rotary dynamics of clockwise paddle movement, and the rotativo-circular dynamics which this movement implies.

FIG. 4 brings up, also from our first par, the three main types of bi inductive machines, being a) the rectilinear rod machine, in b) the poly turbine machine, and in c) the machine with paddle in movement with rotary cylinder.

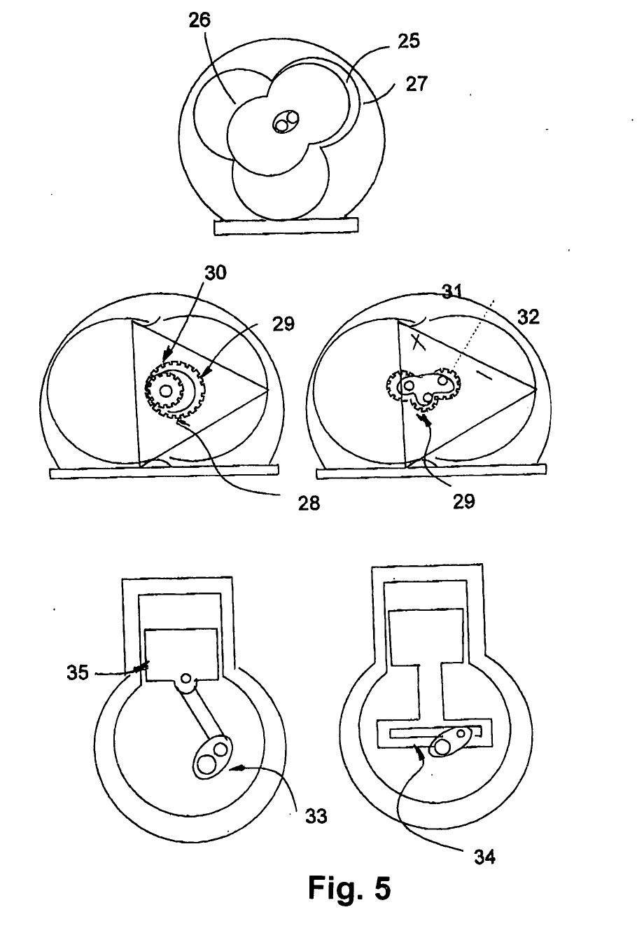

FIG. 5 a shows the push in engines before Wankle. We note that these machines are efficient, from the point of view of the push, firstly, since their explosion is realized at the height of the ascent of the crankshaft and of the straightening of the paddle, 25. Secondly, we notice that the descending push on the paddle 26 is done by its connection to the cylinder, this connection allowing a so called lever effect 27.

In addition, its this same connection which has been the cause of the premature wear of the segments, and this is why Wankle has realized two paddle support methods making its segmentation possible.

FIG. 5b shows Wankle's two inductions, the mono induction and the induction by intermediate gear. We'll explain more thoroughly, during the current disclosure, the fundamental gaps having participated to the mechanical deficiencies of these inductions. For the moment, we'll simply mention that each of them produces a high proportion of counter pushes which are harmful to the machine motricity. In the method by mono induction, whereas the explosive push on the front of the paddle realizes a motricity 29, the push on the back part of the paddle produces a counter force 30, reducing the machine motricity.

In the mechanic by contrario intermediate gear, the push in the direction of the rotation is realized by the back part of the paddle 31, and the negative push is produced on the front part 32.

FIG. 5 c shows the differences between standard piston engines 33, and runner rod engines 34. Whereas in the first case, we produce in descent course the anchoring of the piston to the cylinder 35, realizing what it is common to name the rod effect, we state that by the use of a runner type of rod, we lower the number of parts constituting the machine, and we loose the said rod effect. In the two cases, we can state that a first important gap of Wankle's two mechanics consists in a), by displacing the anchoring of the machine has been lost the peripheral anchoring, originator of the lever effect of the push of the explosion on the totality of the paddle surface.

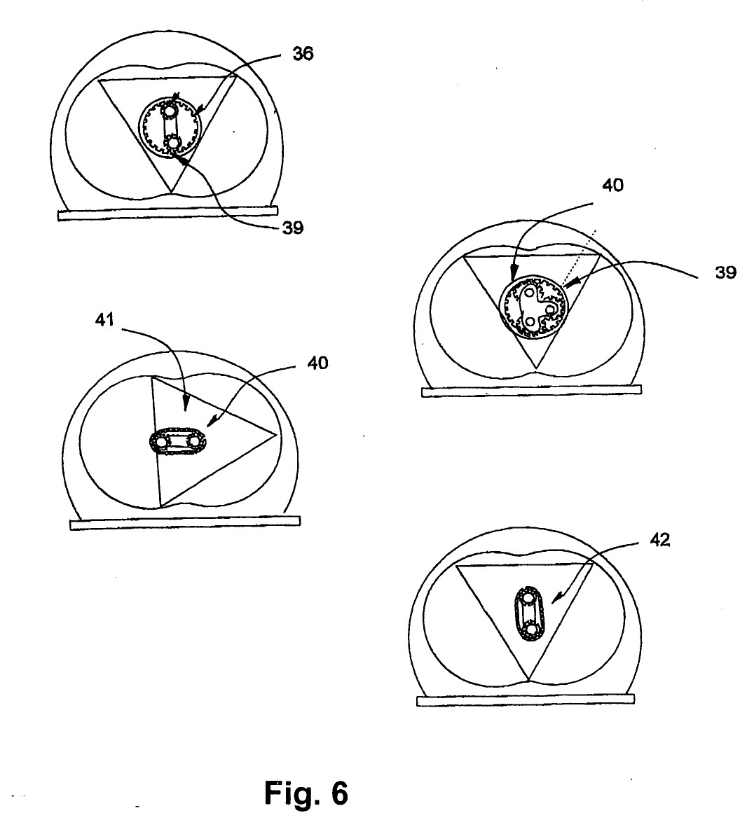

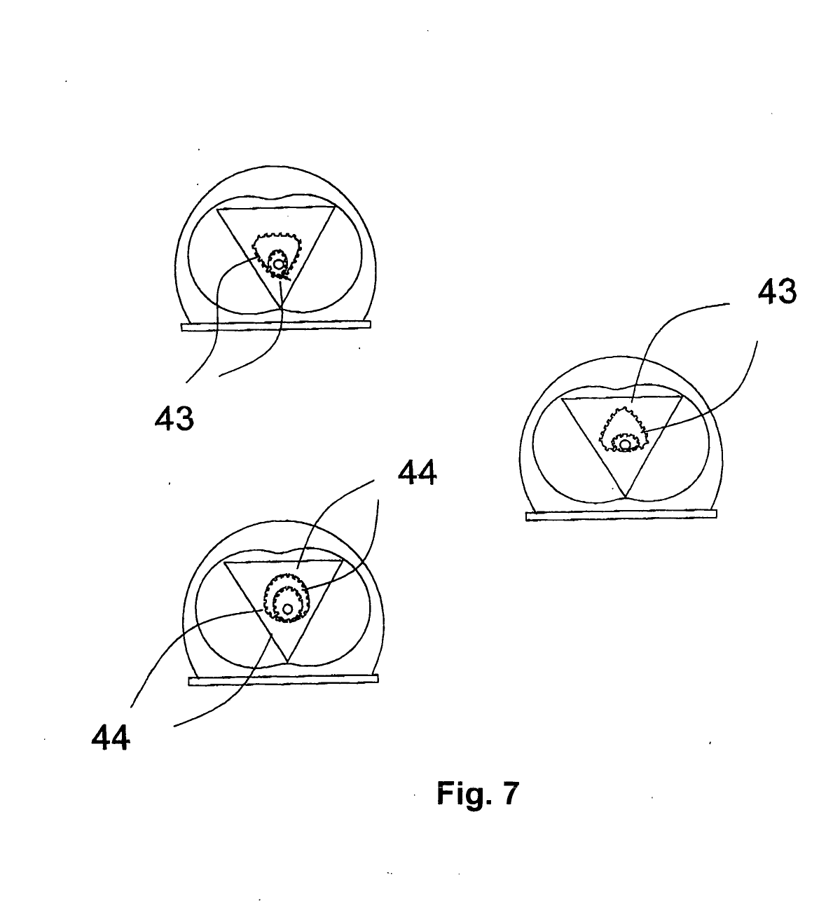

FIG. 6 shows the precisions brought by the current invention relative to the induction by hoop gear. In a, we find the mechanic by hoop gear in its original form. An external type induction gear 36 is set up solidly in the center of the paddle, and a support gear, also external 37, is fixed solidly to the machine corpus. A hoop gear 38 is set up in a rotary, planetary manner to the support gear in such a way to be coupled to the induction gear. The retro rotation of the hoop gear, in course of rotation leads the paddle retro rotation.

In b), we see that a third tension gear 39 has been added, which allows a de-axation of the attack of the hoop gear on the induction gear, and also, a stronger string effect, preventing the forward push to be transformed into retro rotation.

In c), the hoop gear is realized as a chain 40. The forward push on the paddle is transformed into the string effect 41, which leads the post rotivity of the paddle, in addition of the backwards push. Oppositely to Wankle's inductions, the two pushes are thus positive.

In d), the chain is realized as it's belt form 42 and produces the same effects.

FIG. 7 shows the precisions brought by the current invention relative to the induction by polycammed gears. As we have already commented many a times, polycammed gears 43 allow the realization of many machines requiring accelerations and decelerations of parts. The current simply has for effect to mention that the realization of gears, round, or polycammed, with dentitions of variable distance from the teeth 44 could produce the same accelero-decelerative effects.

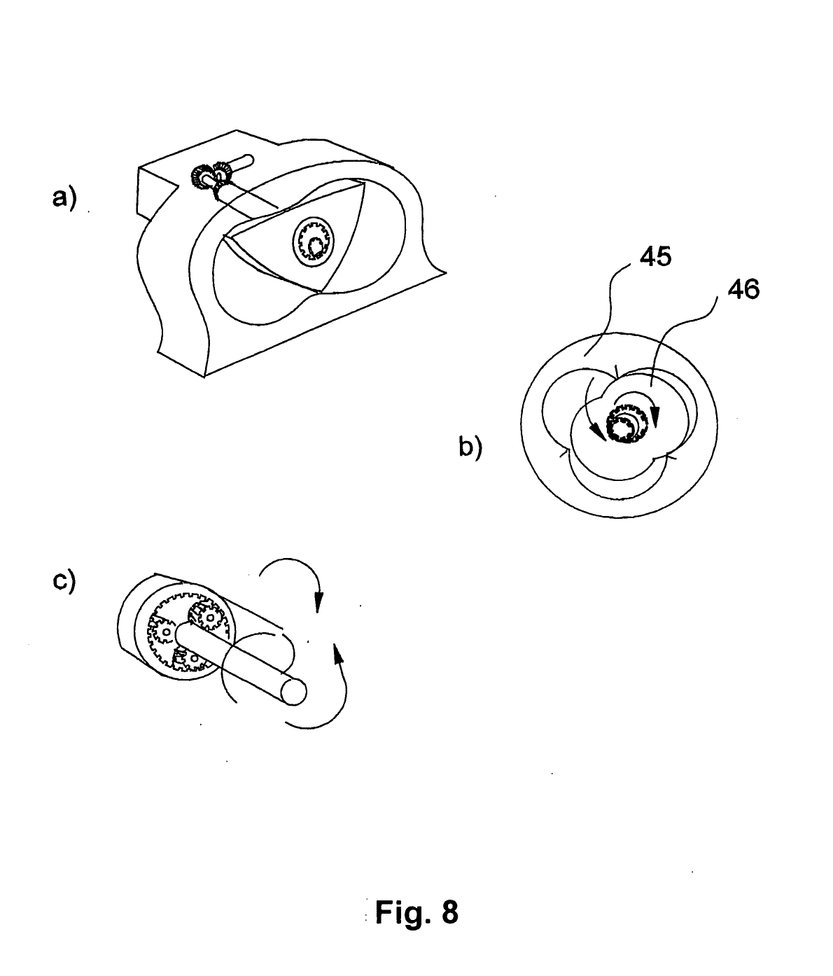

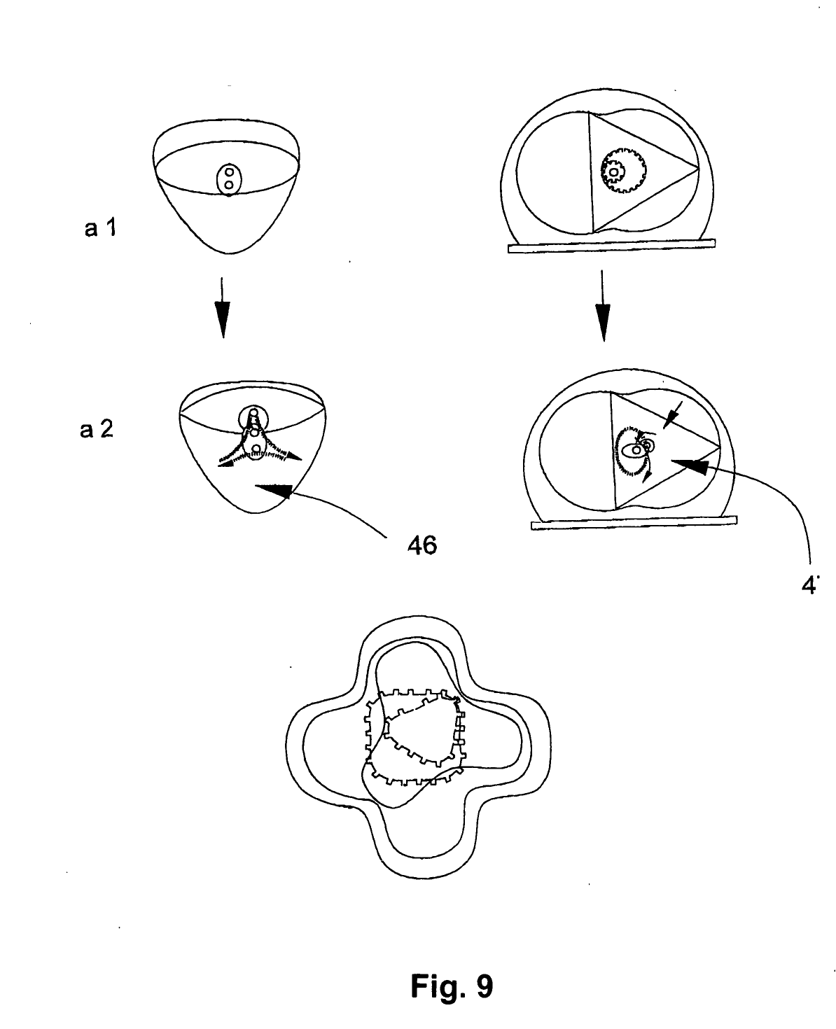

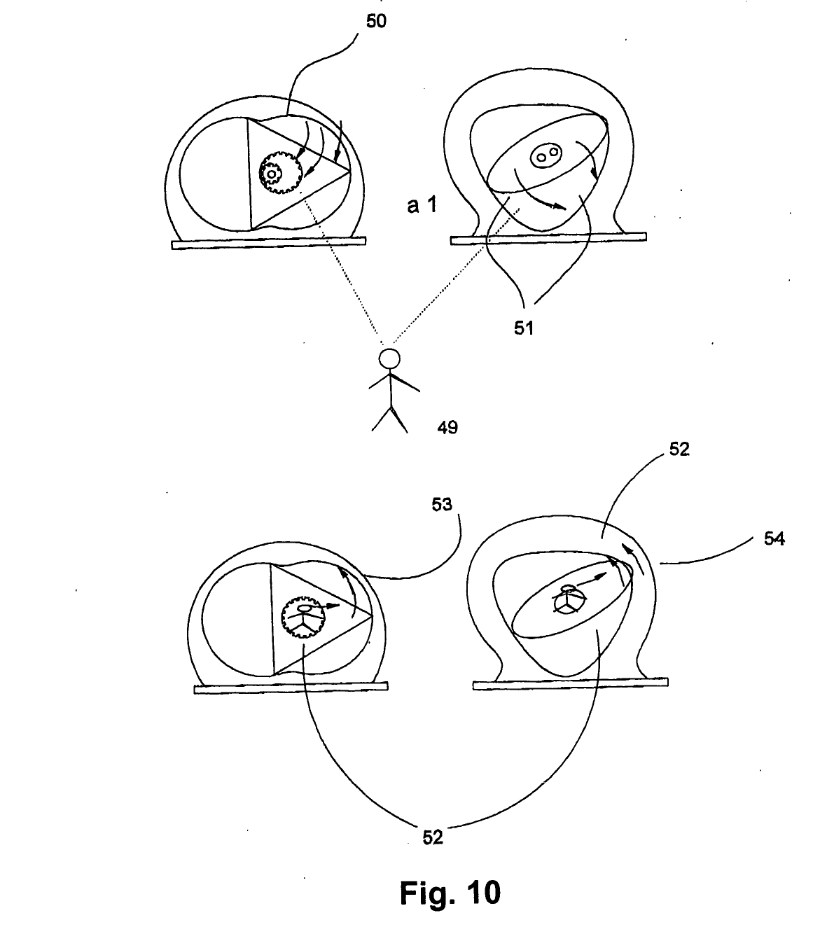

FIG. 8 shows the precisions brought by the current invention relative to induction by semi transmission. We must simply add that the semi transmissions apply to all forms of rotary machines, including explosion machines at the height of the paddle rectification, and to all induction. In these cases, the push on the active support gear 45 is in a straight line with the machine motricity, and is added to the push on the eccentric.

FIG. 9 shows for the two base post and retro rotary figures, the form and coupling corrections brought up beforehand by us by the addition of degrees by layering inductions. We see that the layering of inductions, from a) 1 to 2, has allowed a much better compression capacity 46. In addition, from b 1 to b 2, we see that the position of the master and subsidiary crankshafts is much more favorable to a systemic deconstruction 47. The figure shows in addition, in c, that the application of polycammed gears to figurations in which the segmentation is located in the corners of the cylinders allows a softening of the paddle shapes and an improvement of the longevity of the segments. We'll consult, at the end of this exposition, the propositions of segmentations which we will present.

FIG. 10 shows two types of observations leading to the realization of specific inductions. In the first type of observation, in a) which name exterior comparative, the observer, positioned on the outside of the machine 49, is in measure to state that what defines post rotary machines is that in them, the paddle travels in the same direction of the crankshaft, but at reduced speed 50, whereas what defines a retro rotary machine consists in that the paddle travels in counter direction of the crankshaft 51. Its from this type of observation that can construct the method by mono induction.

In b), of the same figure, we show the observation by the crankshaft. In this type of observation, the observation can be produced from an observer, this time positioned on the machine's eccentric 52, we'll state that, whether the machine be post or retro rotary, the paddle always has a retro rotary action in relation to that of the crankshaft 53, and that what differentiates machines, from this point of view, is a difference in degrees, in what that the retrorotation of the machine is more accentuated 54.

Its this type of observation which could be realized all methods in which the induction of the paddle is realized in view of realizing a retro induction in relation to that of the crankshaft.

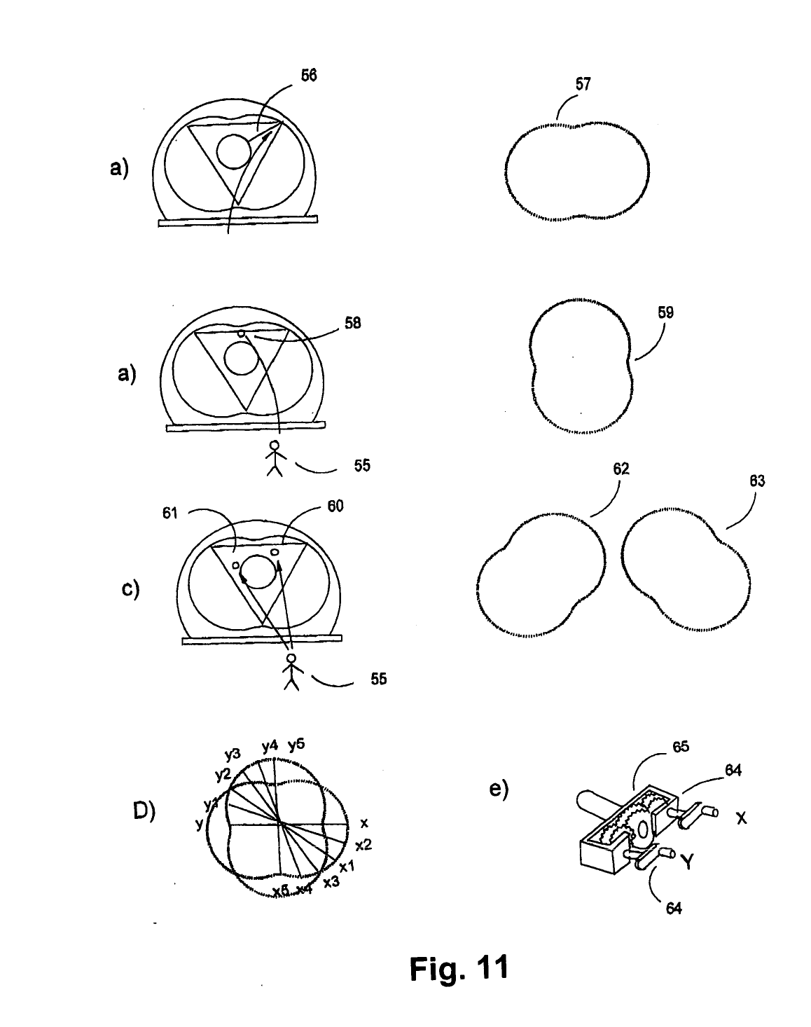

FIG. 11 a shoes the method of specific exterior observation. This method consists in observing, by an outside observer 55, the movement of a specific point of the paddle in course of its planetary rotation. This type of observation is the comprehension base of the poly induction method. In a), we notice that all point located on a line leaving the center of the paddle at one of its extremities 56, realizes a course similar to that of the paddle, and slightly more obtuse 57. In addition, if the chosen point is located on the line from the center, connecting it to the center of one of its sides 58, the realized course will be similar to the first, but in opposite direction of it 59.

In addition, if the chosen point is located in an area intermediate to these two lines, being posterior 60, or anterior 61, the forms realized by these points will also be similar to the first, but this time in an oblique orientationally half way between the first, being posterior 62, or anterior 63.

During these observations, we'll state in addition a constant between the realizations of these curves, in lack of their specific, totally different orientations. If we trace a line between the lowest point of one of the figures, in y and the highest point of the other figure x, and we follow the unfolding of these figures, we'll state that the displacement of these points forming a line will be equidistant. All throughout the realization of the complementary figures. We could then realize, such as shown in e), a double parted poly induction, in which secondary crankshafts 64, will be set up in a rotary manner on a master crankshaft 65,their crankpins being initially set up in such a way as to realize complementary forms. These subsidiary crankshafts will support the compressive parts. We'll find more details of these statements in our Russian patent poly induction energetic machines, number 200200979, may 14^{th} 2001.

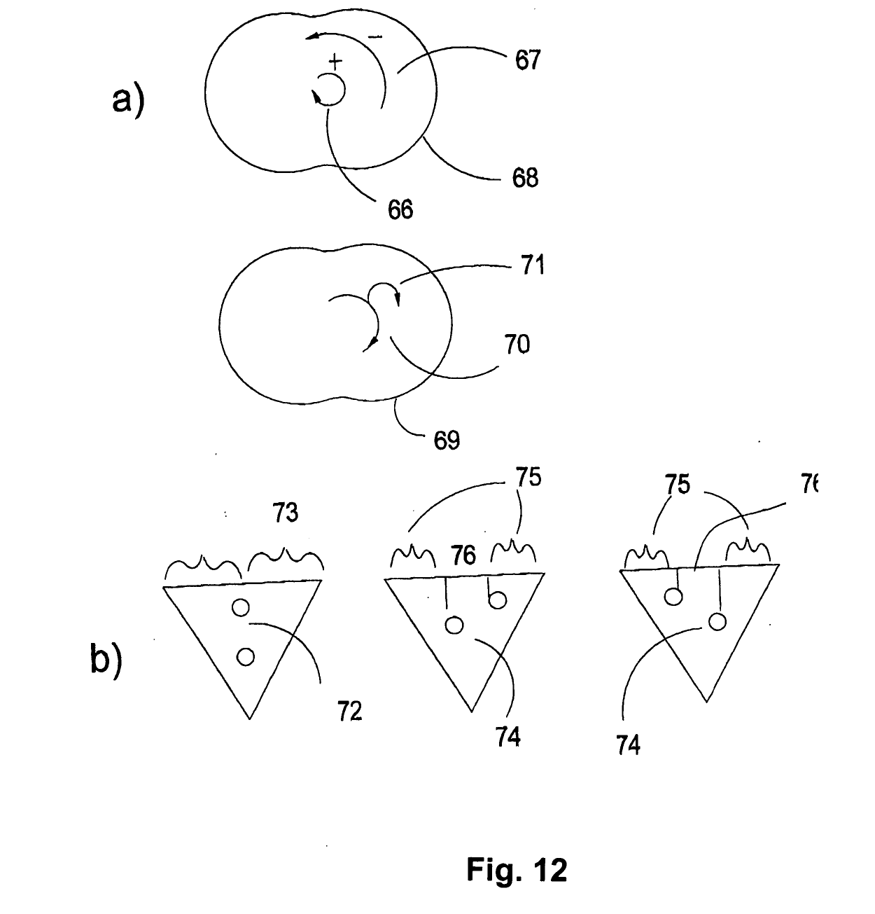

FIG. 12.1 presents, in a), that the comprehension of the geometric dynamic of the paddle realized by the poly induction is totally opposite to that of the previous art. In fact, in a 1, we see that we can express the geometric dynamic of the previous art, by saying that the form d of the desired cylinder is realized from a rapid, circular, geometric movement 66, realized by the central eccentric, and by the peripheral realization, of a circular retro rotary movement 67, realized by the paddle. The final form is thus subtractive, since the superior movement is negative, and cuts back the speed to the central movement. It is the case here of Wankle and his predecessors' first fundamental gap. In the poly induction, the dynamic realization of the projected form 69 is, in contrary, produced by a slow center movement 70, and from a rapid, accelerated peripheral movement 71. The form is thus created from the addition of these two positive movements, this being from where the machine gets its power.

In b of the same figure, we see that, whatever the position of the centers of the subsidiary crankshafts during their total elevation, the explosive push on the paddle remains, in lack of the double parted poly induction, always equally distributed. In fact, when the line constituted by the two crankshafts is perpendicular to the explosion 72, the paddle is equally divided 73. In the same way, when the crankshafts are angularly set up 74, the paddle is once again equally divided, since the anterior and posterior parts are equal 75, and that the central part is well centered 76.

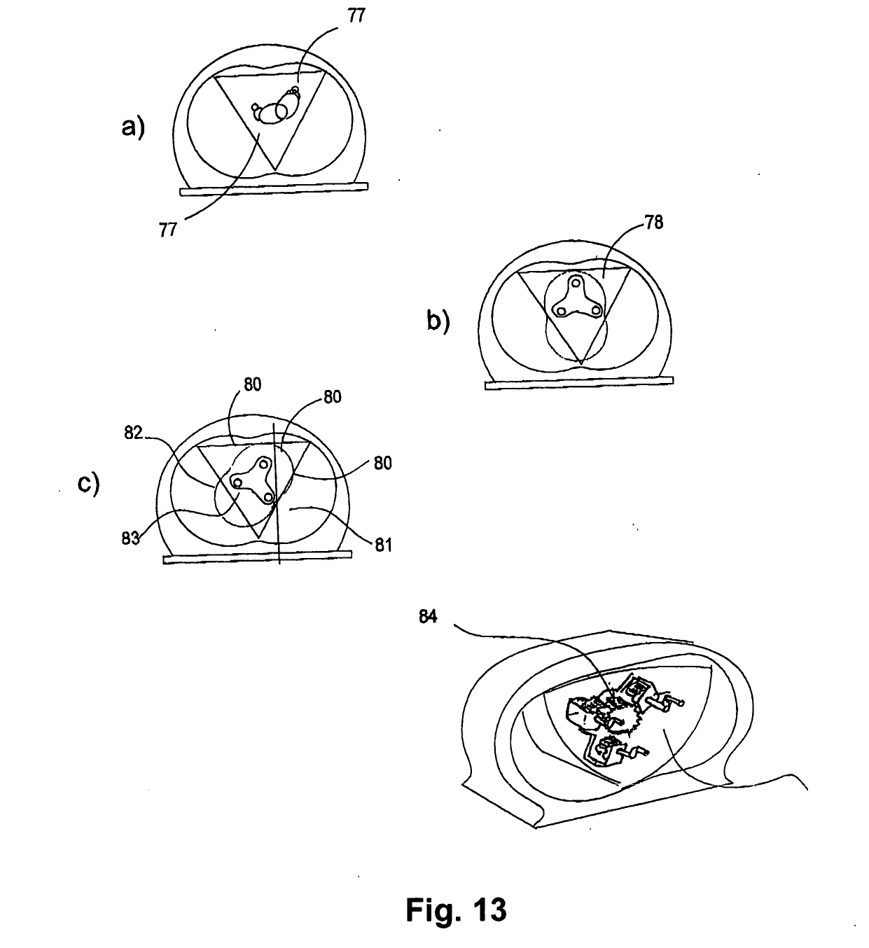

FIG. 13 shows the precisions brought by the current invention relative to the induction by poly induction. In a), we show that the poly induction can be realized by all induction, each induction being realized post rotarily. In the given example in a), the inductions of the subsidiary crankshafts are activated by hoop gear induction 77.

In the double parted poly induction, we have supported the idea that the stopping of the anterior induction in course of descent produces a descent arming. In b), we show that we can realize the poly induction in three parts, all while conserving the anchoring of descent by positioning the support points in the sides 78. Each crankshaft will therefore realize a vertical cylinder course 79.

In c, the position of the support points is both in intermediate zones 80, and in addition realized in such a way so that during the explosion, two of the crankshafts are perpendicular to the attack 81. One of the three crankshafts will always consequentially be in part subtracted from the dead point, the dead point being divided between the two perpendicular crankshafts. We must in addition note that the displacement of the crankshafts will be oblique 82 and the anchoring will be in part a descent anchoring and diagonal 83.

In d), we show that we can simultaneously realize the double and triple parted poly induction by realizing inductions alternatively. In this type of induction, we cut back, partially or totally, certain teeth of the support gear 84, or of the induction gear, in such a way so that except for the transition periods of the effective inductions, only two inductions on three will be working. Consequentially, the sloping effect around an anchoring point, specific to double parted poly induction is assured here, equally distributed for all the paddle faces. During the realization of the power, the inductions will thus be double parted, and the most negative induction will be neutralized. This induction will be activated not by the crankshafts, but by its simple attachment to the paddle.

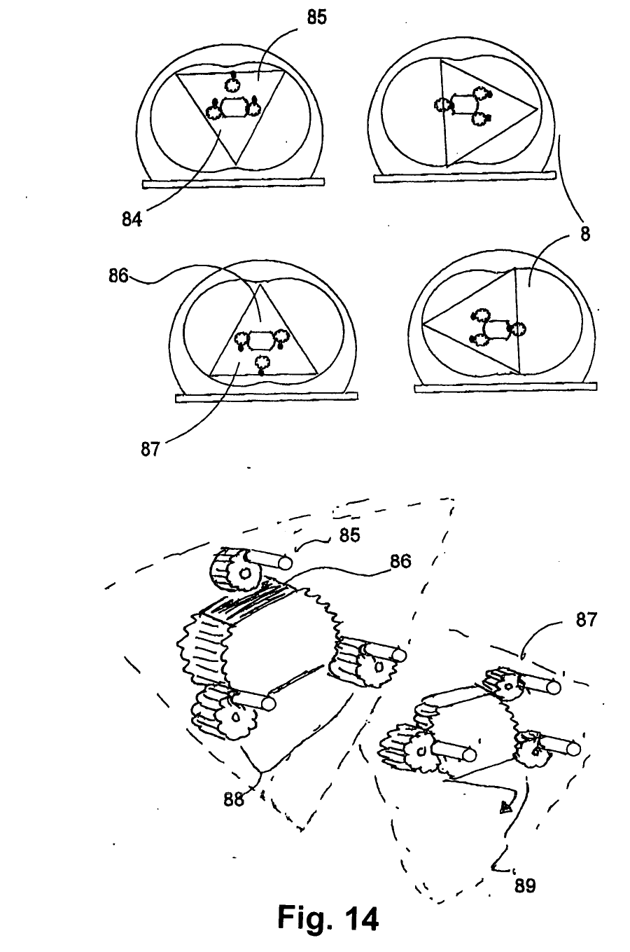

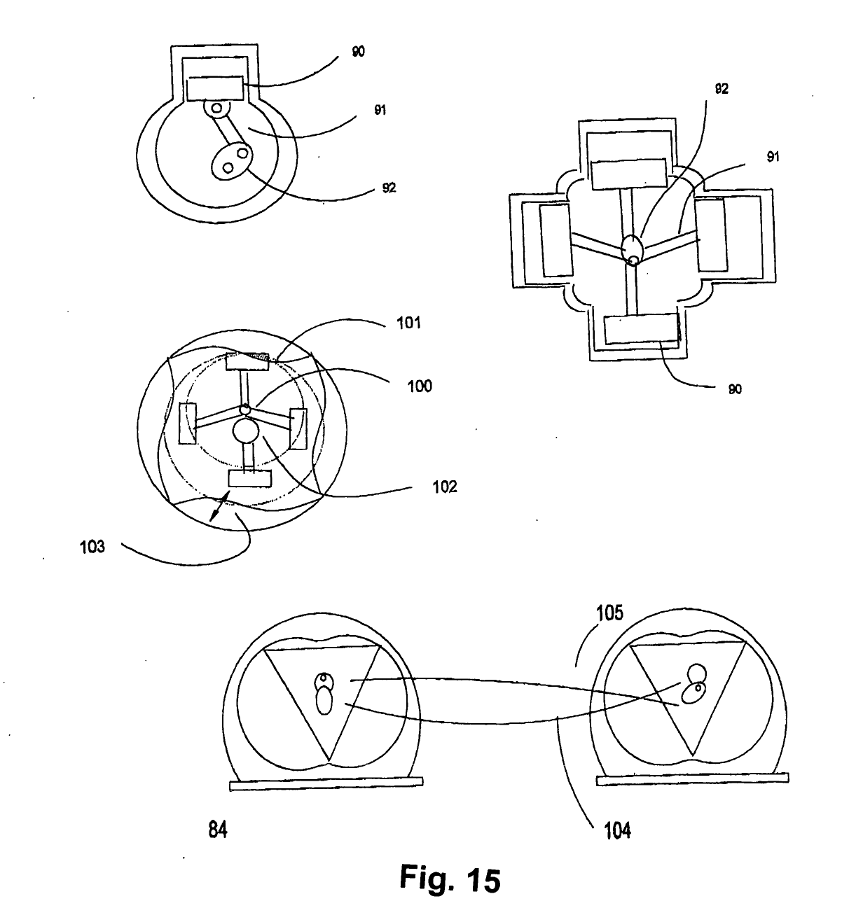

FIG. 14 shoes the dynamic for a rotation, of such an arrangement. We'll note here that the inductions have been placed in the sides of the paddles 85, but as we have said. They could be placed anywhere on the paddle. We'll in addition note that, as for all of our inductions, this type of mechanic is valid for all figure, rotivity, and for all dynamic, as for example planetary cylinder rotativo circular dynamics.

In this figure we notice that, as we have mentionned above, the teeth of the support gear have been partially cut back 86. Consequentially, except for in transitory periods 87 only two inductions work 88. Consequentially, the power is not simply issued from the rotation of one group around the other, in partial stoppage 89. Consequentially, a mega-rotation is realized around this center point, which we name descending arming, and produces mega-energy. This is what we call the Slinky movement. The interest of the current specification consists in building an identical descent for all paddle parts. We thus see, in the continuation of the figures, that there is a relay produced between the active and passive inductions.

FIG. 15 in a), shows three different piston engine dynamics. In a 1) we find the standard dynamic. In a 2), we find the orbital type dynamic and in a 3) the rotor cylinder dynamic of our Canadian patents titled Energetic machine II, to this effect. In the first dynamic, we find three constituting elements of all machine when we intend to realize under its motor form, being the compressive part 90, here realized as a piston and a cylinder, the transmittive ligature part 91, realized as a rod, and finally the mechanical part, realized as a crankshaft 92. In an orbital type dynamic, the set up of many of these systems are different since they are not on the same line, but rather set up in periphery. However, each system is complete, and comprises all the already described elements 90, 91, 92. In the rotor cylinder machine however, the crank shaft is no longer active. It has in fact been dissected, and only its crankpin is realized non-dynamically by a de centered axe fixed rigidly in the side of the machine block 100. Contrary to the orbital engine, the general cylinder of this machine is realized in a rotary manner 101 around a central axe 102. Pistons and cylinders therefore traverse different circumferences 103, which assure expansions and compressions.

From the point of view of the constitution of elements, we see that the realization of the crankshaft of the previous examples has been done confoundedly with another element, here, the cylinder. There was consequentially a deportation of its central position which results in a great energy loss.

In c) of the same figure, we see the layering dynamic which we have produced in the first part of the current invention. We see here that the paddle is not set up on a central crankshaft, but rather on a layering of the crankshaft in which the second plays the role of the rotary rod.

The group of these examples, in addition of already commented poly induction examples in the previous figures, bring us to point the finger to Wankle and his predecessors' second fundamental gap, which consists in having without their knowledge, displaced the subsidiary crankshaft from the periphery towards the center, and to have realized the central crankshaft, as in the example mentioned above, confoundedly with a peripheral element, being the paddle, which consists of the second fundamental gap of these machines.

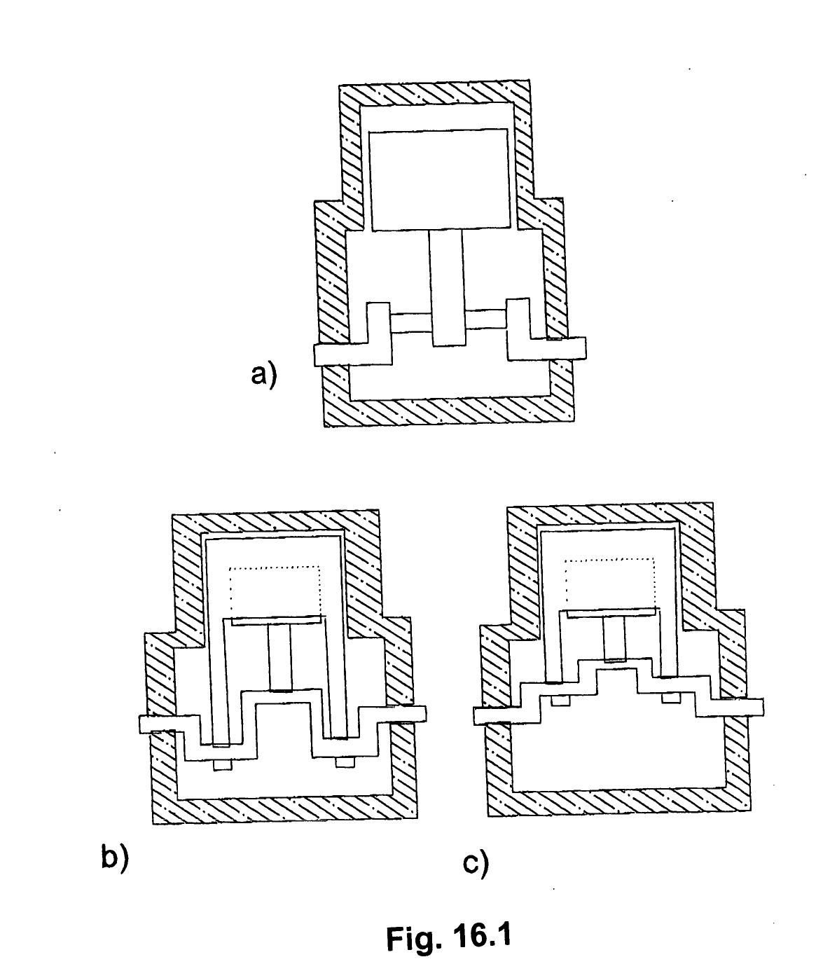

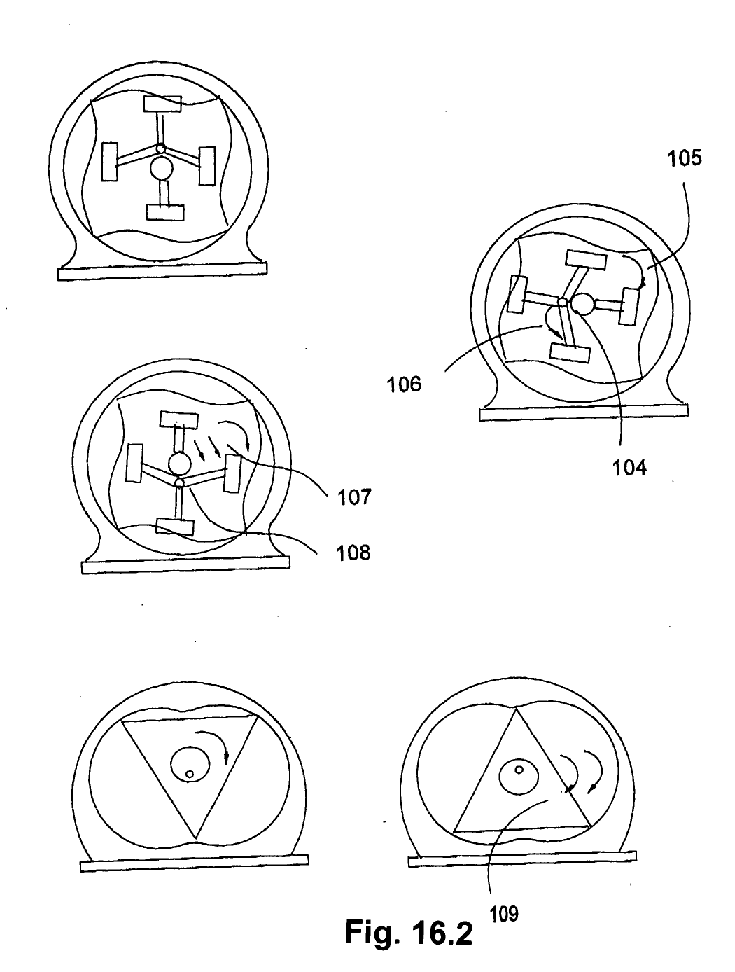

FIG. 16.1 shows how, from standard piston machines, in a) we can produce between two compressive dynamic parts, here, two pistons, contrario actions in b), and in same direction in c). To realize contrario machines, we use, coupled to pistons set up one in the other, a crankshaft in which the crankpin reach will be located in opposite parts. We'll thus obtain an opposite action of the pistons in relation of one to the other. Inversely, if we set up crankpins in the same quadrant and this with different reach lengths, such as shown in c), we'll simply realize a differential action between the pistons.

FIG. 16.2 shows, from examples of rotor cylinder piston machines, how we can grasp the third fundamental gap of the previous art, this time, dynamically. As we have seen in the example of the rotor cylinder machine mentioned above, we have completely subtracted the action of the crankshaft. In our patent application, simple induction machine, we have shown that we can re-instigate it, either retro or post rotarily and thus produce expansions and compressions at a rythm superior by one per rotation per cylinder.

In a of the current figure, we thus find the base set up, without exposed crankshaft dynamic. In b, of the same figure, we suppose that the crankshaft 104 is re inserted in the figure, all while conserving the rotary movement of the cylinder 105. We suppose that the crankshaft acts retro rotationally 106. We will thus state that a more rapid expansion of the compressive parts, and a contrario action of the mechanical parts which will increase the power of the machine. In c), of the same figure, we suppose that the cylinder has closed chambers. In addition, we suppose, in contrary, that the crankshaft is lead in the same direction of that of the cylinder, and in addition, at an accelerated speed 107, which will also produce expansions and compressions. We'll thus state that when the crankshaft acts more rapidly and rejoins the next expansion 108, as in the rotary engine, it rejoins the next face 109.

We'll note that contrarily to be but contrario, this dynamic is only differential, since the force on the crankshaft constructs itself consequentially by applying itself to one peice from another peice. This constitutes very clearly the third of Wankle's fundamental gaps, which consist in having realized a simply differential action between the crankshaft and the paddle. As we have already shown, the bi rotary mechanics, by layering inductions and by poly induction do not realize these gaps. In the next figures, we'll show that the bi rotary mechanic by Clockwise movement compressive parts also realize machines without the three fundamental gaps.

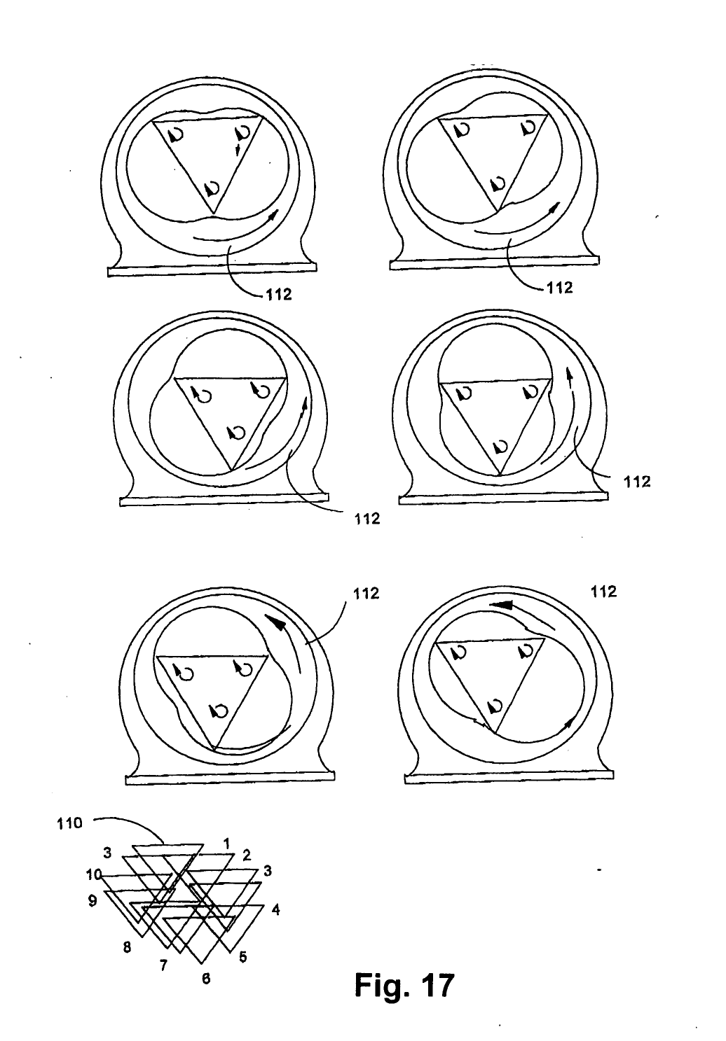

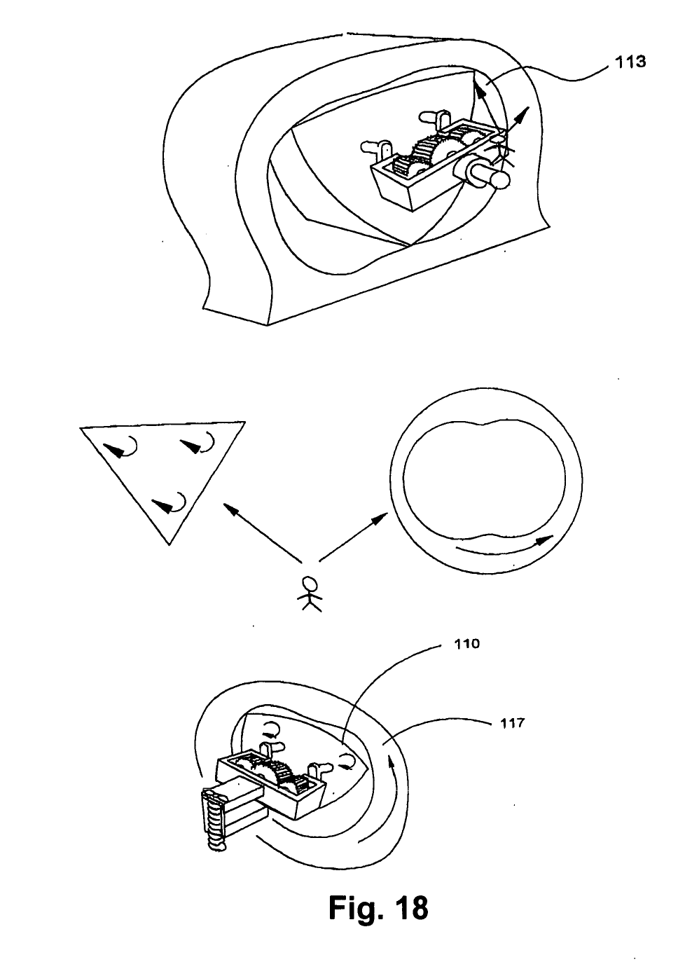

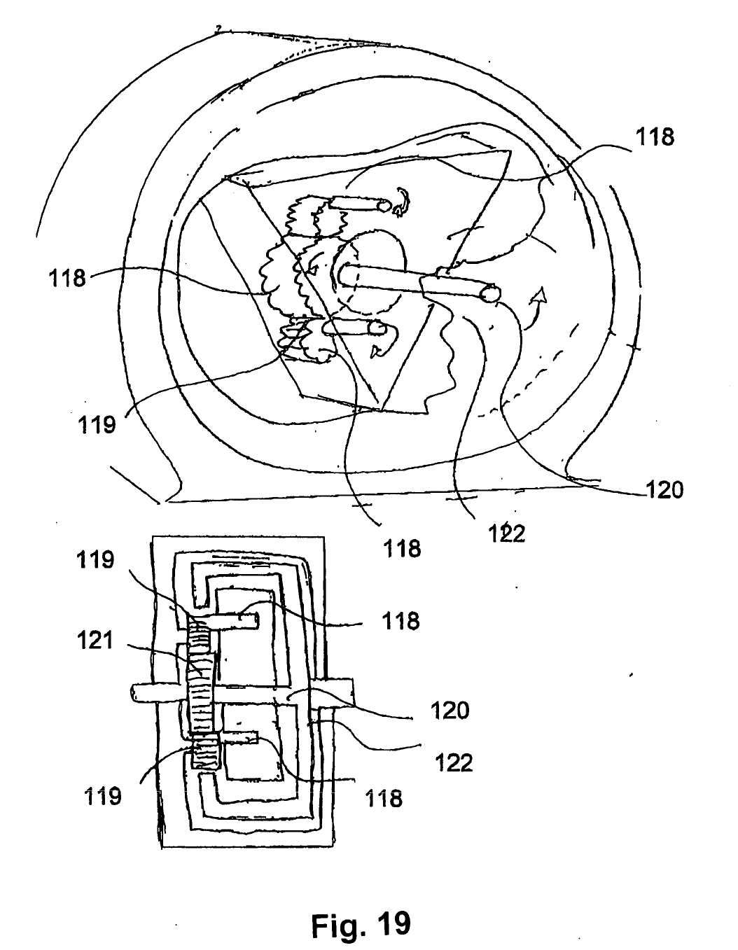

FIG. 17 is a reminder of the clockwise dynamic 110 of a machine with a post rotary figuration with a three sided paddle, and a two sided cylinder. In this dynamic we suppose a very specific paddle movement, so that it's orientational aspect remains unchanged, observed from the exterior, during its center's rotation, and that consequentially, as for the hands on a clock, in spite of the movement of the hands, the orientation of the numbers do not change. This is why we have named it clockwise movement.

In a machine, if we realize a paddle with this type of movement, we'll need to realize the cylinder in a rotary manner 112, and in the most specific case of post rotary machines, contrario to the circular movement of the paddle's center.

FIG. 1b shows by which observation we can state the clockwise movement. We have named this observation, observation from the master crankshaft of poly inductive machines. This type of observation was obviously not possible for the inventors of the previous art. In this type of observation, we suppose an observer set up on the master crankshaft 113 of a poly induction machine. This crankshaft, as for its stability framework, will be able to state what follows. Firstly, they will observe the clockwise movement of the paddles which it observes, and that each part of it realizes a strictly circular movement, and non rotary 114. Secondly, when they will observe the cylinder, it will not be for him, as for a fixed exterior observer, but rather in movement, and read specifically in inverse movement of the paddle's clockwise movement 115.

We can once again realize, mechanically and constructively the rotativo circular clockwise movement by clutching in a vice 115 the master crankshaft of a poly inductive machine by activating the rest of the machine. Consequentially, in fact, if we make the whole rotate, we'll state that the subsidiary crankshafts can still be activated and consequentially produce the clockwise movement of the paddle 116, and that the support gear, non-dynamic beforehand, will activate itself, leading with it the rotation of the cylinder 117. We could then by this stratagem observe from the outside a perfectly rotativo-circular machine with a clockwise paddle type.

FIG. 19b shows, by deduction of the previous experience, the base mechanic serving to realize concretely the support of the machine in clockwise movement. It is the case of a poly induction, so to speak, dynamically inversed. We install simply in a rotary manner two subsidiary crankshafts 118 provided with confounded support and induction gears 119 in the side of the machine. We install the paddle 119 on these crankshaft's crankpins. We then set up in a rotary manner in the machine a machine axe 120 to which we'll fix a link reuniting the crankshaft's gear 121 and the cylinder 122. The clockwise paddle movement will thus lead a retro rotation of the central gear and, consequentially, the cylinder.

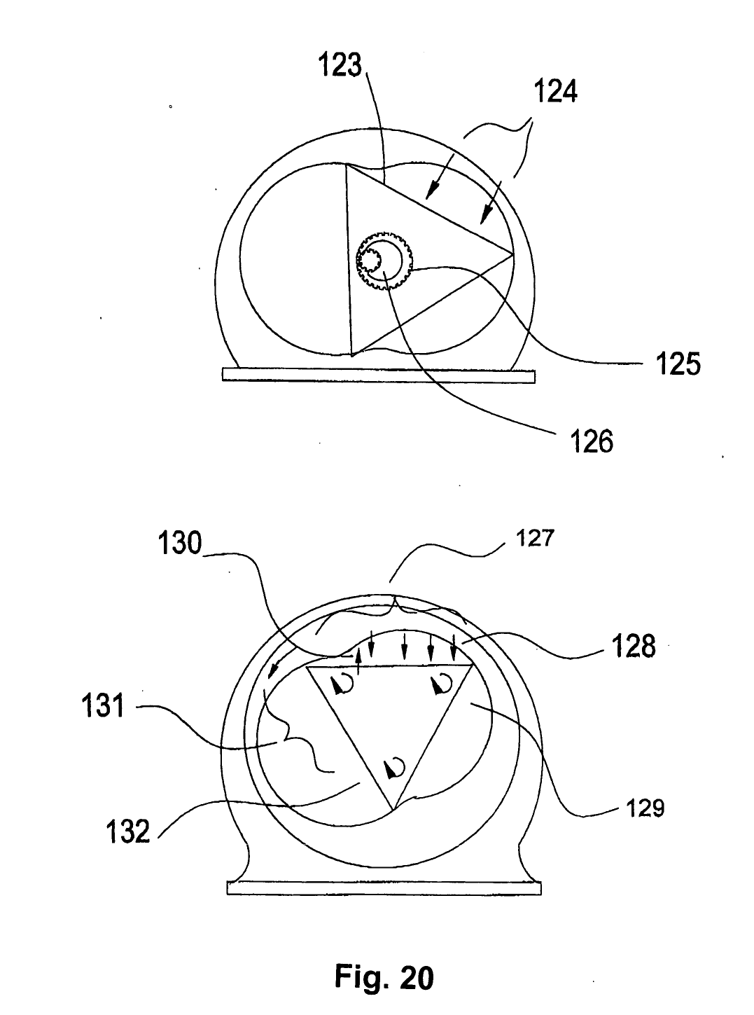

FIG. 20 summarized reminds us of the mechanical difficulties and weaknesses of standard rotary machines, consequential to the pre-enounced gaps in a), and shows that all these difficulties and gaps are overcome in the clockwise setup. The theoretical gaps mentioned above result in fact in very real difficulties in which the main are the following:
a) A negative counter force on the back part of the paddle in course of descent 123
b) An unequal speed of systemic deconstruction 124
c) An overcommanding of the crankshaft, a third of paddle rotation, requiring a whole rotation 125
d) An increased de-rotation friction of the paddle on its crankshaft 126, caused by the use of an eccentric.

In summary, thus, the paddle doesn't work positively on but a part of its length, and this work remains unequally distributed. In addition, this work realizes a work in which the resulting force is reduced by the speed of the crankshaft and the great friction. The machine is very uneffective. In clockwise paddle/rotary cylinder dynamics, all these gaps are cut back and replaced by qualities.

Let us note:
a) A power on the whole length of the paddle 127
b) A decreasing descent speed equal in all points 128
c) A notable decreasing of the overcommanding of the crankshaft: a number of three explosions per rotation of the crankshaft in opposition to two 129
d) A rod effect recovered by the turbinic push on the cylinder 130
e) A systemic contrario deconstruction between the cylinder and the paddle 131
f) The absence of all acceleration and deceleration of any piece 132
g) The rotary cylinder could be provided with a paddle and assures cooling and realises dynamic light valves for the machine.

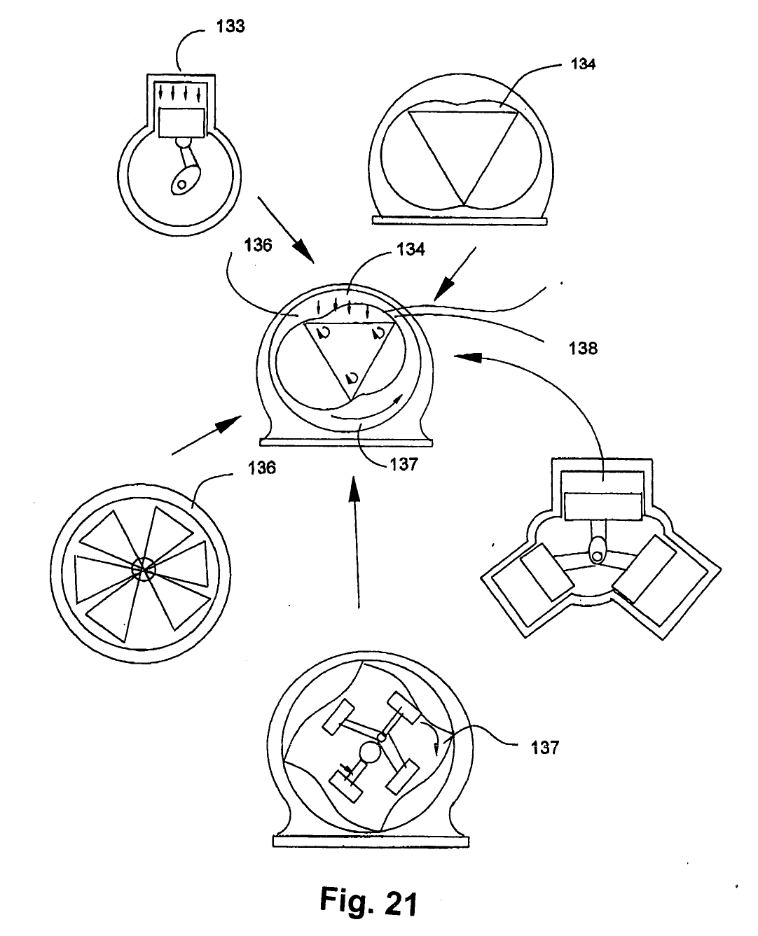

FIG. 21 shows that the clockwise dynamic is located halfway between standard piston, rotary, orbital and turbine and with rotor cylinder dynamics. This is why we have named these machines rotativo-circular, or even rotativo-turbinic, or finally rotativo orbital.

Firstly, let us note that rotativo circular with clockwise paddle machines have a frank and equal push on the paddle, not only similar, but equal to that of piston engines 133. Then, we must say that these machines take their geometric figuration from rotary machines of the previous art 134. We must then add that these machines, unless we produce them intentionally with polycammed gears, have, like turbines, no acceleration or deceleration of the mechanical or compressive pieces 136. Then, as in contrario rotor cylinder piston machines, the combination of inductions has been done with the crankshaft set up horizontally, which implies that the crankshaft has not been placed in periphery, but centrally but also that the parts are contrario 137. Finally, the descent of the piston is vertical enough and in periphery, and reminds us of that of single paddled orbital engines 138.

It is almost true to say that this new machine possesses the qualities of all these machines reunited without possessing their respective faults.

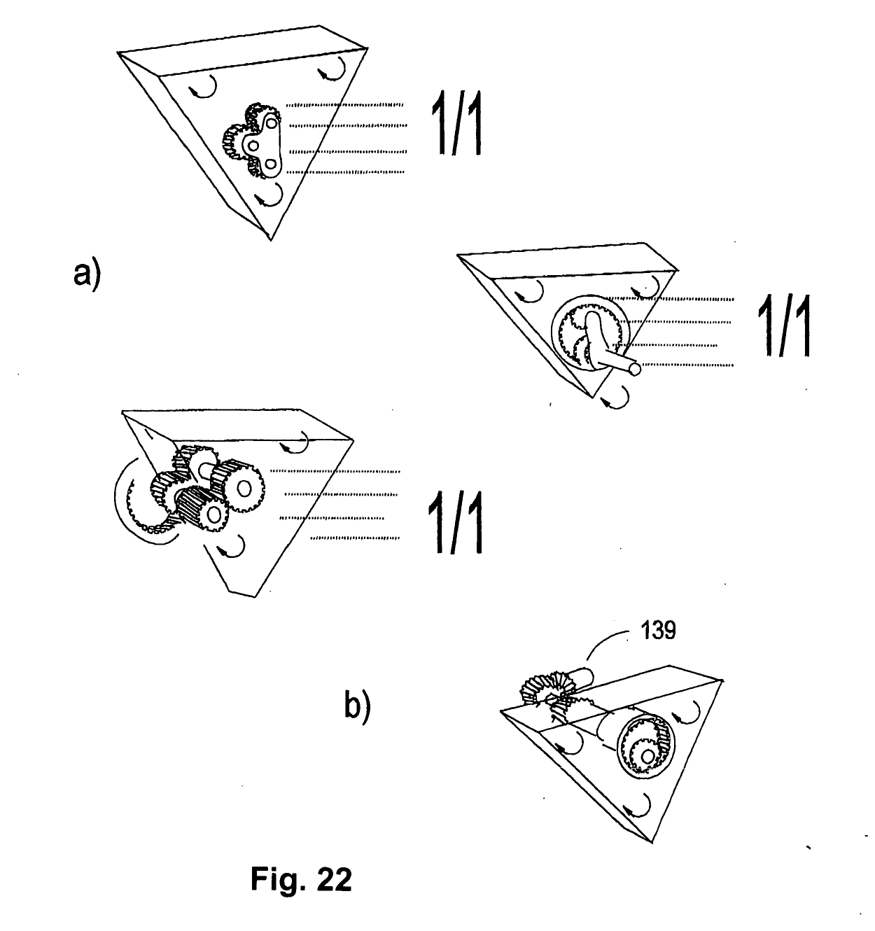

FIG. 22 shows that all first degree induction obtained by observation on the crankshaft, if it is realized in a one to one support gear to induction gear ratio, can result in the clockwise guidance of the paddle by the center. In a1, a2, a3, we find respectively first degree inductions by intermediate gear, by hoop gear, by heel gear, all set up with one to one gear ratios. This gear ratio shows well, in addition of the perfectly equal action on each part of the paddle, the bi rotary aspect of clockwise paddle machines, aspect which we find, under other figurative forms, but in poly turbines and in rectilinear rod engines.

In 22 b, we show that the mono inductions or inductions by poly inductions must, as all induction in which we wouldn't have changed the gear ratio, be realized semi transmittively 139, in such a way as to cut back their retro rotary propension, being post rotary.

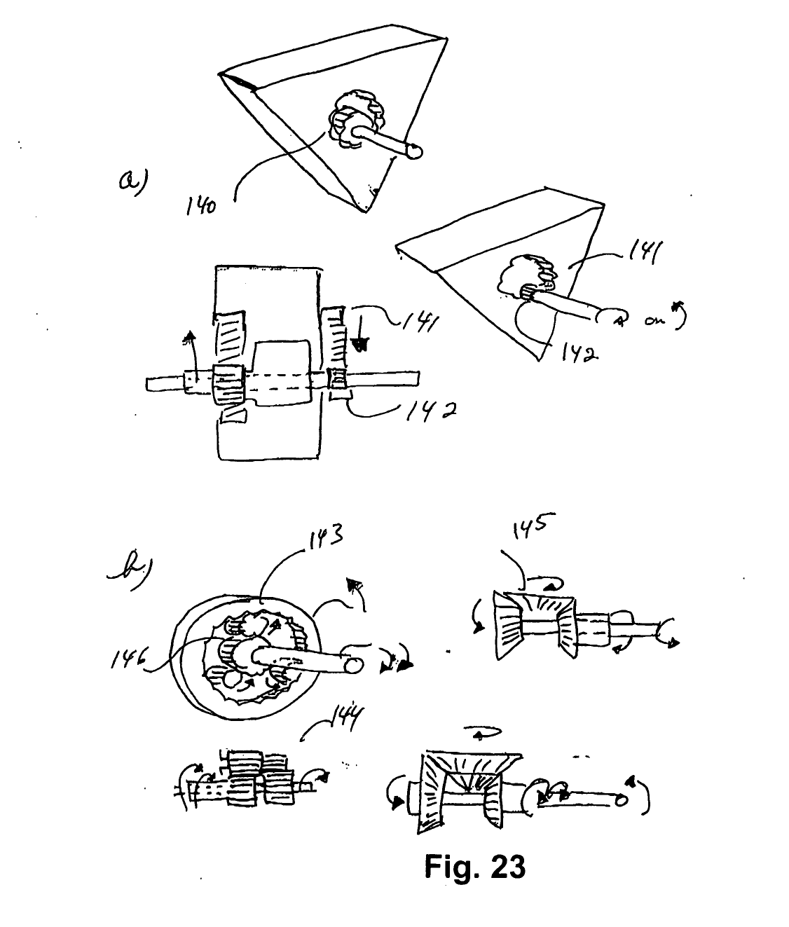

FIG. 23 a) differentiates ascending and descending inductions. The ascending inductions are of standard first degree, or even such as we have seen in the layering of inductions, the peripheral induction, allowing to assure the orientational support of the paddle. As we can state here, in 140, we have an ascending induction of mono inductive type. We define an induction as descending when it [passes] contrario to a peripheral element to activate an inferior or central element. In these cases, it's the superior support gear, usually the paddle's, which becomes the induction support gear 141, whereas the inferior gear, more often of the central axe is the induction gear 142 of this axe and the elements, usually the cylinder which are attached to it. In the current figure, in the goal to simplify, the descending induction is also a mono induction induction, but this could be a poly induction, an induction by hoop gear or any other induction.

FIG. 23 b 1) summarizes the two main types of semi transmission, accelero-decelerative, and in b 2 shows how to realize them confoundedly.

We can realize the acceleration or the deceleration of parts by semi transmission realized with the aid of an internal and external gear 143, or even by the coupling of two gears to a double gear 144 of different sizes. In addition, we can realize the inversion either by pinion gears 145, or either by combination of external gears 146.

As these two mechanical actions will frequently be necessary in rotativo-circular machines, we'll have interest to realize these semi transmissions inverso-accelerative in a confounded manner, such as in b1, or even in b2.

FIG. 24 summarizes the three main methods of support for rotativo circular machines. We can consider that rotativo circular machines are the horizontalized expression of layered support machines, already presented by ourselves. Consequentially, we'll always need, to realize them, two combined inductions, which very often are of semi transmittive type. We therefore define semi transmissions as inductions transferred onto themselves, from center to center. One will have understood, given the number of first degree inductions which we have furnished, and the number of semi tranmittive inductions, which the possible permutations are vast and can't be presented here. This is why we'll give the generative combination rules of these inductions.

The logic of these rules is the following. One understands that one of these inductions will control the rotation of the cylinder and the other the clockwise or planetary movement of the paddle, and that consequentially these two inductions must be perfectly synchronized. They must therefore communicate by a third element, allowing the coordination. The ascending, descending or semi transmission support methods could therefore be realized by a common part, either by the paddle, the crankshaft, the support gear. In part a) of the current figure, we find an example of the first type of combination. By one side, the paddle is supported by a method by hoop gear, of the ratio of one to one, assuring the clockwise movement. In addition, on its second face, it is provided with a descending induction assuring the rotation of the cylinder axe. The two systems are therefore combined by the paddle.

In b of the same figure, the induction of the paddle is realized by an intermediate gear induction. It communicates with the crankshaft and, in addition, from this same element, we attach a semi transmission which will rotarily activate the cylinder. Paddle and cylinder will therefore be converging because they are coupled to this same element which is the crankshaft.

In c of the same figure, the elements will now be connected by a same gear, which will serve as dynamic support gear to the paddle and induction gear or axe to the cylinder. In fact, we can see that the paddle is activated by a semi transmitive mechanic, and that its support gear is dynamic. In addition, if we realize the retro rotation of the cylinder, from the crankshaft, we can use an inversed semi transmission, realized totally confounded with the first, which allows us to say that the cylinder gear is an induction cylinder, is the same gear as the dynamic paddle gear.

We now understand better the interest of the poly induction set up presented in our first assembly figures. In this realization, the ascending paddle induction is exactly the same, in opposite direction of the semi transmittive induction and inverses the cylinder, which limits strongly the number of parts. We'll find, at the very end of the current exposition, other combination examples which all respect the same associate fund ideas, knowing that the inductive parts are necessarily connected by one or another of the mechanical parts of the machine, paddle, crankshaft, or support gear.

FIG. 25 specifies the contrario and same direction movements for clockwise movement/rotary cylinder machines, both retro and post rotary. In addition, it shows that clockwise paddle movement machines are realizable for all machine figure.

In a) we have a post rotary machine figuration, with a three sided paddle and two sided cylinder.

In b), we find the triangular retro rotary machine. We note that in the case of the retro rotary machines, the cylinder remains completely rotary, but works in the same direction as the clockwise paddle movement.

Figure c) shows a clockwise paddle movement of four sides and a three sided contrario rotary cylinder

Figure d) shows a three sided clockwise paddle movement machine, but with a four sided cylinder, and consequentially, of retro rotary figuration. Cylinder and paddle therefore working in the same direction.

In e), we notice a five sided clockwise paddle movement post rotary, and a cylinder in contrario movement, of four sides.

In f), a retro rotary figure with movements in the same direction, with clockwise, four sided paddle, and five sided cylinder.

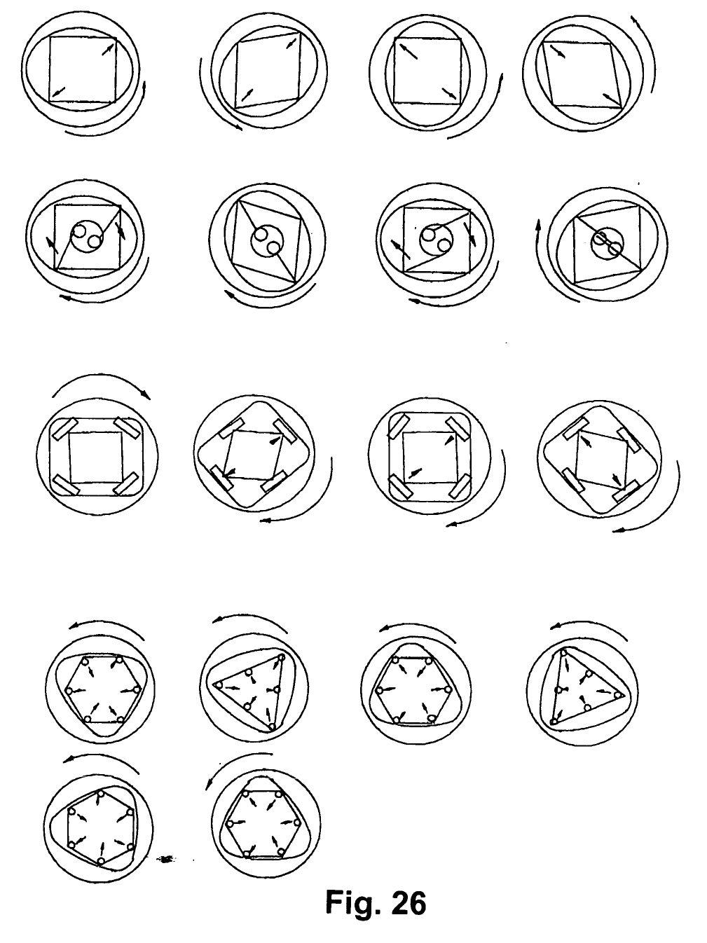

FIG. 26 specifies that even birotary type machines, as for example polyturbines in a and in b Quasiturbines, in c) are realizable in the same manner as a rotativo circular machine. In d), we also see that these machines are also realizable for all number of sides. Here the rotativo circular poly turbine has a six sided paddle structure in a triangular rotary cylinder.

In addition, if we observe the sequences present in a and b, we'll note that, as for standard machines, various rotivity levels can intervene for a same machine. In a), the paddle structure isn't rotary, it simply realizes its rhombuso-squaroid aspect alternatively, and is completed by the rotation of the cylinder.

In b, we'll note that the two crankshafts supporting the paddle structure are strictly rotary, which forces the realization of the alternative rhombuso-squaroid passage of the paddle structure to realize itself across a certain rotation, however, non-planetary. This rotation is completed by the rotation of the cylinder.

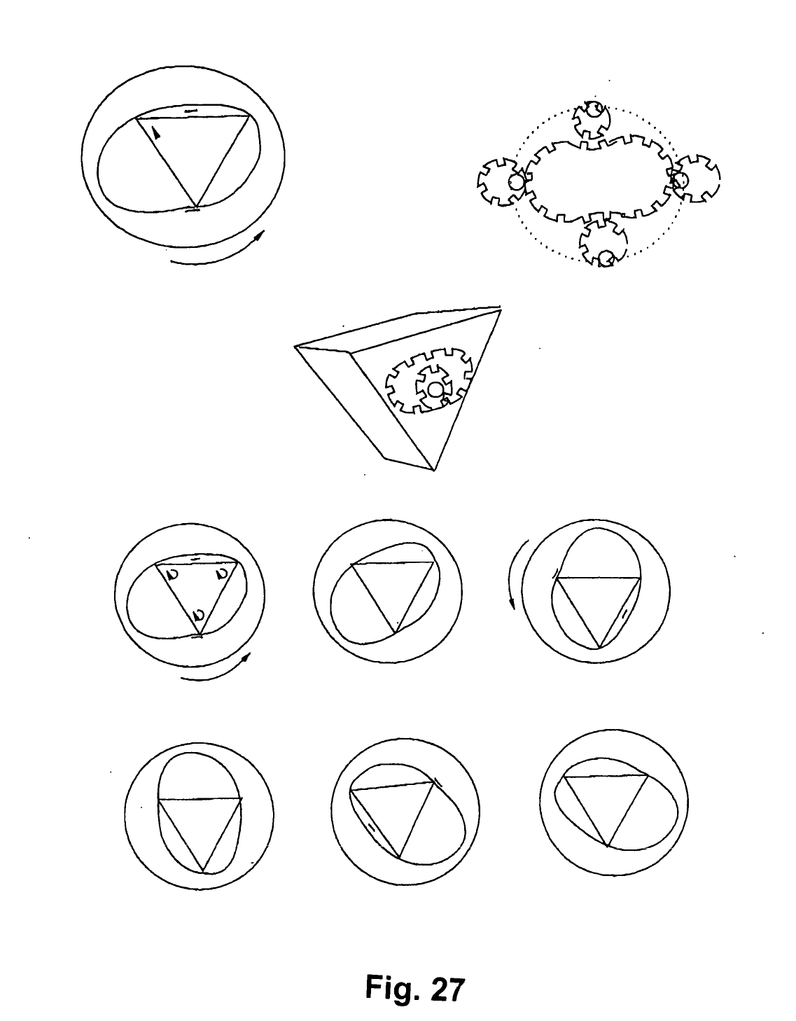

FIG. 27 shows that the rotativo-circular dynamics can also, from already commented correction mechanics, notably by the use of polycammed gears, for standard machines, be realized accelero/deceleratively. In these cases the curves of the cylinders will be modified.

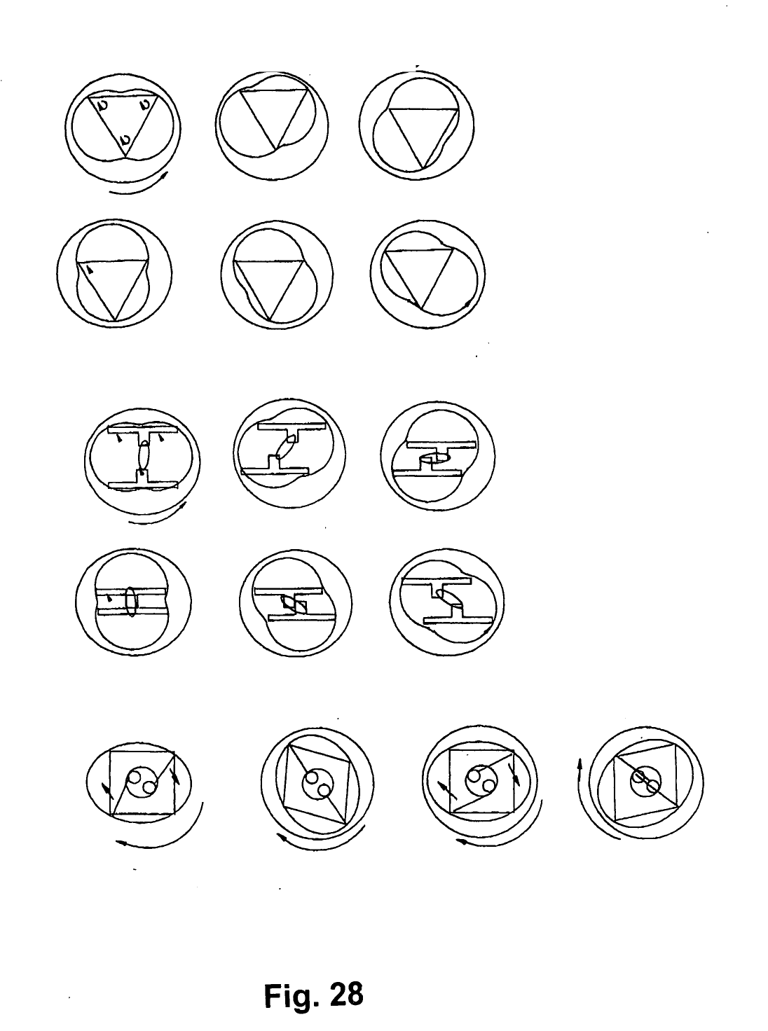

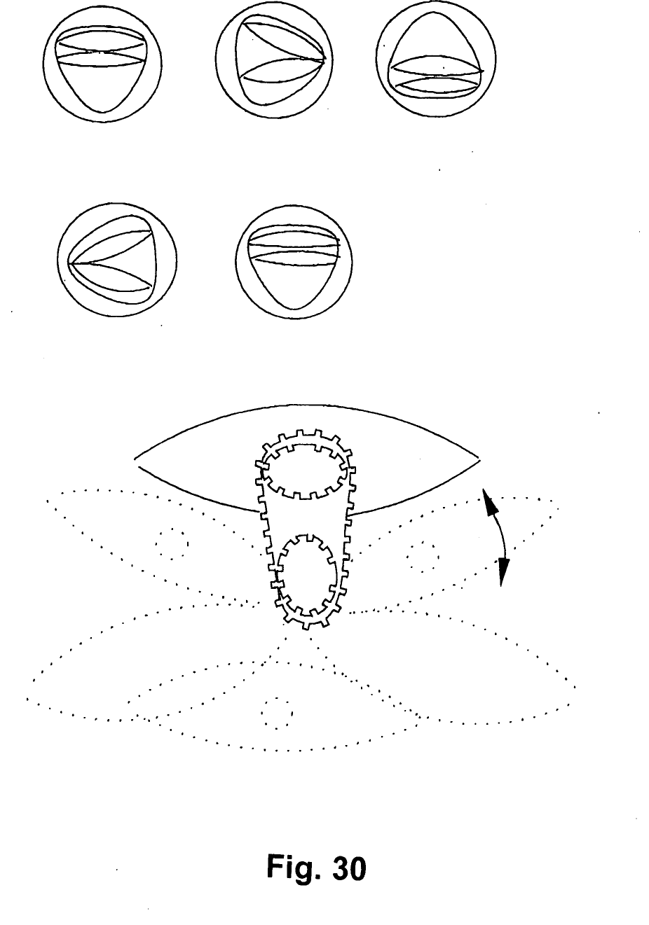

FIG. 28 shows that rotativo circular machines can be realized with different types of paddles. In a), we find standard paddle figures.

In b, the compressive structure is constituted of unitary paddles with clockwise movement acting in combination with the cylinder to create compressions between them and the exterior, or even between them and the cylinder in the center of the machine. In the later case, the compression realized by this group will be the double of the normal compressions and the machine could consequentially establish a diesel gas management.

In c), we simply remind that the compression structure can also be a paddle structure, as shown in the previous figures.

FIG. 29 recalls our first dynamics to this subject and shows that clockwise paddle movement machines can have various degrees.

In a), the paddle without orientational action, and which consequentially has a clockwise movement, its positional action being circular. In b), the paddle has a clockwise orientational action and rectilinear positional action. In c), it has a clockwise orientational action and quasi trangular positional action. And finally, in d), its orientational action remains clockwise, but its positional action, since the crankshaft is longer, is coupled not to a simply rotary action of the cylinder, but to a planetary cylinder action.

All these machines are consequentially a same generation of machine, sometimes increased of degrees by rectilinization, geometrization, or like here, by triangularization of the positional course of the paddle, such as in b and c, sometimes by an increasing of the degree of the cylinder.

The group of these various degree dynamics shows well that rotativo circular machines form a category of machines having generative characteristics which are particular to them. In all cases, the master crankshaft is confounded with the cylinder.

In FIG. 30, we show that the polycamation of the induction or support gears can be realized not to accelerate and decelerate the positional movement of the paddle, but to modify alternatively the orientational movement of the paddle, making it thus oscillatory clockwise. This is possible by a relation of support and induction gears all in a ratio of one to one but this time, of poly cammed nature.

In addition, in this figure, we show that we can by groups of unitary paddles realize the compression of cylinder machines with an odd number of sides. Here, when one of the paddles is in compression, the other will be in depression. We'll also notice the contrary oscillatory action of the paddles.

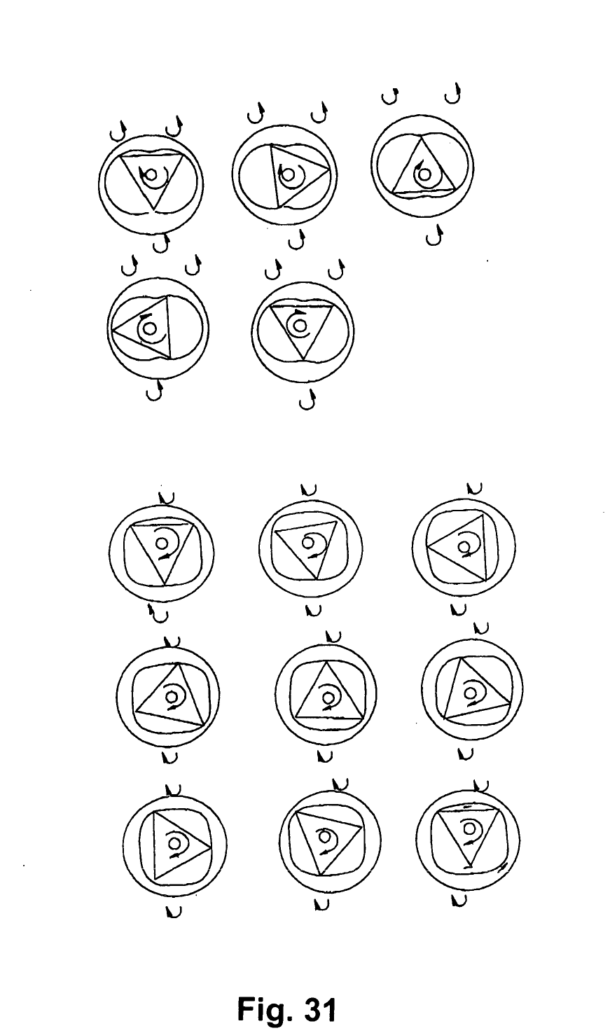

FIG. 31 shows that as for standard machines, we can realize the machine with an inversion of the dynamic of the compressive parts in center and periphery. In consequence, here it will be the cylinder in clockwise movement and the paddle in rotary movement. It is to be noted that, as we will show more abundantly at the end of the current invention, the orientation of the parts will be complementary and that the mechanic will be that of the material counter part. A second consequence of this inversion will consists in what that the post rotary figures thus produced, in addition of, requiring retro rotary mechanics, will realize dynamics in the same direction, whereas retro rotary figures, such as shown in b), will realize contrario dynamics.

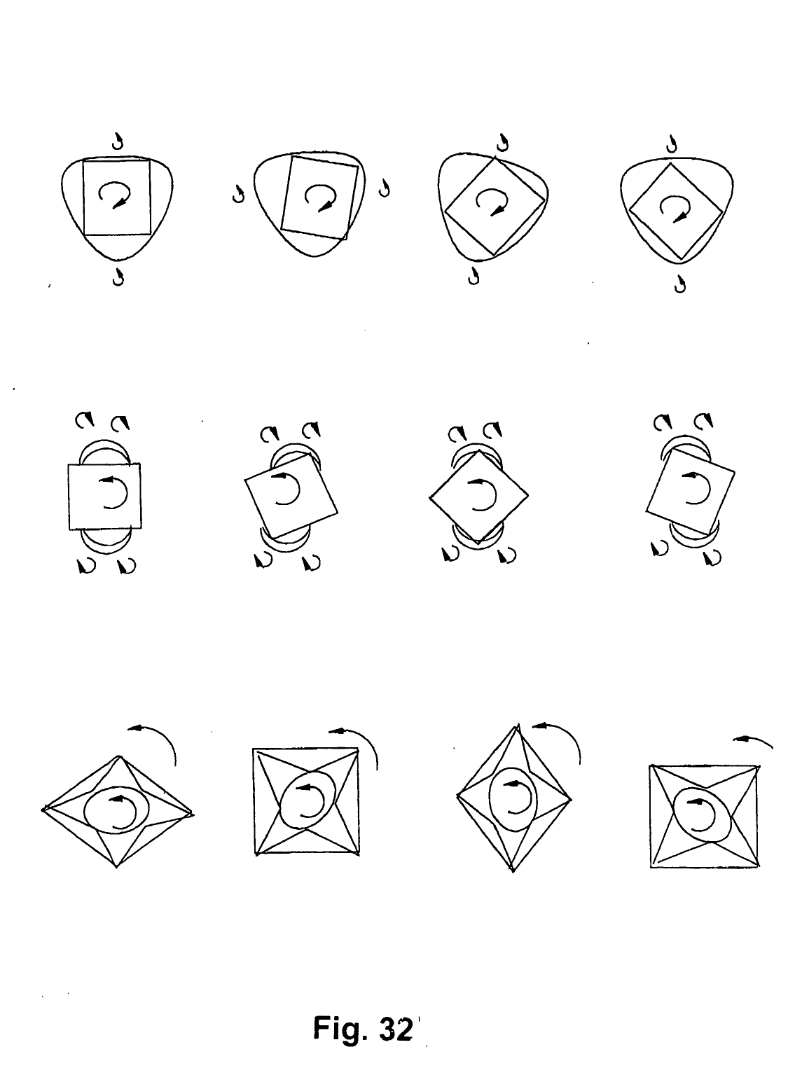

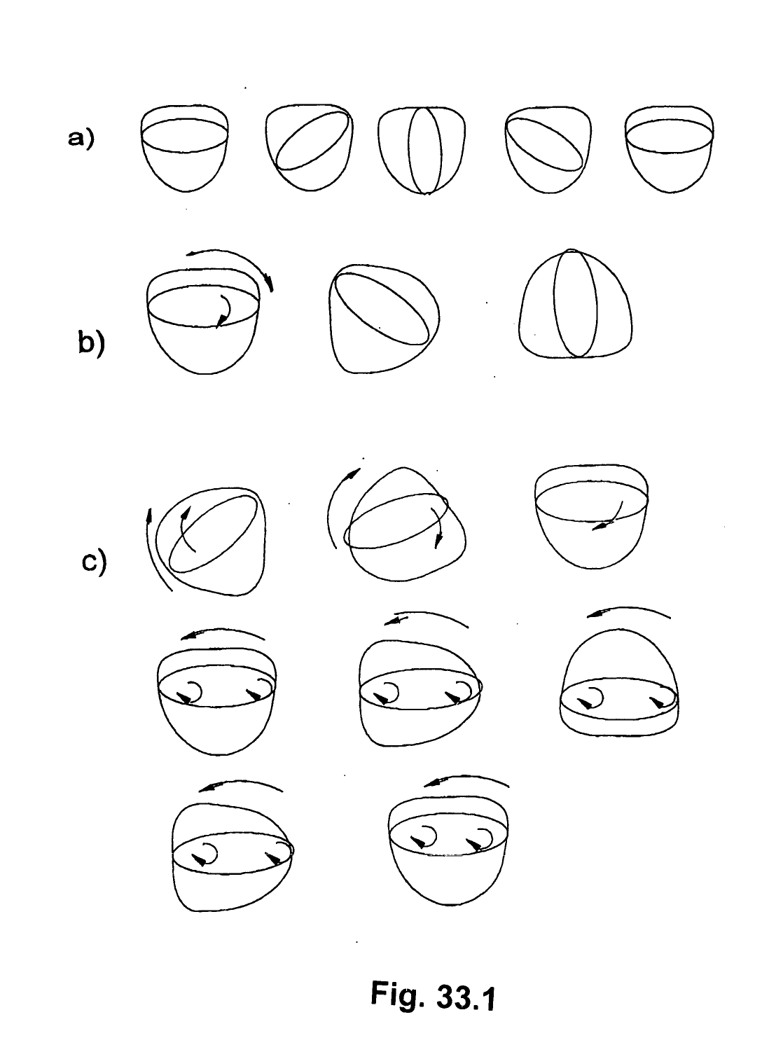

FIG. 32 shows that even inversedly, the cylinder can, like the paddle, be in a single multifaced piece in a), in many uni faced peices in b), and in external paddle structure in c).

FIG. 33.1 shows the three dynamics by planetary paddle/fixed cylinder in a, rotary paddle/cylinder in b, and clockwise paddle/rotary cylinder in c.

FIG. 33.2 shows that we can go even further by varying the dynamics in such a way as to realize explosions and expansions in different locations of the two previous figures. In a), we have a standard two-sided paddle dynamic, and a cylinder with one.

In b), the paddle of this machine however doesn't realize a clockwise movement. Here the explosion takes place in three different locations b1, b2, b3 and not at a single one, as in the standard dynamic.

Inversely, in b), the figure shows that we can suppose, for a same type of figure, a slower retro rotary movement of the paddle than in b, but faster than in a) a post rotary movement of the cylinder allowing to fulfill this alteration. The explosion will take place here in c1 and c3.

Finally, in c), we suppose the fixed cylinder mechanic, where the realized force is neutral.

FIG. 30 shows other examples, this time with a three sided paddle and a two sided cylinder, from the rule which we'll name, rational counterpart rule.

FIG. 33.3 shows for a same material figure of a three sided paddle, two sided cylinder, such as shown in a) of the differential anterior dynamic in b, of the differential posterior dynamics in c. In a, the moment of the explosion is in a 1. In b, the successive explosions are in b1, b2, b3, b4 and in c, c1, c2, c3, c4. We'll note in b, as in c, that the cylinder is displaced in the same direction as the paddle, one retro rotarily and the other post rotarily, and this is why we'll call these dynamics of compressive type. This is why we'll say that the machine produces a differential force only between its parts. However, as, the location of the next compression passes that of the next standard compression, we'll say that this machine is differential posterior.

Group of Figures Relative to Rotativo Circular or Rotativo Orbital Machines

FIG. 33.4 shows that another dynamic is possible, and that this dynamic allows the realization of a contrario movement of the cylinder and of the compressive part, such as we have previously shown for rotor cylinder machines. Each figure corresponds to the succession of the compressions of the machine. We'll note in fact that in this figure a planetary post rotary movement of the paddle and a retro rotary cylinder movement, and that consequentially, these two parts realize a movement which is said Motor, or contrario.

FIG. 34 shows what we'll call the rule of cylindrical counter-part. This rule shows how all the different appearance mechanics are comprehensible from a same logic. This rule can be enounced in the following way: for all machine of a given number of sides, there exists, during its standard realization with planetary paddle and fixed cylinder, a number of degrees of rotation of the eccentric for each area of the new expansion. All alteration in diminishing of this number of degrees will have to be compensated in counter part by a rotation or retro rotation of the cylinder. In other terms, the cylinder will itself have to be found, in relation to the paddle, in a position identical to that which it would have had without these alterations.

Let us give an example. We know that the explosion in a standard three sided paddle and two sided cylinder machine will happen after one hundred and eighty degrees of crankshaft rotation. Thus, if we determine that the next explosion will occur at one hundred and twenty degrees only, we'll need to calculate the difference of the angles corresponding to the standard explosion and that of the new projected explosion. We arrive here at sixty degrees less. We'll therefore have to effectuate a mechanical regularization and imprint to the cylinder a retro rotation of sixty degrees. If we thus realize the continuation of the explosion, we arrive to the clockwise movement.

FIG. 35 shows that this counter part rule is general, and is applicable no matter what the location of the new projected explosion. For example in a), the location of the new projected explosion is at one hundred degrees, being eighty degrees less than the standard location. The mechanical regularization will therefore be to imprint to the cylinder a retro rotation of eighty degrees.

In b) the projected area of the new compression is at 270 degrees, being ninety degrees more than the standard location. The regularization rule will enact a correction of the cylinder's dynamic by imprinting to it a post rotation of ninety degrees.

FIG. 35.4 gives a first example of a more complete dynamic allowing to make appear these figures which we'll name, by opposition to material figures, virtual figures. In the first case, the real figure is of post rotary type with two sided paddle, the group turning and realizing a virtual retro rotary figure with triangular cylinder.

As we have shown in the previous figures, it is possible to realize the location of the new compression at any new angle and to correct it by a cylindrical regularization. However, since it is motor machines we are speaking of, it is important to specify for these new machines, the types of mechanics which will be used to support the paddles and cylinders, as well as the locations of the gas intake and exhaust, as well as the fixation of the spark plugs or other accessories. To do this, it is therefore pertinent to proceed to an observation of the paddle behavior, independently from the cylinder.

This being done, we'll state that the attribution of a new explosion location will necessarily force a different dynamic paddle figuration, different from its material figuration. This new figuration, for the reasons which we have previously given could be established in such a way to be realized in one, two or three turns.

We'll thus state that by determining the location of the next explosion in such a way so that the new projected angle can be a simple fraction of three hundred and sixty degrees, for example, of one to three, one to four, one to five, six, we'll allow the paddle to realize a virtual figure equivalent to one of the base figures of retro rotary machines.

In the example given here, we project an explosion at each one hundred and twenty degrees. And we realize the paddle consequentially in such a way so that it realizes this virtual figure, here triangular, all while realizing the dynamic regularization of the cylinder.

We must necessarily distinguish material figures from virtual figures. In this example, as we have said, the material paddle and cylinder, realize a post rotary type figure with a two sided paddle, and one sided cylinder, such as shown in a. In b, we see that the virtual figure that the paddle will realize is that of a triangular engine. Moult exactly by the same mechanic as this retro rotary figure in fact, the paddle will displace itself identically.

To compensate this planetary paddle rotation figure, we'll activate the material cylinder by ajusting each angle and to each moment according to the procedure enounced to the previous figure. The cylinder will therefore turn of two third rotations for each third of paddle rotation. This procedure thus allows to realize the machine with a retro rotary mechanic, and simultaneously with a real post rotary figuration, in which the compression will be better.

As we can notice, paddle and cylinder both turn in the same direction, which makes the simply differential machine, posterior.

FIG. 35.5 gives a second example of the material and virtual figure. We must realize the machine with a specification of the virtual figure, wince, as we'll see, on one part, the mechanic will be that of the virtual figure, and on another part, the position of the spark plugs, intakes and exhausts of the machine will also be realized by respecting the virtual figure. In this example, the material figure will be that of a post rotary machine with triangular paddle and double arc cylinder, such as shown in a). However, as we have shown in b) the virtual figure will be that of a retro rotary machine.

As we have already mentioned, if we understand the thing from the mechanical point of view, we could to the contrary say that the material figure is the second, since the mechanic allowing the support of the paddle will necessarily be that of the virtual figure. As before, if we adjust, at each phase of its unfolding, the cylinder with the corrected angulation, we'll obtain a rotary cylinder, which will allow the conjunction of real and virtual figures, which we'll name the synthetic course. A material figure of post rotary triangular paddle with double arc cylinder machine will be realized simultaneously to the virtual form of a triangular retro rotary machine. As in the first case, this figure is located in the area of differential anterior machines.

FIG. 35.6 re-exposes the continuation of the positions of a clockwise movement machine. As we can state, the originality of this type of machine is to describe a limit point between two areas of the chromatic scale of rotary machines. In this point, we find the following particularity, that the number of paddle sides is identical to that of the virtual cylinder. The explosions or compressions take place, in fact, for example here, on each side of a virtual triangle for a virtual paddle. We see for each figure in a and b, that the number of real sides of the paddle is equal to the number of sides of the virtual cylinder, in what consists of the originality of the machine, due to it not being able to be realized strictly in it's real form.

FIG. 36 shows that we can inversely diminish the number of sides of the virtual figure in relation to the standard figure, which implies, in the measure where the compressions will be successive, that we'll realize a differential posterior virtual form. Here, consequentially, we will realize a machine of post rotary triangular paddle and double arc cylinder of real form, in such a way as to virtually realize a post rotary machine of a single side. This realization allows, to all practical means to subtract the crankshaft, realizing the compressive parts strictly rotarily.

FIG. 37.1 shows that consequentially we can, by adding or subtracting from one side of the virtual cylinder, transfer a post rotary machine, in retro rotary machine and inversedly. Here, the same post rotary machine with triangular paddle can become a synthetic post rotary machine with one sided virtual cylinder, or retro rotary synthetic, with a four sided virtual cylinder.

FIG. 37.2 shows that this is true for all figure forms. We have here, as an example, in a, a triangular paddle machine, in b, a square paddle machine, in c a five sided paddle machine.

FIG. 37.3 shows that the realizations of the synthetic figures are also true for retro rotary machines as much as post rotary. In a) we can see a post rotary machine realize a retro rotary form of a virtual cylinder, whereas in b, we see a material retro rotary machine, realize a virtual post rotary cylinder form.

FIG. 38 shows that the realizations, for a same material figure, of virtual figures are not limited to figures of a number of sides superior or inferior by one. Here, we realize, for example, a post rotary triangular paddle machine with a virtual five sided cylinder form.

In column a) we can see the list of the explosions and we can state that the paddle is simultaneously compatible with the real and virtual cylinder forms. In column b, we can see the various moments of passage, in which the paddle points pass simultaneously in the points of real and virtual cylinders. Here, the retro rotation of the paddle is accelerated, which produces a rotation of it in the same direction as the cylinder, and for this the machine will be located in the area of anterior differential machines.

FIG. 39.1 shows that in reality, we can realize, for a same material figure, all the base geometric figures as virtual figures. For example, here, for a post rotary machine with triangular paddle, we can realize, as we have already shown, a figure with a lower number of sides, thus posterior differential, or with a higher number of sides, being triangular, square, hexagonal, and so forth.

FIG. 39.2 shows that this is true for all figures, and gives the example of a post rotary square paddle material form.

FIG. 40 shwos that we can realize the virtual cylinder of a machine by realization of each of its faces, non successively, by jumps.

For example, we could, for a triangular paddle post rotary type machine, realize this machine by localizing each compression by jumps of eluded faces. In the current example, we organize the paddle dynamic in such a way so that not only it realizes an eight sided virtual figure, but in addition that it doesn't pass to successive paddles, but rather by jumps of two eluded faces at a time. The paddle will thus be closer to its virtual figure by passing through the following series of faces: I, IV, VII, II, V, VIII, III VI.

FIG. 40.1, gives the continuation, for a rotation of all compression and expansion positions of the paddle. It is important to make a few of the following commentaries. The first consits in mentionning that the realization of this virtual figure allows many explosions per rotation, which would only be realizable normally by an eight sided figure, which consequentially would give but small explosions. The second consists in saying that, this done, we succeed in placing each successive compression in the contrario zone. In fact, if we observe the unfolding of the sequence of the paddle and cylinder, we notice that they work in opposite direction, which assures to the machine, by a contrario force, an important motor power. A third observation consists in noting that the movement of each of the compressions and expansions is alternative, and can be assimilated by the Slinky movement, or even to a multi clockwise successive movement, already commented movements by ourselves for piston machines, and which find here its realization for rotary machines. This movement which can be assimilated to a successive clockwise movement allows an expansion more towards the center than in standard rotary machines, in which the expansion pivots around the center before realizing it. The expansion, here, in addition, will not take three quarters of a rotation, as in rotary machines, but only a quarter rotation. The machine could therefore be easily realizable of four 3^{rd} time by choosing the even sequences for the explosions and the odd sequences for the admission or evacuation and vice versa.

FIG. 41.1 reminds us of the slinky dynamic for a rotor cylinder machine, this dynamic realizing a course by jump of parts.

FIG. 41.2 shows that, since the course of the non successive faces are possible, the continuation of the synthetic courses, which we'll also name real courses, are multiple for a same virtual figure. For example, here, we show that various virtual paddle courses allow the realization of a five sided virtual figure for a post rotary three paddle sided material figure.

In the following figures, we'll show that according to the chosen synthetic course for the same real and virtual figures, we realize very different machines, since certain of them are located in the area of differential anterior machines, others in the area of contrario machines, and others in the area of differential posterior machines.

FIG. 42.1 thus enlarges the construction rule of the rotivity of the cylinder by stating that we must take in account of not the virtual figure, but of the virtual course of realization of this figure. Consequentially, the degree difference of the first successive material and virtual compressions, and its angle, will be applied to the cylinder.

In the example of the current figure, the five sided virtual figure is realized successively, which forces the displacement of the paddle and the cylinder in the same direction, and realizes a differential anterior machine.

FIG. 42.2 realizes a real, non successive, synthetic course, in which the jumps will be realized in such a way as to be located in the contrario area of the machine. Here, we elide consequentially a virtual face to each compression. Such as shown in b, the machine follows the sequence; I:1, III:2, V:3 II:P 4, IV:5.

We must therefore characterize the machine according to its real form, virtual form, and of synthetic sequence critearea. We could say that this machine is of type P 3/2; 5; 1: contrario, which will signify that the machine is post rotary, of three sides to two, of five sided virtual cylinder, and a jump of one elized side. We could even specify the contrario aspect.

FIG. 42.3 shows the same real and virtual forms, but, once again with a different synthetic course. Here, the jump is of two, and the sequence is thus the following I:1, IV:2, II:3, V 4, III 5.

As we can state, it is not as much the virtual form which will define the surface of the machine, but the synthetic course on this form. Here, the synthetic course makes the first explosion appear, being located in a deca zone of the point of the explosion during the standard realization, anterior and at point zero, the machine is thus differential posterior, and such as we can state, since the cylinder and paddle are acting post rotarily in the same direction, the power is reduced, since there is a mechanical contradiction with the unique direction which must have an explosion.

FIG. 43 summarizes the three previous figures and coincicedly puts in dregs the synthetic course and the belonging of a realization to one area or another. In a, we have a successive course, in which the first compression is located in the differential anterior area.

In b, the synthetic course realizes a machine of chromatic area said contrario and will be of motor category.

In c, the machine realizes a synthetic course in which the first compression is located in the differential posterior area. The machine will be compressive.

FIG. 44 shows that certain figures, in which the number of sides is even and low enough, bring back inferior figures. For example here, the virtual six sided cylinder allows a sequence of successive faces in a). In b, however the sequence with a jump, makes us fall back on the clockwise dynamic, whereas the sequence with two jumps in c), makes us fall back on the standard dynamic.

FIG. 45 shows various real figure courses of seven sides for a post rotary material figure with a three sided paddle. We can find here, from one to seven for each figure, the succession of compressions. As before, the first synthetic courses will take place in differential anterior machines, the sequence with two eluded faces will make way for a contrario type machine, and the other sequences, differential posterior machines.

FIG. 46 shows various real courses of a virtual eight sided figure for a post rotary material figure with a three sided paddle. As in the previous figure, we can distinguish the synthetic courses which will make way for differential, anterior or posterior machines or contrario machines, producing the motor effect.

FIG. 47.1 shows that more the number of sides increases, more the number of possible courses increase, and consequentially of contrario courses. Here, the virtual figure of fourteen to fourteen sides for a real post rotary figure with three sided paddle.

FIG. 47.2 reminds that each material paddle figure has its specific area and that more the paddle has sides, more the contrario area is restraint.

FIG. 48.1 summarizes the final figures, ans shows, in a single FIGURE that many virtual figures are possible for a same material figure, and that many synthetic courses are possible for each virtual figure.

FIG. 48.2 shows, for a rotation, this time, a material post rotary figure of four and three sides of paddle and cylinder, realized on a ten sided virtual structure. The synthetic course by jumps of three faces allows to realize the first compression and explosion, and the following, in a contrario part of the machine. As we can state, we realize 10 compressions for each half rotation of the paddle, and third of rotation for the cylinder, and consequentially, if the machine is realized in four times, ten explosions per paddle rotation, which corresponds to a piston engine in V with twenty pistons, being practically three V-8's, or two V-12's.

FIG. 49.1 shows, inversely, that many material figures are possible for a same virtual figure, and that each will posess a preferable contrario area.

FIG. 49.2 shows the chromatic scale of a three sided paddle, two sided cylinder material figure machine. We can see the differential anterior areas, being realized when the explosion comes before the clockwise moment of the machine. We can see differential posterior areas, being realized when the moment of explosion is posterior to the moment of standard explosion. Finally, we can see contrario areas, being realized when the location of the first explosions is realized between the clockwise and standard locations.

FIG. 50.1 shows the mechanical specifications of these machines. We can generally say that these machines could be activated by mechanics similart to the mechanics of rotativo circular clockwise movement machines, taking in account however to realize the paddle movement in such a way so that it produces the movement of the real and material figurations, if the machine is produced in slinky and virtually and materially if it produces successive compressions.

In the two cases, we'll realize ranged crankpins of the machines in such a way so that their length is equivalent to that of material figures, when realized standardly, and also in such a way so that they realize rotation and retro rotation ratios of virtual or real figures depending on the case.

For example, in the case of the mechanization of FIG. 42.2 and 33.4, we'll realize the machine with the same crankpin length as the post rotary material figure with a three sided paddle and two sided cylinder.

In addition, we'll realize orientational mechanics of the FIG. 42.2 with the help of a retro rotary mechanic, limiting that of a five sided cylinder machine, increased the number of supplementary degrees to fill by the triangular and non square paddle shape.

In the two cases, we'll note that this being done we greatly increase the poly induction, and increasing its reach, which has for effect to make positive even the back part of the paddle movement, which will not remain in simple blockage, but will act dynamically.

FIG. 50.2 shows, as for standard machines, clockwise movement machines can not only be realized inversedly, but also bi functionally.

FIG. 50.3 distinguishes, for the group of chromatic scale realizations for differential retroroaty, post rotary, and contrario, for a machine which is virtual. This chromatic scale is composed of the following main points, being that of rotary paddle and cylinder machines, clockwise cylinder machines, planetary rotor cylinder machines. The interphases between these points constituted the differential parts, contraio, or differential posterior of these machines. These statements constitute an certain advance in the knowledge of these machines, which anteriorly would only be constituted of two polar possibilities, being the octave point, and the standard point, which we'll call the fifth point. The addition of the clockwise point, which we'll call the third point, allows not only to constitute the areas of these machines, but also to realize a rational progression between them, as in the scale of colours, the diatonic musical scale, or in other scales. The parts do not understand themselves successively, discretely, and isolated, but rationally, by their relations to a same fundamental, the point zero. In addition, from the dynamic point of view, the realization of a machine according to its synthetic course, therefore, not only simultaneously virtual and real, rationally speaking, and in the Hegelian or Cartesian sense of the term. In these cases, the mechanical logic resembles the arts, since it allows to realize understanding links from material data, which finally are more real than the data itself.

FIG. 51 shows the qualities of a virtual cylinder with eight sides and with jumps of two, and consequentially, of contrario movement. Such as we can state, here, the parts work in contrario. Secondly, as in clockwise movement machines, the rod effect is realized by the rotation of the cylinder. Thirdly, as we can state in c, the end of the expansion is vertical enough in relation to the expansion of a standard machine, which respects the passiveness of the explosion.

FIG. 52 summarizes the four types of possible mechanizations for rotativo circular machines, being in a, by real mechanic of the virtual movement of the paddle by semi transmitive mechanic of the rotary cylinder, in b) by real mechanic of the virtual paddle movement by descending mechanic of the rotation of the cylinder, in c) by semi transmitive mechanic of the paddle by confounded semi transmitive cylinder mechanic, in d) by semi transmitive paddle mechanic by descending mechanic of the rotary cylinder.

FIG. 53 shows that each of these mechanics and semi transmissions can be standard or poly inductive.

FIG. 54 shows that we can increase the efficiency of differential piston machines by realizing them with rotor cylinders or added superior pistons. In the same way, we can add the rotary cylinder towards the exterior fixed cylinder. In this way, the compression is done from three parts, and the power on the paddle is then realized in support on the exterior cylinder which cuts back the contradictory effect of the strictly differential push.

FIG. 55 is an example of rotativo circular machine mechanization in which we use a poly inductive semi transmission in a, and a descending mono induction in b.

FIG. 56 shows a few other combinations among the hundreds possible. It is therefore important to state that the induction assemblies are exemplary. All of these inductions could be replaced by any other, depending on the case, standard, semitransmitive, ascending, or descending induction. In a1, we have a poly inductive semi transmission commanding the cylinder retro rotation, realized confoundedly with a fixed poly induction b1, commanding the clockwise paddle action.

In a 2, we have a poly inductive paddle action, and in b 2.1 a mono inductive descending action of the cylinder. In b2.2 the action commanding the cylinder is semitransmitive with pinions.

In a 3, the semi transmitive poly inductive action commads the cylinder and the dynamic support gear of the ascending poly induction of the paddle, in b 3. In a4, the ascending paddle poly induction leads a descending cylinder poly induction in b4. In a 5, a semi transmitive induction with pinion gears leads simultaneously the cylinder and the support gear of the ascending semi transmitive induction by hoop gear in b 5. In a 6, the dedoubled semi transmission leads both the cylinder and the central dynamic ascending induction gear by the central dynamic gear in b 6.

FIG. 57 shows that the clockwise movement is also peripherally possible.

FIG. 58 shows that the clockwise movement can be realized bi-functionally, the external cylinder, and the internal sub-paddle being strictly rotary, and the paddle in cockwise movement.

FIG. 59 shows in a that we can realize in a simplified way the segmentation of rotary machines by the use of U segments 300, inserted into the points of the paddles, in such a way so that their terminal parts 301 touch themselves, or even such as in a 2, touch a central circular segment 302. In 1 3, we see that these U segments can also be set up in the cylinder, in such a way as to partially enrobe the paddle. In these cases, they will simply be completed by segments 304 reminding the form of the paddle course, set up in its sides.

In b of the same figure, we show how to realize a machine with the support of a crankshaft rather than an eccentric, by adding the paddle in such a way as to let pass the crankshaft's crankpin and by closing off the extrusion by a complementary paddle part 505.

In c of the same figure, we show that we can realize the rotary paddle of clockwise cylinder movement machines by fabricating it in the way of a turbine paddle. The entry of the matter by the center 306 will consequentially produce a first rotation of the paddle in the way of a turbine, and the substances escaping 307, will lead its cylindrical clockwise parts. Inversely, if the substances are inserted from the exterior 308, the turbine will then act as a matter concentrator 409, and produce propulsion.

FIG. 60 shows other possible mechanics, which are once again taken from the previously exposed composition rules. It is therefore important to repeat that these induction assemblies are exemplary. All of these inductions could be replaced by any other induction, depending on the case, standard, semitransmittive, ascending, or descending. Here, in the three cases, the ascending induction is a poly induction. In a, the induction gears 400 are supported on their support gear 401 and are coupled to a second series of gears which will be peripheral support gears 402. The crankpins, 403, supporting the paddle 404 will thus be coupled to induction gears by means of this second series of gears. They will activate retro rotarily the induction gear of the cylinder 405.

In b, the poly induction activates the paddle 406, and is connected to a semi transmission by inversive pinions 407, activating the cylinder. In c, the original cylinder gear 408, is coupled to an internal gear 408, which allows to realize the cylinder planetarily.

FIG. 62 shows the semantic gaps overcome by our works relative to planetary cylinder machines, there is directional error and omission or mechanical contradiction. In fact, the correct direction of these machines is complementary to the direction of their counterpart, and the mechanic must not be that of the figure, but in fact, that of its counter part. A correct comprehension of these elements allow, as we have shown, to realize the cylinder bifunctionally.
J) Relatively to rotary paddle and cylinder machines, the direction of them must be inversed since according to the rule which we have given, the next expansion taking place in the same location, the paddle must realize a retro rotation of one hundred and eighty degrees. This reorientation of the machine allows to consider it as the octave machine of the chromatic scale.
K) The rotor cylinder machine realizes a paddle of virtual figuration of a square cylinder machine, and becomes by this fact, differential retro rotary, which lowers the motricity of the achine. The comprehension of this machine is incomplete, not only by the absence of general rules, but also from the absence of the clockwise machine movement, and also by the absence of the establishment of the virtual and real figures. As before, we note an absence of mechanization of this figure, which would have shown the retro rotary character, and requires semi transmissions, or other descending inductions. This figure is outside its chromatic field and remains isolated, differential anterior, without mechanics. As the most of the tentative in terms of rotary machines, it evokes the machine in the compressive and not motor capacity, which gives it an inferior power, even to standard machines.
L) The lack of knowledge of bi inductive figures, figurative, being poly turbines, and dynamic, being clockwise paddle or cylinder movement machines.
M) The absence of establishment or of determination of the mechanical figuration or dynamic levels.
N) The absence of accelero decelerative mechanized dynamics
O) The absence of the establishment of chromatic fields.

1. An energetic rotary machine, having an exterior housing in which are dynamically set up two complementary compressive parts each having a specific number of sides, being a cylindrical and paddle part, these parts realizing compression chambers in complicity, the number of compressions realized per cycle being equal or above the number of sizes of the paddle, the cylindrical part having an annular form with an circular exterior profile and an interior opening chosen in function with the form of the paddle, the paddle being set up in the inferior opening of the cylindrical part, these complementary compressive parts being realized between themselves and synchronized by a set of mechanical inductions, one of the compressive parts being connected directly or indirectly to a tree of exit power, this machine characterizing itself by the rotation of the cylindrical part around the paddle structure, thus describing a rotary movement, whereas each of the points of the paddle structure realize, for a complete machine cycle, a circular figure, the centers of these circular figures being equidistant between themselves, and located in periphery and at an equal distance of the center of the cylindrical cavity, the paddle structure realizing a circular displacement all while conserving a same orientation for all of its course, thus effecting a movement of rotary translation.

2. A rotary type energetic machine, having an exterior housing with a cylindrical cavity in which are set up dynamically two complementary compressive parts each having a specific number of sides, being a cylindrical part and a paddle part, these parts realizing compression chambers in complicity, the number of compressions realized per cycle being equal or superior to the number of sides of the paddle structure, the cylindrical part being set up in a rotary manner in the cylindrical cavity, the cylindrical part having an annular form with a circular exterior profile and an interior opening chosen in function of the form of the paddle structure, the paddle structure being set up in the interior opening of the cylinder, these complementary compressive parts being connected between themselves and synchronized by a set of mechanical inductions, one of these compressive parts being directly or indirectly connected to a tree of exit power, this machine characterizing itself by the rotation of the cylindrical part around the paddle structure, thus describing a rotary movement, whereas for each of the points of the paddle structure realized, for a complete cycle of the machine, a geometric figure defined by an N number of successive lobes in which the center of this geometric figure coincides with the center of the cylindrical cavity, and which N is superior to two.

3. A machine according to claim 2, in which a part of the mechanical induction allows the realization of a positioning of the paddle part is defined in function with the compressive parts, and in which the mechanical induction part allows the control of the orientation of the paddle part is defined in function with the geometric figure.

4. A machine according to claim 1, in which the paddle has a retro rotation speed equal to the speed of the eccentric's rotation, this paddle part being coupled to the cylindrical part.

5. A machine according to claim 2, in which the ratio between the retro rotation speed of the paddle structure and the rotation speed of its eccentric is located between 1/X, where X is the number of sides of the paddle part, and 1/1.

6. A machine according to claim 2, in which the geometric figure has N lobes described by the paddle part is produced by successively realizing the sides of this figure.

7. A machine according to claim 2, which the order of compressions of a cycle is produced by displacing the paddle part according to the geometric figure by realizing its lobes non successively, the totality of the lobes of this figure being realized by more than a rotation of the paddle part.

8. A machine according to claim 1, in which the dynamic of the compressive parts is realized inversely, the cylindrical part realizing the movement of rotational translation and the paddle part realizing the rotational movement.

9. A machine according to claim 2, in which the dynamic of the compressive parts is realized inversely, the points of the cylindrical part realizing the geometric figure, and the paddle part realizing the rotational movement.

10. A machine according to claim 1, in which the number of sides of the paddle structure is superior by one to that of the cylindrical part, thus realizing the machine in its post rotary form.

11. A machine according to claim 1, in which the number of sides of the paddle structure is inferior by one to that of the cylindrical part, thus realizing the machine under its retro rotary form.

12. A machine according to claim 1, in which the paddle part is realized by a plurality of the paddle parts, each of these parts possessing its own mechanical induction, and each of these parts acting in complicity and synchronization with the cylindrical part.

13. A machine according to claim 1, in which the paddle structure is constituted of a group of straight segments, connected non-rigidly between themselves by their extremities in such a manner as to form a flexible paddle structure, called paddle structure, this structure being realized dynamically inside the cylindrical part.

14. A machine according to claim 13, in which the movement of the paddle points of the paddle structure is rectilinear alternative.

15. A machine according to claim 1, realized when the support of one of the compressive parts is activated with a mechanical group comprising a supplementary induction realized in combination with the original induction, making the rotary movement of a compressive part pass to a planetary movement, or even making the simple planetary movement of a compressive part to a composed planetary movement.

16. A machine according to claim 1, putting in layered composition many groups of compressive parts, the cylindrical part of one of them which could be used, by its exterior surface, as a paddle part of the exterior compressive group, and by its interior surface, the cylindrical part to the group of interior compressive parts.

17. A machine according to claim 1, in which the compressive parts have a rotation in opposite direction, when they're observed from the exterior.

18. A machine according to claim 1, in which the movement of one of its compressive parts is irregular, alternatively realizing accelerations and decelerations which could add, when the compressive part possesses a planetary movement, an oscillatory character to it, these accelero-decelerative movement which could be realized with the support of polycammed gears.

19. A machine according to claim 1, in which, the support gear of the mechanical induction of one of its compressive parts, is dynamic.

20. A machine according to claim 1, in which the mechanical induction supporting the paddle structure is one of the following: a mono induction, an intermediate gear mechanic, a poly induction mechanic, an alternative poly induction mechanic, a hoop gear mechanic, a mechanic by hoop gear with chain, a mechanic by double internal gears, a mechanic by heel gear, a mechanic by gear like structure, a mechanic by unitary gear, a mechanic by central active gear, a mechanic by stopped poly induction, a mechanic by subtractive poly induction.
These inductions being realized either with central fixed support gears, with dynamic central support gear, with peripheral support gear.

21. A machine according to claim 7, in which the mechanical induction supporting the cylindrical part is one of the following: a mono induction, an intermediate gear mechanic, a poly induction mechanic, an alternative poly induction mechanic, a hoop gear mechanic, a mechanic by hoop gear with chain, a mechanic by double internal gears, a mechanic by heel gear, a mechanic by gear like structure, a mechanic by unitary gear, a mechanic by central active gear, a mechanic by stopped poly induction, a mechanic by subtractive poly induction.
These inductions being realized either with a central fixed support gear, with dynamic central support gear, with peripheral support gear

22. A machine according to claim 1, in which the inductions of the compressive parts share a common element, this element being:
an eccentric
a dynamic support gear of a planetary induction or
a paddle

23. A machine according to claims 1, in which the exit tree of power is either:
the tree of the eccentric supporting the paddle compressive part or
the tree supporting the cylindrical compressive part.

24. A machine according to claim 2, in which the induction of the paddle part is said descending, this induction characterizing itself by the rigid set up on the paddle part of a peripheral support, this gear activating indirectly or directly an induction gear, this induction gear being set up rigidly in the center of the cylindrical part of the machine, or on an axe of the cylindrical part.

25. A machine according to claim 1, used as: engine, compressor, collection machine, pump, propeller, turbine, mechanical part of a mechanical turbine, artificial heard, or wind mill.

26. A machine according to claim 1 in which we confer the paddle part to an aerodynamic curve allowing to realize the transport of substances in the machine:
from the periphery towards the center
from the center towards the periphery or
from a lateral face to another.

27. A machine according to claim 2, in which the valves, spark plugs are installed on the rotary part, or the paddle part.

28. A machine according to claim 1, in which the emplacements of the valves, spark plugs and other accessories are set up in function of the material figures and the realization sequence of the compressions.

29. A machine according to claim 2, in which the number of sides of the paddle structure is superior by one to that of the cylindrical part, thus realizing the machine in its post rotary form.

30. A machine according to claim 2, in which the number of sides of the paddle structure is inferior by one to that of the cylindrical part, thus realizing the machine under its retro rotary form.

31. A machine according to claim 2, in which the paddle part is realized by a plurality of the paddle parts, each of these parts possessing its own mechanical induction, and each of these parts actina in complicity and synchronization with the cylindrical part.

32. A machine according to claim 2, realized when the support of one of the compressive parts is activated with a mechanical group comprising a supplementary induction realized in combination with the original induction, making the rotary movement of a compressive part pass to a planetary movement, or even making the simple planetary movement of a compressive part to a composed planetary movement.

33. A machine according to claim 2, in which the compressive parts have a rotation in opposite direction, when they're observed from the exterior.

34. A machine according to claim 2, in which, the support gear of the mechanical induction of one of its compressive parts, is dynamic.

35. A machine according to claim 2, in which the mechanical induction supporting the paddle structure is one of the following: a mono induction, an intermediate gear mechanic, a poly induction mechanic, an alternative poly induction mechanic, a hoop gear mechanic, a mechanic by hoop gear with chain, a mechanic by double internal gears, a mechanic by heel gear, a mechanic by gear like structure, a mechanic by unitary gear, a mechanic by central active gear, a mechanic by stopped poly induction, a mechanic by subtractive poly induction.
These inductions being realized either with central fixed support gears, with dynamic central support gear, with peripheral support gear.

36. A machine according to claim 2, in which the inductions of the compressive parts share a common element, this element being:
an eccentric
a dynamic support gear of a planetary induction or
a paddle

37. A machine according to claims 2, in which the exit tree of power is either:
the tree of the eccentric supporting the paddle compressive part or
the tree supporting the cylindrical compressive part.

38. A machine according to claim 2, used as: engine, compressor, collection machine, pump, propeller, turbine, mechanical part of a mechanical turbine, artificial heard, or wind mill.

39. A machine according to claim 2 in which we confer the paddle part to an aerodynamic curve allowing to realize the transport of substances in the machine:
from the periphery towards the center
from the center towards the periphery or
from a lateral face to another.

40. A machine according to claim 2, in which the emplacements of the valves, spark plugs and other accessories are set up in function of the material figures and the realization sequence of the compressions.
